(19) United States
(12) Patent Application Publication
(10) Pub. No.: US 2026/0026535 A1
(43) Pub. Date: Jan. 29, 2026

(54) MATCHA RICHNESS ENHANCER

(71) Applicant: Masaru OTANI, Tokyo (JP)

(72) Inventors: Masaru OTANI, Tokyo (JP); Motoko TAKAOKA, Nishinomiya-shi (JP)

(73) Assignee: Masaru OTANI, Tokyo (JP)

(21) Appl. No.: 19/250,526

(22) Filed: Jun. 26, 2025

(30) Foreign Application Priority Data
Jun. 27, 2024 (JP) 2024-104435
Jun. 27, 2024 (JP) 2024-104436

(51) Int. Cl. A23L 27/21; A21D 2/24; A21D 2/36; A23F 3/40; A23G 1/44; A23G 1/48; A23G 3/44; A23G 3/48; A23G 9/38; A23G 9/42; A23L 27/00

(52) U.S. Cl. CPC A23L 27/21; A21D 2/245; A21D 2/36; A23F 3/405; A23G 1/44; A23G 1/48; A23G 3/44; A23G 3/48; A23G 9/38; A23G 9/42; A23L 27/88

(57) ABSTRACT

Provided are a matcha richness enhancer that enhances the richness of matcha and a matcha food or beverage that contains this matcha richness enhancer. For example, provided are a matcha richness enhancer that contains leucine and an aspartic acid salt such that leucine:aspartic acid salt, by mass, is within a range of 76 to 94:6 to 24 and a matcha food or beverage that contains this matcha richness enhancer. Also provided, for example, are a matcha richness enhancer that contains leucine, isoleucine, valine, and an aspartic acid salt such that (total leucine, isoleucine, and valine):aspartic acid salt, by mass, is within a range of 76 to 94:6 to 24 and a matcha food or beverage that contains this matcha richness enhancer.

### TECHNICAL FIELD

The present disclosure relates to a matcha richness enhancer that enhances the richness of matcha in a matcha food or beverage. Moreover, the matcha richness enhancer according to the present application may also be used to prevent deterioration of the richness and/or flavor of matcha in a matcha food or beverage. Furthermore, the present disclosure also relates to a matcha food or beverage containing the aforementioned matcha richness enhancer.

### BACKGROUND

The branched-chain amino acids (BCAAs) leucine, isoleucine, and valine are essential amino acids for living organisms. In contrast to many other amino acids that are metabolized in the liver, BCAAs are directly broken down in muscle. BCAAs are useful for preventing symptoms associated with loss of muscle mass such as sarcopenia (loss of skeletal muscle mass) and frailty (weakness due to fatigue and decreased vitality), which are problems faced by middle-aged and elderly people. In particular, it has been reported that even among essential amino acids, the taking of BCAAs rich in leucine increased the synthesis of muscle protein in the elderly.

Although the ingestion of BCAAs is actively promoted due to the beneficial effect on muscle such as described above, there is a problem that ingestion of BCAAs is difficult for many people from a viewpoint of taste due to BCAAs having extremely strong bitterness. In order to resolve this problem, attempts have been made to make BCAAs easier to ingest by adding a fruit fragrance such as lemon, a sweetener such as sugar, or an acidifier such as citric acid to thereby mask the drawback of BCAAs with regards to taste (https://www.myprotein.jp/thezone/others/bcaa-official-flavour-ranking-top-10/). Moreover, BCAAs to which a fragrance of earl grey tea has been added are commercially available (https://www.myprotein.jp/thezone/recipe/iced-earl-grey-tea-bcaa/).

Upon conducting research in relation to the ingestion of BCAAs in view of the circumstances described above, the inventors discovered that when an amino acid composition containing leucine is added to matcha, not only is the drawback in terms of taste of leucine itself masked, but contrary to expectations, this actually enhances the richness of matcha. Moreover, the inventors also discovered that this effect of enhancing the richness of matcha is intensified through the further addition of an aspartic acid salt to the aforementioned amino acid composition containing leucine or through the further addition of isoleucine, valine, and an aspartic acid salt to the aforementioned amino acid composition containing leucine.

On the other hand, since matcha is liked for its unique richness and flavor and since matcha also has health promoting effects from a physical perspective and a mental perspective, matcha is of course used in matcha beverages and is also often used as a processed good ingredient that is added to sweets and the like. Moreover, not only is matcha a familiar ingredient to Japanese people, but it has also recently become loved by people around the world. One issue relating to matcha is that the richness and flavor of matcha in a matcha food or beverage such as a matcha beverage have a high tendency to deteriorate over time due to the sensitivity of matcha components to moisture, light, temperature, and so forth. Through further continuation of the research described above, the inventors discovered that the aforementioned amino acid composition (particularly an amino acid composition containing leucine, isoleucine, valine, and an aspartic acid salt) can also further enhance the taste of matcha by preventing deterioration of the richness and flavor of matcha in a matcha food or beverage.

### SUMMARY

One object of the present disclosure is to provide a matcha richness enhancer that enhances the richness of matcha in a matcha food or beverage and that is aimed at making it possible for a matcha food or beverage that is liked for its unique richness and flavor and that also has health promoting effects from a physical perspective and a mental perspective to be enjoyed in a wider variety of occasions from a viewpoint of taste (particularly richness of matcha). Another object of the present disclosure is to provide a matcha richness enhancer that also has an effect of preventing deterioration over time of the richness and/or flavor of matcha in a matcha food or beverage and has a beneficial effect on muscle (for example, prevention of sarcopenia and/or prevention of frailty). Another object of the present disclosure is to provide a matcha food or beverage that contains the aforementioned matcha richness enhancer and in which the richness of matcha is enhanced such that, from a viewpoint of taste (particularly richness of matcha), a matcha food or beverage that is liked for its unique richness and flavor and that also has health promoting effects from a physical perspective and a mental perspective can be enjoyed in a wider variety of occasions.

Based on findings made over the course of the research process, the inventors completed the present disclosure set forth below, by which the above-described objects are achieved.

Specifically, according to one aspect, the present disclosure relates to a matcha richness enhancer containing leucine and an aspartic acid salt, wherein
parts by mass of the leucine: parts by mass of the aspartic acid salt is a blending ratio within a range of 76 to 94:6 to 24.

Moreover, according to another aspect, the present disclosure relates to a matcha richness enhancer containing leucine, isoleucine, valine, and an aspartic acid salt, wherein total parts by mass of the leucine, the isoleucine, and the valine: parts by mass of the aspartic acid salt is a blending ratio within a range of 76 to 94:6 to 24.

Furthermore, according to yet another aspect, the present disclosure relates to a matcha food or beverage containing any one of the matcha richness enhancers set forth above.

According to the present disclosure, a matcha richness enhancer is provided that enhances the richness of matcha in a matcha food or beverage and that is aimed at making it possible for a matcha food or beverage that is liked for its unique richness and flavor and that also has health promoting effects from a physical perspective and a mental perspective to be enjoyed in a wider variety of occasions from a viewpoint of taste (particularly richness of matcha). Also provided is a matcha richness enhancer that also has an effect of preventing deterioration over time of the richness and/or flavor of matcha in a matcha food or beverage and has a beneficial effect on muscle (for example, prevention of sarcopenia and/or prevention of frailty). Furthermore, according to the present disclosure, also provided is a matcha food or beverage that contains the aforementioned matcha richness enhancer and in which the richness of matcha is enhanced such that, from a viewpoint of taste (particularly richness of matcha), a matcha food or beverage that is liked for its unique richness and flavor and that also has health promoting effects from a physical perspective and a mental perspective can be enjoyed in a wider variety of occasions.

### BRIEF DESCRIPTION OF THE DRAWINGS

In the accompanying drawings:

FIG. 1 illustrates box and whisker plots pertaining to results of comparative evaluation of various amino acid compositions of differing amino acid make-up for “strength” and “preferability” of “bitterness” of matcha in a matcha food or beverage in Example 1 (a cross (×) sign indicates an average value of evaluation scores);

FIG. 2 illustrates box and whisker plots pertaining to results of comparative evaluation of various amino acid compositions of differing amino acid make-up for “strength” and “preferability” of “umami” of matcha in a matcha food or beverage in Example 1 (a cross (×) sign indicates an average value of evaluation scores);

FIG. 3 illustrates box and whisker plots pertaining to results of comparative evaluation of various amino acid compositions of differing amino acid make-up for “strength” and “preferability” of “aroma” of matcha in a matcha food or beverage in Example 1 (a cross (×) sign indicates an average value of evaluation scores);

FIG. 4 illustrates box and whisker plots pertaining to results of comparative evaluation of various amino acid compositions of differing amino acid make-up for “strength” and “preferability” of “richness” of matcha in a matcha food or beverage in Example 1 (a cross (×) sign indicates an average value of evaluation scores);

FIG. 5 illustrates box and whisker plots pertaining to results of comparative evaluation of various amino acid compositions of differing amino acid make-up for “strength” and “preferability” of “flavor” of matcha in a matcha food or beverage in Example 1 (a cross (×) sign indicates an average value of evaluation scores);

FIG. 6 illustrates a box and whisker plot pertaining to results of comparative evaluation of various amino acid compositions of differing amino acid make-up for “overall evaluation” of matcha in a matcha food or beverage in Example 1 (a cross (×) sign indicates an average value of evaluation scores);

FIG. 7 illustrates box and whisker plots pertaining to results of comparative evaluation of the quantitative ratio of BCAA (leucine) and an aspartic acid salt (amino acid compositions 1, 2, 3) and the additive amount (65 mg, 130 mg, 195 mg, 270 mg) of an added amino acid composition for “strength” and “preferability” of “bitterness” of matcha in a matcha food or beverage in Example 2 (a cross (×) sign indicates an average value of evaluation scores);

FIG. 8 illustrates box and whisker plots pertaining to results of comparative evaluation of the quantitative ratio of BCAA (leucine) and an aspartic acid salt (amino acid compositions 1, 2, 3) and the additive amount (65 mg, 130 mg, 195 mg, 270 mg) of an added amino acid composition for “strength” and “preferability” of “sweetness” of matcha in a matcha food or beverage in Example 2 (a cross (×) sign indicates an average value of evaluation scores);

FIG. 9 illustrates box and whisker plots pertaining to results of comparative evaluation of the quantitative ratio of BCAA (leucine) and an aspartic acid salt (amino acid compositions 1, 2, 3) and the additive amount (65 mg, 130 mg, 195 mg, 270 mg) of an added amino acid composition for “strength” and “preferability” of “richness” of matcha in a matcha food or beverage in Example 2 (a cross (×) sign indicates an average value of evaluation scores);

FIG. 10 illustrates box and whisker plots pertaining to results of comparative evaluation of the quantitative ratio of BCAA (leucine) and an aspartic acid salt (amino acid compositions 1, 2, 3) and the additive amount (65 mg, 130 mg, 195 mg, 270 mg) of an added amino acid composition for “strength” and “preferability” of “flavor” of matcha in a matcha food or beverage in Example 2 (a cross (×) sign indicates an average value of evaluation scores);

FIG. 11 illustrates box and whisker plots pertaining to results of comparative evaluation of the quantitative ratio of BCAA (leucine) and an aspartic acid salt (amino acid compositions 1, 2, 3) and the additive amount (65 mg, 130 mg, 195 mg, 270 mg) of an added amino acid composition for “strength” and “preferability” of “aroma” of matcha in a matcha food or beverage in Example 2 (a cross (×) sign indicates an average value of evaluation scores);

FIG. 12 illustrates box and whisker plots pertaining to evaluation score results for change over time and prevention of deterioration over time by an amino acid composition with respect to “strength” of “bitterness” and “sweetness” of matcha in a matcha food or beverage in Example 3 (a cross (×) sign indicates an average value of evaluation scores);

FIG. 13 illustrates box and whisker plots pertaining to evaluation score results for change over time and prevention of deterioration over time by an amino acid composition with respect to “strength” of “richness” and “flavor” of matcha in a matcha food or beverage in Example 3 (a cross (×) sign indicates an average value of evaluation scores);

FIG. 14 illustrates a box and whisker plot pertaining to evaluation score results for change over time and prevention of deterioration over time by an amino acid composition with respect to “strength” of “aroma” of matcha in a matcha food or beverage in Example 3 (a cross (×) sign indicates an average value of evaluation scores);

FIG. 15 illustrates box and whisker plots pertaining to change over time of relative “strength” of a specimen in which an amino acid composition had been added as compared to a specimen in which an amino acid composition had not been added with regards to “bitterness” and “sweetness” of matcha in a matcha food or beverage in Example 4 (a cross (×) sign indicates an average value of evaluation scores);

FIG. 16 illustrates box and whisker plots pertaining to change over time of relative “strength” of a specimen in which an amino acid composition had been added as compared to a specimen in which an amino acid composition had not been added with regards to “richness” and “flavor” of matcha in a matcha food or beverage in Example 4 (a cross (×) sign indicates an average value of evaluation scores);

FIG. 17 illustrates a box and whisker plot pertaining to change over time of relative “strength” of a specimen in which an amino acid composition had been added as compared to a specimen in which an amino acid composition had not been added with regards to “aroma” of matcha in a matcha food or beverage in Example 4 (a cross (×) sign indicates an average value of evaluation scores);

FIG. 18 illustrates box and whisker plots pertaining to evaluation score results of “strength” and “preferability” of “bitterness” of matcha in a matcha beverage to which an amino acid composition had been added in Example 5 (a cross (×) sign indicates an average value of evaluation scores);

FIG. 19 illustrates box and whisker plots pertaining to evaluation score results of “strength” and “preferability” of “aroma” of matcha in a matcha beverage to which an amino acid composition had been added in Example 5 (a cross (×) sign indicates an average value of evaluation scores);

FIG. 20 illustrates box and whisker plots pertaining to evaluation score results of “strength” and “preferability” of “richness” of matcha in a matcha beverage to which an amino acid composition had been added in Example 5 (a cross (×) sign indicates an average value of evaluation scores);

FIG. 21 illustrates box and whisker plots pertaining to evaluation score results of “strength” and “preferability” of “umami” of matcha in a matcha beverage to which an amino acid composition had been added in Example 5 (a cross (×) sign indicates an average value of evaluation scores);

FIG. 22 illustrates box and whisker plots pertaining to evaluation score results of “strength” and “preferability” of “flavor” of matcha in a matcha beverage to which an amino acid composition had been added in Example 5 (a cross (×) sign indicates an average value of evaluation scores);

FIG. 23 illustrates a box and whisker plot pertaining to evaluation score results of “overall evaluation” of matcha in a matcha beverage to which an amino acid composition had been added in Example 5 (a cross (×) sign indicates an average value of evaluation scores);

FIG. 24 illustrates box and whisker plots pertaining to evaluation score results of “strength” and “preferability” of “bitterness” of matcha in a sweetener-containing matcha beverage to which an amino acid composition had been added in Example 6 (a cross (×) sign indicates an average value of evaluation scores);

FIG. 25 illustrates box and whisker plots pertaining to evaluation score results of “strength” and “preferability” of “aroma” of matcha in a sweetener-containing matcha beverage to which an amino acid composition had been added in Example 6 (a cross (×) sign indicates an average value of evaluation scores);

FIG. 26 illustrates box and whisker plots pertaining to evaluation score results of “strength” and “preferability” of “richness” of matcha in a sweetener-containing matcha beverage to which an amino acid composition had been added in Example 6 (a cross (×) sign indicates an average value of evaluation scores);

FIG. 27 illustrates box and whisker plots pertaining to evaluation score results of “strength” and “preferability” of “umami” of matcha in a sweetener-containing matcha beverage to which an amino acid composition had been added in Example 6 (a cross (×) sign indicates an average value of evaluation scores);

FIG. 28 illustrates box and whisker plots pertaining to evaluation score results of “strength” and “preferability” of “flavor” of matcha in a sweetener-containing matcha beverage to which an amino acid composition had been added in Example 6 (a cross (×) sign indicates an average value of evaluation scores);

FIG. 29 illustrates a box and whisker plot pertaining to evaluation score results of “overall evaluation” of matcha in a sweetener-containing matcha beverage to which an amino acid composition had been added in Example 6 (a cross (×) sign indicates an average value of evaluation scores);

FIG. 30 illustrates box and whisker plots pertaining to evaluation score results of “strength” of “bitterness” and “sweetness” of matcha in a matcha candy to which an amino acid composition had been added in Example 7 (a cross (×) sign indicates an average value of evaluation scores);

FIG. 31 illustrates box and whisker plots pertaining to evaluation score results of “strength” of “richness” and “flavor” of matcha in a matcha candy to which an amino acid composition had been added in Example 7 (a cross (×) sign indicates an average value of evaluation scores);

FIG. 32 illustrates box and whisker plots pertaining to evaluation score results of “strength” of “aroma” and “overall evaluation” of matcha in a matcha candy to which an amino acid composition had been added in Example 7 (a cross (×) sign indicates an average value of evaluation scores);

FIG. 33 illustrates box and whisker plots pertaining to evaluation score results of “strength” and “preferability” of “bitterness” of matcha in a matcha baked sweet to which an amino acid composition had been added in Example 8 (a cross (×) sign indicates an average value of evaluation scores);

FIG. 34 illustrates box and whisker plots pertaining to evaluation score results of “strength” and “preferability” of “aroma” of matcha in a matcha baked sweet to which an amino acid composition had been added in Example 8 (a cross (×) sign indicates an average value of evaluation scores);

FIG. 35 illustrates box and whisker plots pertaining to evaluation score results of “strength” and “preferability” of “richness” of matcha in a matcha baked sweet to which an amino acid composition had been added in Example 8 (a cross (×) sign indicates an average value of evaluation scores);

FIG. 36 illustrates box and whisker plots pertaining to evaluation score results of “strength” and “preferability” of “sweetness” of matcha in a matcha baked sweet to which an amino acid composition had been added in Example 8 (a cross (×) sign indicates an average value of evaluation scores);

FIG. 37 illustrates box and whisker plots pertaining to evaluation score results of “strength” and “preferability” of “flavor” of matcha in a matcha baked sweet to which an amino acid composition had been added in Example 8 (a cross (×) sign indicates an average value of evaluation scores);

FIG. 38 illustrates a box and whisker plot pertaining to evaluation score results of “overall evaluation” of matcha in a matcha baked sweet to which an amino acid composition had been added in Example 8 (a cross (×) sign indicates an average value of evaluation scores);

FIG. 39 illustrates box and whisker plots pertaining to evaluation score results of “strength” and “preferability” of “bitterness” of matcha in matcha ice cream to which an amino acid composition had been added in Example 9 (a cross (×) sign indicates an average value of evaluation scores);

FIG. 40 illustrates box and whisker plots pertaining to evaluation score results of “strength” and “preferability” of “aroma” of matcha in matcha ice cream to which an amino acid composition had been added in Example 9 (a cross (×) sign indicates an average value of evaluation scores);

FIG. 41 illustrates box and whisker plots pertaining to evaluation score results of “strength” and “preferability” of “richness” of matcha in matcha ice cream to which an amino acid composition had been added in Example 9 (a cross (×) sign indicates an average value of evaluation scores);

FIG. 42 illustrates box and whisker plots pertaining to evaluation score results of “strength” and “preferability” of “sweetness” of matcha in matcha ice cream to which an amino acid composition had been added in Example 9 (a cross (×) sign indicates an average value of evaluation scores);

FIG. 43 illustrates box and whisker plots pertaining to evaluation score results of “strength” and “preferability” of “flavor” of matcha in matcha ice cream to which an amino acid composition had been added in Example 9 (a cross (×) sign indicates an average value of evaluation scores);

FIG. 44 illustrates a box and whisker plot pertaining to evaluation score results of “overall evaluation” of matcha in matcha ice cream to which an amino acid composition had been added in Example 9 (a cross (×) sign indicates an average value of evaluation scores);

FIG. 45 illustrates box and whisker plots pertaining to evaluation score results of “strength” and “preferability” of “bitterness” of matcha in matcha chocolate to which an amino acid composition had been added in Example 10 (a cross (×) sign indicates an average value of evaluation scores);

FIG. 46 illustrates box and whisker plots pertaining to evaluation score results of “strength” and “preferability” of “aroma” of matcha in matcha chocolate to which an amino acid composition had been added in Example 10 (a cross (×) sign indicates an average value of evaluation scores);

FIG. 47 illustrates box and whisker plots pertaining to evaluation score results of “strength” and “preferability” of “richness” of matcha in matcha chocolate to which an amino acid composition had been added in Example 10 (a cross (×) sign indicates an average value of evaluation scores);

FIG. 48 illustrates box and whisker plots pertaining to evaluation score results of “strength” and “preferability” of “sweetness” of matcha in matcha chocolate to which an amino acid composition had been added in Example 10 (a cross (×) sign indicates an average value of evaluation scores);

FIG. 49 illustrates box and whisker plots pertaining to evaluation score results of “strength” and “preferability” of “flavor” of matcha in matcha chocolate to which an amino acid composition had been added in Example 10 (a cross (×) sign indicates an average value of evaluation scores); and

FIG. 50 illustrates a box and whisker plot pertaining to evaluation score results of “overall evaluation” of matcha in matcha chocolate to which an amino acid composition had been added in Example 10 (a cross (×) sign indicates an average value of evaluation scores).

### DETAILED DESCRIPTION

The following provides a specific description of embodiments of the present disclosure. These contents are intended to illustrate and describe the present disclosure and are not intended to limit the present disclosure in any way.

The term “food or beverage” according to the present application refers to an article that is served for drinking and/or eating by humans, an article contained in an article that is served for eating and/or drinking by humans, or an article that can serve as a raw ingredient of an article that is served for eating and/or drinking by humans. Examples of the aforementioned “food or beverage” include, but are not limited to, (1) agricultural products such as rice, vegetables, and fruit, livestock products such as meat, raw milk, and edible bird eggs, and aquatic products such as fish, shellfish, and seaweed; (2) foods and beverages that have undergone other manufacturing or processing such as noodles, bread, sweets, condiments, and beverages; and (3) additives (those defined in the Food Sanitation Act). The “food or beverage” according to the present application excludes pharmaceuticals, quasi pharmaceuticals, regenerative medical products, and alcohol products defined in the Alcohol Tax Law.

The term “beverage” according to the present application has the same meaning as “drink” or “drink product” and refers to articles encompassed by the “food or beverage” according to the present application that are served for drinking by humans, that are contained in articles that are served for drinking by humans, or that can serve as raw ingredients of articles that are served for drinking by humans. The “beverage” according to the present application is typically a liquid under normal conditions at which it is served for drinking by humans (for example, under conditions of normal temperature (20° C.) and normal pressure (1013 hPa)), but is not limited thereto. Moreover, the “beverage” according to the present application may typically be served for drinking by humans as a liquid at various temperatures (for example, as a cold (for example, around 5° C.) liquid or as a warm (for example, around 55° C.) liquid), but is not limited thereto. The “beverage” according to the present application may differ between the time of production/provision and the time of drinking by a human in terms of phase (for example, different phases in terms of being a solid at the time of provision and being a liquid at the time of drinking, but not limited thereto), temperature (for example, different temperatures in terms of being −20° C. at the time of provision and being 10° C. at the time of drinking, but not limited thereto), and so forth.

The term “food” according to the present application has the same meaning as “foodstuff” and “food product” and refers to articles encompassed by the “food or beverage” according to the present application that are served for eating by humans, that are contained in articles that are served for eating by humans, or that can serve as raw ingredients of articles that are served for eating by humans. The “food” according to the present application is typically a solid under normal conditions at which it is served for eating by humans (for example, under conditions of normal temperature (20° C.) and normal pressure (1013 hPa)), but is not limited thereto. Moreover, the “food” according to the present application may typically be served for eating by humans as a solid at various temperatures (for example, as a cold (for example, around −20° C.) solid or as a warm (for example, around 55° C.) solid), but is not limited thereto. The “food” according to the present application may differ between the time of production/provision and the time of eating by a human in terms of phase (for example, different phases in terms of being a liquid at the time of provision and being a solid at the time of eating, but not limited thereto), temperature (for example, different temperatures in terms of being −20° C. at the time of provision and being 10° C. at the time of eating, but not limited thereto), and so forth.

The “beverage” and the “food” according to the present application are not mutually exclusive of each other, and the same composition may serve as a “beverage” or may serve as a “food” depending on the occasion.

The term “matcha” according to the present application refers to an article that is obtained by steaming tea leaves that have been produced by shading the tea leaves from sunlight for 2 to 3 weeks prior to picking, subsequently drying the tea leaves without rubbing to obtain “tencha”, and then grinding the “tencha” into a powdered form using a mortar, a ball mill, a jet mill, or the like and that is for use in a “food or beverage”. This powder corresponds to “matcha” in a narrow sense, but in a broader sense, an article served for drinking that is obtained by suspending or dissolving this powder in water at any of various temperatures (in general, this sequence of operations is more particularly referred to as “preparation”) may also be referred to as “matcha”. When distinguishing therebetween in the present application, the former may be referred to as “powdered matcha” and the latter may be referred to as “matcha tea”. The term “matcha tea” according to the present application is encompassed by the subsequently described term “matcha beverage”.

The term “matcha food or beverage” according to the present application refers to a “food or beverage” that contains the aforementioned “powdered matcha” or that has the aforementioned “powdered matcha” as a raw ingredient or part of a raw ingredient. So long as the “matcha food or beverage” according to the present application contains the aforementioned “powdered matcha” or has the aforementioned “powdered matcha” as a raw ingredient or part of a raw ingredient, the amount and production process thereof is not relevant. The “matcha food or beverage” according to the present application may further contain another optional component besides the aforementioned “powdered matcha” or may further have another optional component besides the aforementioned “powdered matcha” as a raw ingredient or part of a raw ingredient. Examples of other optional components besides the aforementioned “powdered matcha” include sweeteners and so forth, but are not limited thereto. Examples of such sweeteners include, but are not limited to, saccharides such as lactose, sugar, sucrose, fructose, honey, and oligosaccharide, high-intensity sweeteners (for example, aspartame, acesulfame K, sucralose, etc., but not limited thereto), and natural sweeteners (for example, stevia, etc., but not limited thereto). Moreover, the “matcha food or beverage” according to the present application may contain water, cow milk, skimmed milk powder, soy milk, milk powder, a milk component derived from cow milk and/or soy milk, dextrin, a thickener, a fragrance, a colorant, a preservative, and so forth.

The term “powdered matcha product” according to the present application refers to articles encompassed by the previously described “matcha food or beverage” that are served in a powdered or granular form. Moreover, the “powdered matcha product” according to the present application may be served in a form resulting from hardening of an article that was originally in a powdered or granular form, such as in the form of a sugar cube or tablet. Although the “powdered matcha product” according to the present application may be served for eating or drinking by a human in that form, this is rarely the case. The “powdered matcha product” according to the present application is typically served for eating or drinking by a human as a subsequently described “matcha beverage” through addition and then dissolution, suspension, or the like of the “powdered matcha product” in a “beverage” such as water or cow milk or as a “matcha candy”, “matcha baked sweet”, “matcha chocolate”, or “matcha ice cream” through sprinkling, coating, covering, laying, sandwiching, mixing, kneading, inclusion, or the like thereof with respect to a “food” such as a “candy”, “baked sweet”, “chocolate”, or “ice cream”. In other words, the “powdered matcha product” according to the present application may be used in order to produce/provide another “matcha food or beverage”. Conversely, the “powdered matcha product” according to the present application may be produced/provided from another “matcha food or beverage” by, for example, spraying a concentrated “matcha beverage” as a mist and causing instantaneous evaporation of moisture to form a fine powder. The “powdered matcha product” according to the present application may be provided by itself or may be provided in combination with another article with the presumption of use in producing/providing another “matcha food or beverage”. The “powdered matcha product” according to the present application may be loaded into and provided in a vessel (for example, a bag, plastic resin, metal can, bottle cap (powder-in-cap), paper pack, pouch, glass bottle, pottery, cup, etc., but not limited thereto). The “powdered matcha product” according to the present application may further contain another optional component besides “powdered matcha” or may further have another optional component besides “powdered matcha” as a raw ingredient or part of a raw ingredient. The “powdered matcha product” according to the present application may be, but is not limited to, a powdered matcha product for matcha tea, a powdered matcha product (powdered matcha product for green tea) that is to be mixed with leaves, powder, or granules of green tea (for example, leaves, powder, or granules of sencha, gyokuro, kabusecha, kukicha, tencha, mecha, etc., but not limited thereto), a powdered matcha product (powdered matcha product for a green tea beverage) that is to be added to a green tea beverage (for example, a beverage such as sencha, gyokuro, kabusecha, kukicha, tencha, mecha, etc. but not limited thereto), a powdered matcha product (powdered matcha product for matcha latte) that is for producing/providing matcha latte, a powdered matcha product (powdered matcha product for powdered matcha) that is for producing/providing powdered matcha, a powdered matcha product (powdered matcha product for a matcha beverage) that is for producing/providing a “matcha beverage”, a powdered matcha product (powdered matcha product for a matcha candy) that is for producing/providing a “matcha candy”, a powdered matcha product (powdered matcha product for a matcha baked sweet) that is for producing/providing a “matcha baked sweet”, a powdered matcha product (powdered matcha product for matcha chocolate) that is for producing/providing “matcha chocolate”, a powdered matcha product (powdered matcha product for matcha ice cream) that is for producing/providing “matcha ice cream”, or the like. The “powdered matcha product” according to the present application is preferably a powdered matcha product for matcha tea, a powdered matcha product for green tea, a powdered matcha product for a green tea beverage, a powdered matcha product for matcha latte, a powdered matcha product for powdered matcha, a powdered matcha product for a matcha beverage, a powdered matcha product for a matcha candy, a powdered matcha product for a matcha baked sweet, a powdered matcha product for matcha chocolate, or a powdered matcha product for matcha ice cream. The “powdered matcha product” according to the present application is particularly preferably a powdered matcha product for matcha tea, a powdered matcha product for green tea, a powdered matcha product for a green tea beverage, a powdered matcha product for matcha latte, a powdered matcha product for powdered matcha, or a powdered matcha product for a matcha beverage.

The term “matcha beverage” according to the present application refers to articles encompassed by the “matcha food or beverage” according to the present application that are served for drinking by humans, that are contained in articles that are served for drinking by humans, or that can serve as raw ingredients of articles that are served for drinking by humans. The “matcha beverage” according to the present application may further contain another optional component besides “powdered matcha” or may further have another optional component besides “powdered matcha” as a raw ingredient or part of a raw ingredient. For example, the “matcha beverage” according to the present application may be, but is not limited to, a sweetener-containing matcha beverage that is a matcha beverage containing a sweetener as another optional component besides “powdered matcha”. Examples of the “matcha beverage” according to the present application include, but are not limited to, beverages that are obtained by adding “powdered matcha” or a “powdered matcha product” to a beverage such as water or cow milk of any of various temperatures and causing dissolution, suspension, or the like therein. For example, the “matcha beverage” according to the present application may be matcha tea, matcha latte, or a beverage (matcha-containing green tea beverage) such as sencha, gyokuro, kabusecha, kukicha, tencha, or mecha that contains the aforementioned “powdered matcha” or that has the aforementioned “powdered matcha” as a raw ingredient or part of a raw ingredient. The “matcha beverage” according to the present application may be loaded into and provided in a vessel (for example, a plastic bottle, plastic resin, metal can, paper pack, pouch, glass bottle, pottery, cup, etc., but not limited thereto).

The term “matcha food” according to the present application refers to articles encompassed by the previously described “matcha food or beverage” that are served for eating by humans, that are contained in articles that are served for eating by humans, or that can serve as raw ingredients of articles that are served for eating by humans. Examples of the “matcha food” according to the present application include, but are not limited to, a “powdered matcha product”, “matcha candy”, “matcha baked sweet”, “matcha chocolate”, “matcha ice cream”, and so forth that are served for eating by humans.

The term “candy” according to the present application refers to a sweet that has a sweetener (for example, a saccharide such as lactose, sugar, sucrose, glucose, fructose, honey, starch syrup, palatinose, or oligosaccharide, a sugar alcohol such as xylitol, a high-intensity sweetener [for example, aspartame, acesulfame K, sucralose, etc., but not limited thereto], a natural sweetener [for example, stevia, etc., but not limited thereto], etc., but not limited thereto) and an excipient (for example, starch, dextrin, reduced maltose syrup, etc., but not limited thereto) as raw ingredients and that is tasted through licking by the tongue while in the mouth. The “candy” according to the present application may have another component besides the aforementioned sweetener and the aforementioned excipient as a raw ingredient. Examples of other components besides the aforementioned sweetener and the aforementioned excipient include, but are not limited to, colorants, fragrances, lubricants, and so forth. The type of the “candy” according to the present application may be a hard type that is comparatively hard (for example, a hard candy (boiled sweet), etc., but not limited thereto) or a soft type that is comparatively soft (for example, a chewable type, a caramel, a gummy, etc., but not limited thereto). The term “matcha candy” according to the present application refers to a “candy” that contains the aforementioned “powdered matcha” or that has the aforementioned “powdered matcha” as a raw ingredient or part of a raw ingredient. So long as the “matcha candy” according to the present application contains the aforementioned “powdered matcha” or has the aforementioned “powdered matcha” as a raw ingredient or part of a raw ingredient, the amount and production process thereof are not relevant.

The term “baked sweet” according to the present application refers to a sweet that has mainly flour, a sweetener (for example, a saccharide such as lactose, sugar, sucrose, glucose, fructose, honey, starch syrup, palatinose, or oligosaccharide, a sugar alcohol such as xylitol, a high-intensity sweetener [for example, aspartame, acesulfame K, sucralose, etc., but not limited thereto], a natural sweetener [for example, stevia, etc., but not limited thereto], etc., but not limited thereto), an oil/fat (for example, butter, margarine, etc., but not limited thereto), egg, and so forth as raw ingredients and that is made through a process of baking in an oven, a frying pan, or the like. Examples of the “baked sweet” according to the present application include, but are not limited to, a financier, a madeleine, a cupcake, a tart, a cookie, a sable, and a wafer. The term “matcha baked sweet” according to the present application refers to a “baked sweet” that contains the aforementioned “powdered matcha” or that has the aforementioned “powdered matcha” as a raw ingredient or part of a raw ingredient. So long as the “matcha baked sweet” according to the present application contains the aforementioned “powdered matcha” or has the aforementioned “powdered matcha” as a raw ingredient or part of a raw ingredient, the amount and production process thereof are not relevant.

The term “ice cream” according to the present application refers to a sweet that has a sweetener and so forth as raw ingredients and that is served for eating after being frozen at below freezing (0° C. or lower). In Japan, ice cream products (general term for ice cream, ice milk, and lacto-ice) and frozen sweets are standardized/classified according to the “Ministerial Ordinance on Milk and Milk Products Concerning Compositional Standards, etc.” and the “Fair Competition Code for Labeling of Ice Cream Products and Frozen Sweets”, and the term “ice cream” according to the present application is inclusive of both these ice cream products and these frozen sweets. The term “matcha ice cream” according to the present application refers to “ice cream” that contains the aforementioned “powdered matcha” or that has the aforementioned “powdered matcha” as a raw ingredient or part of a raw ingredient. So long as the “matcha ice cream” according to the present application contains the aforementioned “powdered matcha” or has the aforementioned “powdered matcha” as a raw ingredient or part of a raw ingredient, the amount and production process thereof are not relevant.

The term “chocolate” according to the present application refers to a sweet that has a cacao content or 35% or more or that has a cacao content of 21% or more and in which the cacao content combined with milk-solids content is 35% or more. The term cacao content used above refers to cacao mass that is obtained as a paste through grinding of cacao nibs, which is the name for a product obtained through fermentation and drying of cacao beans after harvest and removal of superfluous parts such as skins, cocoa butter that is fat extracted from these cacao bean nibs, etc. The “chocolate” according to the present application may contain another component besides the aforementioned “cacao content”, examples of which include milk-solids, sweeteners, fragrances, colorants, and so forth, but are not limited thereto. The “chocolate” according to the present application may be dark chocolate, milk chocolate, white chocolate, or the like depending on differences in terms of cacao components, differences in terms of the amount thereof, and so forth. The term “matcha chocolate” according to the present application refers to “chocolate” that contains the aforementioned “powdered matcha” or that has the aforementioned “powdered matcha” as a raw ingredient or part of a raw ingredient. So long as the “matcha chocolate” according to the present application contains the aforementioned “powdered matcha” or has the aforementioned “powdered matcha” as a raw ingredient or part of a raw ingredient, the amount and production process thereof are not relevant.

The term “bitterness” according to the present application refers to one of the basic tastes together with “sourness”, “saltiness”, “sweetness”, and “umami”, and a representative taste substance of “bitterness” is quinine. The term “bitterness of matcha” according to the present application refers to the “bitterness” that is experienced when drinking matcha (matcha tea), for example.

The term “aroma” according to the present application refers to something sensed due to an aromatic substance causing stimulation of the olfactory nerve distributed inside of the nostrils. The term “aroma of matcha” according to the present application refers to the unique calming “aroma” of matcha that is released upon grinding of leaves.

The term “richness” according to the present application refers to a deep taste such as the taste of tea, soy sauce, fermented foods, and condiments and refers to a deep overall taste in which “saltiness”, “sweetness,” and “umami” of a food itself are combined and that lasts in the mouth. The “aroma” and texture such as thickness also contribute to this “richness”. The term “richness of matcha” according to the present application refers to the “richness” that is experienced when drinking matcha (matcha tea), for example.

The term “umami” according to the present application refers to one of the basic tastes together with “sourness”, “saltiness”, “sweetness”, and “bitterness”. Glutamic acid, inosinic acid, guanylic acid, and the like are examples of substances that give a taste of “umami”. The term “umami” according to the present application refers to the “umami” that is experienced which drinking Japanese kelp or dried bonito broth, for example. The term “umami of matcha” according to the present application refers to the “umami” that is experienced when drinking matcha (matcha tea), for example.

The term “sweetness” according to the present application refers to one of the basic tastes together with “sourness”, “saltiness”, “bitterness”, and “umami”. More specifically, the term “sweetness” according to the present application refers to the taste that is experienced when eating something that contains sugar, a saccharide-based sweetener such as fructose, or the like. The term “sweetness of matcha” according to the present application refers to the “sweetness” that is experienced when drinking matcha (matcha tea), for example.

The term “flavor” according to the present application refers to a combination of the aroma (also referred to generally as “flavor”) and the taste (referring collectively to “sourness”, “saltiness”, “sweetness”, bitterness”, and “umami”) that is received when a food or beverage is taken into the mouth. The term “flavor of matcha” according to the present application refers to the “flavor” that is experienced when drinking matcha (matcha tea), for example.

The “strength” of a parameter such as bitterness, aroma, richness, umami, sweetness, or flavor according to the present application refers to the intensity level of that parameter as based on perception in a sensory evaluation of a food or beverage by an evaluator or tester.

The “preferability” of a parameter such as bitterness, aroma, richness, umami, sweetness, or flavor according to the present application refers to a subjective like/dislike based on perception in a sensory evaluation of a food or beverage by an evaluator or tester.

“Enhancing” a certain parameter (for example, “richness”) according to the present application means that when causing a transition from a state A to a state B that is a transition of state relating to “strength” of that parameter (for example, “richness”), the level of “strength” of the parameter (for example, “richness”) in the state B is equal to or higher than the level of “strength” of the parameter (for example, “richness”) in the state A.

The term “enhancer” according to the present application refers to an agent having an effect of “enhancing” such as described above. There are instances in which the “enhancer” according to the present application is provided in an individual form, a kit form, or the like that is not contained in a matcha food or beverage, but there are also instances in which the “enhancer” is provided in a form in which it is contained in a matcha food or beverage. In a situation in which the “enhancer” according to the present application is provided in an individual form or a kit form, the “enhancer” may, for example, be provided in a state in which it is housed in a vessel or a state in which it is housed in a cap of a bottle, for example, as a powder, granules, a tablet, a liquid, or the like, but is not limited to being provided in this form.

“Deterioration” of a certain parameter (for example, “richness”) according to the present application means that in a situation in which there is a transition from a state A to a state B that is a transition of state relating to that parameter (for example, “richness”), the state A is defined as a more desirable state than the state B. “Deterioration” relating to a given sensory evaluation parameter can be evaluated as the “strength” of that sensory evaluation parameter transitioning to a weaker state or transitioning to a stronger state, depending on the sensory evaluation parameter, when sensory evaluation is performed. Moreover, “deterioration” relating to a certain sensory evaluation parameter can be evaluated as the “preferability” of that sensory evaluation parameter typically transitioning to a less preferable state when sensory evaluation is performed.

“Deterioration of richness of matcha” according to the present application can be evaluated as the “strength” of “richness” becoming weaker when a sensory evaluation of “richness” according to the present application is performed. Moreover, “deterioration of richness of matcha” according to the present application can be evaluated as the “preferability” of “richness” becoming less preferable when a sensory evaluation of “richness” according to the present application is performed.

“Deterioration of aroma of matcha” according to the present application can be evaluated as the “strength” of “aroma” becoming weaker when a sensory evaluation of “aroma” according to the present application is performed. Moreover, “deterioration of aroma of matcha” according to the present application can be evaluated as the “preferability” of “aroma” becoming less preferable when a sensory evaluation of “aroma” according to the present application is performed.

“Deterioration of flavor of matcha” according to the present application can be evaluated as the “strength” of “flavor” becoming weaker when a sensory evaluation of “flavor” according to the present application is performed. Moreover, “deterioration of flavor of matcha” according to the present application can be evaluated as the “preferability” of “flavor” becoming less preferable when a sensory evaluation of “flavor” according to the present application is performed.

“Deterioration of bitterness of matcha” according to the present application can be evaluated as the “strength” of “bitterness” becoming weaker when a sensory evaluation of “bitterness” according to the present application is performed. Moreover, “deterioration of bitterness of matcha” according to the present application can be evaluated as the “preferability” of “bitterness” becoming less preferable when a sensory evaluation of “bitterness” according to the present application is performed.

“Deterioration of umami of matcha” according to the present application can be evaluated as the “strength” of “umami” becoming weaker when a sensory evaluation of “umami” according to the present application is performed. Moreover, “deterioration of umami of matcha” according to the present application can be evaluated as the “preferability” of “umami” becoming less preferable when a sensory evaluation of “umami” according to the present application is performed.

“Deterioration of sweetness of matcha” according to the present application can be evaluated as the “strength” of “sweetness” becoming weaker when a sensory evaluation of “sweetness” according to the present application is performed. Moreover, “deterioration of sweetness of matcha” according to the present application can be evaluated as the “preferability” of “sweetness” becoming less preferable when a sensory evaluation of “sweetness” according to the present application is performed.

The term “prevent” according to the present application refers to ensuring that a transition of state does not occur. “Preventing deterioration” according to the present application means ensuring that “deterioration” does not occur and maintaining a state without transition thereof, and “preventing deterioration” also encompasses transition to a state that is defined as more desirable. For example, “preventing deterioration” of “richness” means ensuring that there is not a transition to a state in which the “strength” of “richness” has become weaker when a sensory evaluation of the “strength” of “richness” according to the present application is performed. Accordingly, “preventing deterioration” of “richness” may be evaluated as the “strength” of “richness” being maintained over time and also as the “strength” of “richness” transitioning to a stronger state over time, for example. Likewise, “preventing deterioration” of “flavor” means ensuring that there is not a transition to a state in which the “strength” of “flavor” has become weaker when a sensory evaluation of the “strength” of “flavor” according to the present application is performed. Accordingly, “preventing deterioration” of “flavor” may be evaluated as the “strength” of “flavor” being maintained over time and also as the “strength” of “flavor” transitioning to a stronger state over time, for example.

The term “deterioration preventing agent” according to the present application refers to an agent having an effect of “preventing deterioration” such as described above. There are instances in which the “deterioration preventing agent” according to the present application is provided in an individual form, a kit form, or the like that is not contained in a matcha food or beverage, but there are also instances in which the “deterioration preventing agent” is provided in a form in which it is contained in a matcha food or beverage. In a situation in which the “deterioration preventing agent” according to the present application is provided in an individual form or a kit form, the “deterioration preventing agent” may, for example, be provided in a state in which it is housed in a vessel or a state in which it is housed in a cap of a bottle, for example, as a powder, granules, a tablet, a liquid, or the like, but is not limited to being provided in this form.

“Adjustment” in relation to a given parameter (for example, “bitterness”, “aroma”, “richness”, “umami”, “flavor”, “sweetness”, etc., but not limited thereto) according to the present application means causing transition of “strength” relating to that parameter from a state at a certain arbitrary level (state A) to a state at another certain arbitrary level (state B) and/or causing transition of “preferability” relating to that parameter from a state at a certain arbitrary level (state A) to a state at another certain arbitrary level (state B). In the preceding context, it may be the case that the certain arbitrary level and the other certain arbitrary level are the same level or are different levels. For example, the “strength” of “richness” may be “adjusted” such that the level of “strength” of richness in the state B is equal to or lower than the level of “strength” of “richness” in the state A. Alternatively, the “strength” of “richness” may be “adjusted” such that the level of “strength” of richness in the state B is equal to or higher than the level of “strength” of richness in the state A, and in this case, “adjustment” referred to above has the same meaning as “enhancement” according to the present application.

The term “adjusting agent” in relation to a certain parameter according to the present application refers to an agent having an effect of “adjustment” such as described above. There are instances in which the “adjusting agent” according to the present application is provided in an individual form, a kit form, or the like that is not contained in a matcha food or beverage, but there are also instances in which the “adjusting agent” is provided in a form in which it is contained in a matcha food or beverage. In a situation in which the “adjusting agent” according to the present application is provided in an individual form or a kit form, the “adjusting agent” may, for example, be provided in a state in which it is housed in a vessel or a state in which it is housed in a cap of a bottle, for example, as a powder, granules, a tablet, a liquid, or the like, but is not limited to being provided in this form.

“Leucine”, “isoleucine”, “valine”, and “aspartic acid” according to the present application are amino acids and may be the L optical isomer or the D optical isomer thereof, but are preferably the L isomer. “Leucine”, “isoleucine”, “valine”, and “aspartic acid” according to the present application may each be a mixture of the L isomer and the D isomer thereof in any ratio.

The term “aspartic acid salt” according to the present application refers to a substance in which at least one carboxy group in aspartic acid has a salt structure. Examples of the “aspartic acid salt” include sodium aspartate, potassium aspartate, and magnesium aspartate, but are not specifically limited thereto. The “aspartic acid salt” according to the present application is preferably sodium aspartate.

When a numerical range is expressed as “A to B” or “A-B” in the present application, this numerical range is inclusive of the boundary value A and the boundary value B unless otherwise specified. For example, the expressions “10 to 100” and “10-100” indicate a numerical range of not less than 10 and not more than 100.

A matcha richness enhancer that enhances the richness of matcha in a matcha food or beverage according to the present application contains leucine.

The matcha richness enhancer that enhances the richness of matcha in a matcha food or beverage according to the present application preferably contains leucine and an aspartic acid salt. This is because a matcha richness enhancer that further contains an aspartic acid salt in addition to leucine has a stronger effect of enhancing the richness of matcha in a matcha food or beverage.

The matcha richness enhancer that enhances the richness of matcha in a matcha food or beverage according to the present application preferably contains leucine, an aspartic acid salt, isoleucine, and valine. This is because a matcha richness enhancer that further contains an aspartic acid salt, isoleucine, and valine in addition to leucine has a stronger effect of enhancing the richness of matcha in a matcha food or beverage.

The matcha richness enhancer that enhances the richness of matcha in a matcha food or beverage according to the present application is preferably further used in order to prevent deterioration of the richness and/or flavor of matcha in a matcha food or beverage. This is because the matcha richness enhancer has an effect of preventing deterioration of the richness and/or flavor of matcha in a matcha food or beverage in addition to an effect of enhancing the richness of matcha in a matcha food or beverage.

The matcha richness enhancer that enhances the richness of matcha in a matcha food or beverage according to the present application preferably contains leucine and an aspartic acid salt such that parts by mass of the leucine: parts by mass of the aspartic acid salt is a blending ratio within a range of 76 to 94:6 to 24. This is because a matcha richness enhancer that contains leucine and an aspartic acid salt such that parts by mass of the leucine: parts by mass of the aspartic acid salt is a blending ratio within a range of 76 to 94:6 to 24 has a strong effect of enhancing the richness of matcha in a matcha food or beverage and also makes the preferability of richness and/or flavor of matcha in a matcha food or beverage more preferable. For the same reason, the matcha richness enhancer that enhances the richness of matcha in a matcha food or beverage according to the present application more preferably contains leucine and an aspartic acid salt such that parts by mass of the leucine: parts by mass of the aspartic acid salt is a blending ratio within a range of 82 to 91:9 to 18. Furthermore, the matcha richness enhancer that enhances the richness of matcha in a matcha food or beverage according to the present application even more preferably contains leucine and an aspartic acid salt such that parts by mass of the leucine: parts by mass of the aspartic acid salt is a blending ratio of 88:12.

The matcha richness enhancer that enhances the richness of matcha in a matcha food or beverage according to the present application preferably contains leucine, isoleucine, valine, and an aspartic acid salt such that total parts by mass of the leucine, the isoleucine, and the valine: parts by mass of the aspartic acid salt is a blending ratio within a range of 76 to 94:6 to 24. This is because a matcha richness enhancer that contains leucine, isoleucine, valine, and an aspartic acid salt such that total parts by mass of the leucine, the isoleucine, and the valine: parts by mass of the aspartic acid salt is a blending ratio within a range of 76 to 94:6 to 24 has a strong effect of enhancing the richness of matcha in a matcha food or beverage and also makes the preferability of richness and/or flavor of matcha in a matcha food or beverage more preferable. Leucine, isoleucine, and valine are referred to as branched-chain amino acids (BCAAs) due to features thereof with regards to molecular structure, and although leucine, isoleucine, and valine also have different effects to one another in relation to taste, they each give a taste of “bitterness” and generally display a similar effect. Moreover, this is also because this matcha richness enhancer also has an effect of preventing deterioration of the richness and/or flavor of matcha in a matcha food or beverage. For the same reason, the matcha richness enhancer that enhances the richness of matcha in a matcha food or beverage according to the present application more preferably contains leucine, isoleucine, valine, and an aspartic acid salt such that total parts by mass of the leucine, the isoleucine, and the valine: parts by mass of the aspartic acid salt is a blending ratio within a range of 82 to 91:9 to 18. Furthermore, the matcha richness enhancer that enhances the richness of matcha in a matcha food or beverage according to the present application even more preferably contains leucine, isoleucine, valine, and an aspartic acid salt such that total parts by mass of the leucine, the isoleucine, and the valine: parts by mass of the aspartic acid salt is a blending ratio of 88:12.

The matcha richness enhancer that enhances the richness of matcha in a matcha food or beverage according to the present application preferably contains leucine, isoleucine, and valine such that parts by mass of the leucine: parts by mass of the isoleucine: parts by mass of the valine is a blending ratio within a range of 40 to 64:6 to 24:6 to 24. This is because a matcha richness enhancer that contains leucine, isoleucine, and valine such that parts by mass of the leucine: parts by mass of the isoleucine: parts by mass of the valine is a blending ratio within a range of 40 to 64:6 to 24:6 to 24 has a strong effect of enhancing the richness of matcha in a matcha food or beverage and also makes the preferability of richness and/or flavor of matcha in a matcha food or beverage more preferable. This is also because this matcha richness enhancer also has an effect of preventing deterioration of the richness and/or flavor of matcha in a matcha food or beverage. For the same reason, the matcha richness enhancer that enhances the richness of matcha in a matcha food or beverage according to the present application more preferably contains leucine, isoleucine, and valine such that parts by mass of the leucine: parts by mass of the isoleucine: parts by mass of the valine is a blending ratio within a range of 48 to 60:11 to 20:11 to 20. The matcha richness enhancer that enhances the richness of matcha in a matcha food or beverage according to the present application even more preferably contains leucine, isoleucine, and valine such that parts by mass of the leucine: parts by mass of the isoleucine: parts by mass of the valine is a blending ratio of 56:16:16.

The matcha richness enhancer that enhances the richness of matcha in a matcha food or beverage according to the present application is preferably a matcha richness enhancer that enhances the richness of matcha in a powdered matcha product. This is because the matcha richness enhancer that enhances the richness of matcha in a matcha food or beverage according to the present application enhances the richness of matcha in a powdered matcha product and/or enhances the richness of matcha in a matcha food or beverage that is produced from a powdered matcha product containing the matcha richness enhancer. This is also because the matcha richness enhancer that enhances the richness of matcha in a matcha food or beverage according to the present application prevents deterioration of the richness and/or flavor of matcha in a powdered matcha product and/or prevents deterioration of the richness and/or flavor of matcha in a matcha food or beverage that is produced from a powdered matcha product containing the matcha richness enhancer.

The matcha richness enhancer that enhances the richness of matcha in a powdered matcha product according to the present application is preferably for blending such that parts by mass of powdered matcha: parts by mass of the matcha richness enhancer in the powdered matcha product is a blending ratio within a range of 1,000:33 to 334. This is because when the matcha richness enhancer that enhances the richness of matcha in a powdered matcha product according to the present application is blended such that parts by mass of powdered matcha: parts by mass of the matcha richness enhancer in the powdered matcha product is a blending ratio within a range of 1,000:33 to 334, the matcha richness enhancer enhances the richness of matcha in the powdered matcha product and/or enhances the richness of matcha in a matcha food or beverage that is produced from the powdered matcha product containing the matcha richness enhancer. This is also because when the matcha richness enhancer is blended in a blending ratio within a range such as set forth above, the matcha richness enhancer prevents deterioration of the richness and/or flavor of matcha in the powdered matcha product and/or prevents deterioration of the richness and/or flavor of matcha in a matcha food or beverage that is produced from the powdered matcha product containing the matcha richness enhancer. For the same reason, the matcha richness enhancer that enhances the richness of matcha in a powdered matcha product according to the present application is more preferably for blending such that parts by mass of powdered matcha: parts by mass of the matcha richness enhancer in the powdered matcha product is a blending ratio within a range of 1,000:33 to 267. The matcha richness enhancer that enhances the richness of matcha in a powdered matcha product according to the present application is even more preferably for blending such that parts by mass of powdered matcha: parts by mass of the matcha richness enhancer in the powdered matcha product is a blending ratio within a range of 1,000:66 to 200.

A powdered matcha product according to the present application contains the matcha richness enhancer that enhances the richness of matcha in a powdered matcha product according to the present application. This is because as a result of the powdered matcha product according to the present application containing the matcha richness enhancer that enhances the richness of matcha in a powdered matcha product according to the present application, the richness of matcha in the powdered matcha product is enhanced and/or the powdered matcha product enhances the richness of matcha in a matcha food or beverage that is produced from the powdered matcha product containing the matcha richness enhancer. This is also because as a result of the powdered matcha product according to the present application containing the matcha richness enhancer that enhances the richness of matcha in a powdered matcha product according to the present application, deterioration of the richness and/or flavor of matcha in the powdered matcha product is prevented and/or deterioration of the richness and/or flavor of matcha in a matcha food or beverage that is produced from the powdered matcha product containing the matcha richness enhancer is prevented.

The powdered matcha product according to the present application preferably contains powdered matcha and the matcha richness enhancer such that parts by mass of the powdered matcha: parts by mass of the matcha richness enhancer is a blending ratio within a range of 1,000:33 to 334. This is because with a powdered matcha product that contains powdered matcha and the matcha richness enhancer such that parts by mass of the powdered matcha: parts by mass of the matcha richness enhancer is a blending ratio within a range of 1,000:33 to 334, the richness of matcha in the powdered matcha product is enhanced and/or the powdered matcha product enhances the richness of matcha in a matcha food or beverage that is produced from the powdered matcha product containing the matcha richness enhancer. This is also because with a powdered matcha product having a blending ratio within a range such as set forth above, deterioration of the richness and/or flavor of matcha in the powdered matcha product is prevented and/or deterioration of the richness and/or flavor of matcha in a matcha food or beverage that is produced from the powdered matcha product containing the matcha richness enhancer is prevented. For the same reason, the powdered matcha product according to the present application more preferably contains powdered matcha and the matcha richness enhancer such that parts by mass of the powdered matcha: parts by mass of the matcha richness enhancer is a blending ratio within a range of 1,000:33 to 267. The powdered matcha product according to the present application even more preferably contains powdered matcha and the matcha richness enhancer such that parts by mass of the powdered matcha: parts by mass of the matcha richness enhancer is a blending ratio within a range of 1,000:66 to 200.

The matcha richness enhancer that enhances the richness of matcha in a matcha food or beverage according to the present application is preferably a matcha richness enhancer that enhances the richness of matcha in a matcha beverage. This is because the matcha richness enhancer that enhances the richness of matcha in a matcha food or beverage according to the present application enhances the richness of matcha in a matcha beverage. This is also because the matcha richness enhancer that enhances the richness of matcha in a matcha food or beverage according to the present application prevents deterioration of the richness and/or flavor of matcha in a matcha beverage.

The matcha richness enhancer that enhances the richness of matcha in a matcha beverage according to the present application is preferably for blending such that parts by mass of powdered matcha: parts by mass of the matcha richness enhancer in the matcha beverage is a blending ratio within a range of 1,000:33 to 334. This is because when the matcha richness enhancer that enhances the richness of matcha in a matcha beverage according to the present application is blended such that parts by mass of powdered matcha: parts by mass of the matcha richness enhancer in the matcha beverage is a blending ratio within a range of 1,000:33 to 334, the strength of richness of matcha in the matcha beverage becomes even stronger. This is also because when this matcha richness enhancer is blended in a blending ratio within a range such as set forth above, the matcha richness enhancer prevents deterioration of the richness and/or flavor of matcha in a matcha beverage. For the same reason, the matcha richness enhancer that enhances the richness of matcha in a matcha beverage according to the present application is more preferably for blending such that parts by mass of powdered matcha: parts by mass of the matcha richness enhancer in the matcha beverage is a blending ratio within a range of 1,000:33 to 267. The matcha richness enhancer that enhances the richness of matcha in a matcha beverage according to the present application is even more preferably for blending such that parts by mass of powdered matcha: parts by mass of the matcha richness enhancer in the matcha beverage is a blending ratio within a range of 1,000:66 to 200.

A matcha beverage according to the present application contains the matcha richness enhancer that enhances the richness of matcha in a matcha beverage according to the present application. This is because as a result of the matcha beverage according to the present application containing the matcha richness enhancer that enhances the richness of matcha in a matcha beverage according to the present application, the richness of matcha in the matcha beverage is enhanced. This is also because as a result of the matcha beverage according to the present application containing the matcha richness enhancer that enhances the richness of matcha in a matcha beverage according to the present application, deterioration of the richness and/or flavor of matcha in the matcha beverage is prevented.

The matcha beverage according to the present application preferably contains powdered matcha and the matcha richness enhancer such that parts by mass of the powdered matcha: parts by mass of the matcha richness enhancer is a blending ratio within a range of 1,000:33 to 334. This is because with a matcha beverage that contains powdered matcha and the matcha richness enhancer such that parts by mass of the powdered matcha: parts by mass of the matcha richness enhancer is a blending ratio within a range of 1,000:33 to 334, the richness of matcha in the matcha beverage is enhanced. This is also because with a matcha beverage having a blending ratio within a range such as set forth above, deterioration of the richness and/or flavor of matcha in the matcha beverage is prevented. For the same reason, the matcha beverage according to the present application more preferably contains powdered matcha and the matcha richness enhancer such that parts by mass of the powdered matcha: parts by mass of the matcha richness enhancer is a blending ratio within a range of 1,000:33 to 267. The matcha beverage according to the present application even more preferably contains powdered matcha and the matcha richness enhancer such that parts by mass of the powdered matcha: parts by mass of the matcha richness enhancer is a blending ratio within a range of 1,000:66 to 200.

The matcha richness enhancer that enhances the richness of matcha in a matcha food or beverage according to the present application is preferably a matcha richness enhancer that enhances the richness of matcha in a matcha candy. This is because the matcha richness enhancer that enhances the richness of matcha in a matcha food or beverage according to the present application enhances the richness of matcha in a matcha candy. This is also because the matcha richness enhancer that enhances the richness of matcha in a matcha food or beverage according to the present application prevents deterioration of the richness and/or flavor of matcha in a matcha candy.

The matcha richness enhancer that enhances the richness of matcha in a matcha candy according to the present application is preferably for blending such that parts by mass of powdered matcha: parts by mass of the matcha richness enhancer in the matcha candy is a blending ratio within a range of 75 to 30:10 to 55 or within a range of 75 to 46:10 to 39. This is because when the matcha richness enhancer that enhances the richness of matcha in a matcha candy according to the present application is blended such that parts by mass of powdered matcha: parts by mass of the matcha richness enhancer in the matcha candy is a blending ratio within a range of 75 to 30:10 to 55 or within a range of 75 to 46:10 to 39, the strength of richness of matcha in the matcha candy becomes even stronger. This is also because when this matcha richness enhancer is blended in a blending ratio within a range such as set forth above, the matcha richness enhancer prevents deterioration of the richness and/or flavor of matcha in a matcha candy. For the same reason, the matcha richness enhancer that enhances the richness of matcha in a matcha candy according to the present application is more preferably for blending such that parts by mass of powdered matcha: parts by mass of the matcha richness enhancer in the matcha candy is a blending ratio within a range of 75 to 50:10 to 35. The matcha richness enhancer that enhances the richness of matcha in a matcha candy according to the present application is even more preferably for blending such that parts by mass of powdered matcha: parts by mass of the matcha richness enhancer in the matcha candy is a blending ratio within a range of 65 to 50:20 to 35. Note that mass ratios such as that mentioned here are mass ratios for when the total of parts by mass of powdered matcha and parts by mass of the matcha richness enhancer in the matcha candy is taken to be 85.

A matcha candy according to the present application contains the matcha richness enhancer that enhances the richness of matcha in a matcha candy according to the present application. This is because as a result of the matcha candy according to the present application containing the matcha richness enhancer that enhances the richness of matcha in a matcha candy according to the present application, the richness of matcha in the matcha candy is enhanced. This is also because as a result of the matcha candy according to the present application containing the matcha richness enhancer that enhances the richness of matcha in a matcha candy according to the present application, deterioration of the richness and/or flavor of matcha in the matcha candy is prevented.

The matcha candy according to the present application preferably contains powdered matcha and the matcha richness enhancer such that parts by mass of the powdered matcha: parts by mass of the matcha richness enhancer is a blending ratio within a range of 75 to 30:10 to 55 or within a range of 75 to 46:10 to 39. This is because with a matcha candy that contains powdered matcha and the matcha richness enhancer such that parts by mass of the powdered matcha: parts by mass of the matcha richness enhancer is a blending ratio within a range of 75 to 30:10 to 55 or within a range of 75 to 46:10 to 39, the richness of matcha in the matcha candy is enhanced. This is also because with a matcha candy having a blending ratio within a range such as set forth above, deterioration of the richness and/or flavor of matcha in the matcha candy is prevented. For the same reason, the matcha candy according to the present application more preferably contains powdered matcha and the matcha richness enhancer such that parts by mass of the powdered matcha: parts by mass of the matcha richness enhancer is a blending ratio within a range of 75 to 50:10 to 35. The matcha candy according to the present application even more preferably contains powdered matcha and the matcha richness enhancer such that parts by mass of the powdered matcha: parts by mass of the matcha richness enhancer is a blending ratio within a range of 65 to 50:20 to 35. Note that mass ratios such as that mentioned here can be mass ratios for when the total of parts by mass of powdered matcha and parts by mass of the matcha richness enhancer in the matcha candy is taken to be 85.

The matcha richness enhancer that enhances the richness of matcha in a matcha food or beverage according to the present application is preferably a matcha richness enhancer that enhances the richness of matcha in a matcha baked sweet. This is because the matcha richness enhancer that enhances the richness of matcha in a matcha food or beverage according to the present application enhances the richness of matcha in a matcha baked sweet. This is also because the matcha richness enhancer that enhances the richness of matcha in a matcha food or beverage according to the present application prevents deterioration of the richness and/or flavor of matcha in a matcha baked sweet.

The matcha richness enhancer that enhances the richness of matcha in a matcha baked sweet according to the present application is preferably for blending such that parts by mass of powdered matcha: parts by mass of the matcha richness enhancer in the matcha baked sweet is a blending ratio within a range of 1.25:0.5 to 3. This is because when the matcha richness enhancer that enhances the richness of matcha in a matcha baked sweet according to the present application is blended such that parts by mass of powdered matcha: parts by mass of the matcha richness enhancer in the matcha baked sweet is a blending ratio within a range of 1.25:0.5 to 3, the strength of richness of matcha in the matcha baked sweet becomes even stronger. This is also because when this matcha richness enhancer is blended in a blending ratio within a range such as set forth above, the matcha richness enhancer prevents deterioration of the richness and/or flavor of matcha in a matcha baked sweet. For the same reason, the matcha richness enhancer that enhances the richness of matcha in a matcha baked sweet according to the present application is more preferably for blending such that parts by mass of powdered matcha: parts by mass of the matcha richness enhancer in the matcha baked sweet is a blending ratio within a range of 1.25:0.5 to 2.5. The matcha richness enhancer that enhances the richness of matcha in a matcha baked sweet according to the present application is even more preferably for blending such that parts by mass of powdered matcha: parts by mass of the matcha richness enhancer in the matcha baked sweet is a blending ratio within a range of 1.25:0.5 to 2. Note that mass ratios such as that mentioned here can be mass ratios for when the total of parts by mass of powdered matcha and parts by mass of the matcha richness enhancer in the matcha baked sweet is taken to be 85.

A matcha baked sweet according to the present application contains the matcha richness enhancer that enhances the richness of matcha in a matcha baked sweet according to the present application. This is because as a result of the matcha baked sweet according to the present application containing the matcha richness enhancer that enhances the richness of matcha in a matcha baked sweet according to the present application, the richness of matcha in the matcha baked sweet is enhanced. This is also because as a result of the matcha baked sweet according to the present application containing the matcha richness enhancer that enhances the richness of matcha in a matcha baked sweet according to the present application, deterioration of the richness and/or flavor of matcha in the matcha baked sweet is prevented.

The matcha baked sweet according to the present application preferably contains powdered matcha and the matcha richness enhancer such that parts by mass of the powdered matcha: parts by mass of the matcha richness enhancer is a blending ratio within a range of 1.25:0.5 to 3. This is because with a matcha baked sweet that contains powdered matcha and the matcha richness enhancer such that parts by mass of the powdered matcha: parts by mass of the matcha richness enhancer is a blending ratio within a range of 1.25:0.5 to 3, the richness of matcha in the matcha baked sweet is enhanced. This is also because with a matcha baked sweet having a blending ratio within a range such as set forth above, deterioration of the richness and/or flavor of matcha in the matcha baked sweet is prevented. For the same reason, the matcha baked sweet according to the present application more preferably contains powdered matcha and the matcha richness enhancer such that parts by mass of the powdered matcha: parts by mass of the matcha richness enhancer is a blending ratio within a range of 1.25:0.5 to 2.5. The matcha baked sweet according to the present application even more preferably contains powdered matcha and the matcha richness enhancer such that parts by mass of the powdered matcha: parts by mass of the matcha richness enhancer is a blending ratio within a range of 1.25:0.5 to 2. Note that mass ratios such as that mentioned here can be mass ratios for when the total of parts by mass of powdered matcha and parts by mass of the matcha richness enhancer in the matcha baked sweet is taken to be 85.

The matcha richness enhancer that enhances the richness of matcha in a matcha food or beverage according to the present application is preferably a matcha richness enhancer that enhances the richness of matcha in matcha ice cream. This is because the matcha richness enhancer that enhances the richness of matcha in a matcha food or beverage according to the present application enhances the richness of matcha in matcha ice cream. This is also because the matcha richness enhancer that enhances the richness of matcha in a matcha food or beverage according to the present application prevents deterioration of the richness and/or flavor of matcha in matcha ice cream.

The matcha richness enhancer that enhances the richness of matcha in matcha ice cream according to the present application is preferably for blending such that parts by mass of powdered matcha: parts by mass of the matcha richness enhancer in the matcha ice cream is a blending ratio within a range of 12:0.5 to 4. This is because when the matcha richness enhancer that enhances the richness of matcha in matcha ice cream according to the present application is blended such that parts by mass of powdered matcha: parts by mass of the matcha richness enhancer in the matcha ice cream is a blending ratio within a range of 12:0.5 to 4, the strength of richness of matcha in the matcha ice cream becomes even stronger. This is also because when this matcha richness enhancer is blended in a blending ratio within a range such as set forth above, the matcha richness enhancer prevents deterioration of the richness and/or flavor of matcha in matcha ice cream. For the same reason, the matcha richness enhancer that enhances the richness of matcha in matcha ice cream according to the present application is more preferably for blending such that parts by mass of powdered matcha: parts by mass of the matcha richness enhancer in the matcha ice cream is a blending ratio within a range of 12:0.5 to 3. The matcha richness enhancer that enhances the richness of matcha in matcha ice cream according to the present application is even more preferably for blending such that parts by mass of powdered matcha: parts by mass of the matcha richness enhancer in the matcha ice cream is a blending ratio within a range of 12:0.5 to 2.5. Note that mass ratios such as that mentioned here can be mass ratios for when the total of parts by mass of powdered matcha and parts by mass of the matcha richness enhancer in the matcha ice cream is taken to be 85.

Matcha ice cream according to the present application contains the matcha richness enhancer that enhances the richness of matcha in matcha ice cream according to the present application. This is because as a result of the matcha ice cream according to the present application containing the matcha richness enhancer that enhances the richness of matcha in matcha ice cream according to the present application, the richness of matcha in the matcha ice cream is enhanced. This is also because as a result of the matcha ice cream according to the present application containing the matcha richness enhancer that enhances the richness of matcha in matcha ice cream according to the present application, deterioration of the richness and/or flavor of matcha in the matcha ice cream is prevented.

The matcha ice cream according to the present application preferably contains powdered matcha and the matcha richness enhancer such that parts by mass of the powdered matcha: parts by mass of the matcha richness enhancer is a blending ratio within a range of 12:0.5 to 4. This is because with matcha ice cream that contains powdered matcha and the matcha richness enhancer such that parts by mass of the powdered matcha: parts by mass of the matcha richness enhancer is a blending ratio within a range of 12:0.5 to 4, the richness of matcha in the matcha ice cream is enhanced. This is also because with matcha ice cream having a blending ratio within a range such as set forth above, deterioration of the richness and/or flavor of matcha in the matcha ice cream is prevented. For the same reason, the matcha ice cream according to the present application more preferably contains powdered matcha and the matcha richness enhancer such that parts by mass of the powdered matcha: parts by mass of the matcha richness enhancer is a blending ratio within a range of 12:0.5 to 3. The matcha ice cream according to the present application even more preferably contains powdered matcha and the matcha richness enhancer such that parts by mass of the powdered matcha: parts by mass of the matcha richness enhancer is a blending ratio within a range of 12:0.5 to 2.5. Note that mass ratios such as that mentioned here can be mass ratios for when the total of parts by mass of powdered matcha and parts by mass of the matcha richness enhancer in the matcha ice cream is taken to be 85.

The matcha richness enhancer that enhances the richness of matcha in a matcha food or beverage according to the present application is preferably a matcha richness enhancer that enhances the richness of matcha in matcha chocolate. This is because the matcha richness enhancer that enhances the richness of matcha in a matcha food or beverage according to the present application enhances the richness of matcha in matcha chocolate. This is also because the matcha richness enhancer that enhances the richness of matcha in a matcha food or beverage according to the present application prevents deterioration of the richness and/or flavor of matcha in matcha chocolate.

The matcha richness enhancer that enhances the richness of matcha in matcha chocolate according to the present application is preferably for blending such that parts by mass of powdered matcha: parts by mass of the matcha richness enhancer in the matcha chocolate is a blending ratio within a range of 16:3.7 to 10. This is because when the matcha richness enhancer that enhances the richness of matcha in matcha chocolate according to the present application is blended such that parts by mass of powdered matcha: parts by mass of the matcha richness enhancer in the matcha chocolate is a blending ratio within a range of 16:3.7 to 10, the strength of richness of matcha in the matcha chocolate becomes even stronger. This is also because when this matcha richness enhancer is blended in a blending ratio within a range such as set forth above, the matcha richness enhancer prevents deterioration of the richness and/or flavor of matcha in matcha chocolate. For the same reason, the matcha richness enhancer that enhances the richness of matcha in matcha chocolate according to the present application is more preferably for blending such that parts by mass of powdered matcha: parts by mass of the matcha richness enhancer in the matcha chocolate is a blending ratio within a range of 16:3.7 to 8.8. The matcha richness enhancer that enhances the richness of matcha in matcha chocolate according to the present application is even more preferably for blending such that parts by mass of powdered matcha: parts by mass of the matcha richness enhancer in the matcha chocolate is a blending ratio within a range of 16:3.7 to 7.5. Note that mass ratios such as that mentioned here can be mass ratios for when the total of parts by mass of powdered matcha and parts by mass of the matcha richness enhancer in the matcha chocolate is taken to be 85.

Matcha chocolate according to the present application contains the matcha richness enhancer that enhances the richness of matcha in matcha chocolate according to the present application. This is because as a result of the matcha chocolate according to the present application containing the matcha richness enhancer that enhances the richness of matcha in matcha chocolate according to the present application, the richness of matcha in the matcha chocolate is enhanced. This is also because as a result of the matcha chocolate according to the present application containing the matcha richness enhancer that enhances the richness of matcha in matcha chocolate according to the present application, deterioration of the richness and/or flavor of matcha in the matcha chocolate is prevented.

The matcha chocolate according to the present application preferably contains powdered matcha and the matcha richness enhancer such that parts by mass of the powdered matcha: parts by mass of the matcha richness enhancer is a blending ratio within a range of 16:3.7 to 10. This is because with matcha chocolate that contains powdered matcha and the matcha richness enhancer such that parts by mass of the powdered matcha: parts by mass of the matcha richness enhancer is a blending ratio within a range of 16:3.7 to 10, the richness of matcha in the matcha chocolate is enhanced. This is also because with matcha chocolate having a blending ratio within a range such as set forth above, deterioration of the richness and/or flavor of matcha in the matcha chocolate is prevented. For the same reason, the matcha chocolate according to the present application more preferably contains powdered matcha and the matcha richness enhancer such that parts by mass of the powdered matcha: parts by mass of the matcha richness enhancer is a blending ratio within a range of 16:3.7 to 8.8. The matcha chocolate according to the present application even more preferably contains powdered matcha and the matcha richness enhancer such that parts by mass of the powdered matcha: parts by mass of the matcha richness enhancer is a blending ratio within a range of 16:3.7 to 7.5. Note that mass ratios such as that mentioned here can be mass ratios for when the total of parts by mass of powdered matcha and parts by mass of the matcha richness enhancer in the matcha chocolate is taken to be 85.

A deterioration preventing agent that prevents deterioration of the richness, aroma, and/or flavor of matcha in a matcha food or beverage according to the present application contains leucine. The deterioration preventing agent that prevents deterioration of the richness, aroma, and/or flavor of matcha in a matcha food or beverage according to the present application preferably contains leucine and an aspartic acid salt. This is because a deterioration preventing agent that further contains an aspartic acid salt in addition to leucine has a stronger effect of preventing deterioration of the richness, aroma, and/or flavor of matcha in a matcha food or beverage. The deterioration preventing agent that prevents deterioration of the richness, aroma, and/or flavor of matcha in a matcha food or beverage according to the present application more preferably contains leucine, isoleucine, valine, and an aspartic acid salt. This is because a deterioration preventing agent that further contains isoleucine, valine, and an aspartic acid salt in addition to leucine has a stronger effect of preventing deterioration of the richness, aroma, and/or flavor of matcha in a matcha food or beverage.

Leucine, isoleucine, and valine are amino acids having “bitterness”, and valine also has “sweetness”. An aspartic acid salt is an amino acid having weak “umami”. Accordingly, a matcha richness enhancer or deterioration preventing agent that contains leucine is thought to also have an effect of directly adjusting “bitterness”. Moreover, a matcha richness enhancer or deterioration preventing agent that contains leucine and an aspartic acid salt is thought to also have an effect of directly adjusting “bitterness” and “umami”. Furthermore, a matcha richness enhancer or deterioration preventing agent that contains leucine, isoleucine, valine, and an aspartic acid salt is thought to also have an effect of directly adjusting “bitterness”, “sweetness”, and “umami”.

Leucine, isoleucine, and valine are categorized as branched-chain amino acids (BCAAs) due to features thereof with regards to molecular structure. These BCAAs have an effect of promoting protein synthesis of skeletal muscle, and this effect is considered to be stronger particularly with leucine. Accordingly, a matcha richness enhancer or deterioration preventing agent that contains leucine and an aspartic acid salt and a matcha richness enhancer or deterioration preventing agent that contains leucine, isoleucine, valine, and an aspartic acid salt impart a breakdown inhibition effect and an enhancement effect with respect to muscle protein.

### EXAMPLES

The following provides an even more detailed description of the present disclosure through examples. However, the present disclosure is not in any way limited by the following examples.

### Example 1: Comparison of Various Amino Acid Compositions for “Bitterness”, “Umami”, “Aroma”, “Richness”, and “Flavor” of Matcha in Matcha Food or Beverage

This test was conducted in order to investigate various amino acid compositions for the effect they have on the “bitterness”, “umami”, “aroma”, “richness”, and “flavor” of matcha in a matcha food or beverage.

### <Ingredients>

Used ingredients and sources thereof were as follows.
Powdered matcha: Powdered Tencha produced in Toyota (Yamauchi Yoshimasa) (Hekien Yamauchi Junpei Shoten)
Water: Okudaisen Mineral Water (Suntory Holdings Limited)
Amino acid compositions: Four types of amino acid compositions (control, L 500 mg, L 440 mg+D 60 mg, and L 280 mg+I 80 mg+V 80 mg+D 60 mg) containing L-valine (V), L-leucine (L), L-isoleucine (I), and sodium L-aspartate (D) with a make-up in terms of parts by mass indicated in the following table

TABLE 1
Make-up of amino acid composition

| | Amino acid composition name | | | |
|---|---|---|---|---|
| | | | | L 280 mg + |
| | | | | I 80 mg + |
| Amino acid | | | L 440 mg + | V 80 mg + |
| components | Control | L 500 mg | D 60 mg | D 60 mg |
| L-Leucine (L) | 0 | 500 | 440 | 280 |
| L-Isoleucine (I) | 0 | 0 | 0 | 80 |
| L-Valine (V) | 0 | 0 | 0 | 80 |
| Sodium | 0 | 0 | 60 | 60 |
| L-aspartate (D) | | | | |
| Total | 0 | 500 | 500 | 500 |

The units of numbers in the table are parts by mass.

### <Preparation Method>

1. 0.5 g of an amino acid composition (0 g in the control) was added into a tea bowl, 80 mL of 80° C. hot water was poured into the tea bowl, and a tea whisk was used to cause dissolution until the amino acid composition was completely dissolved.
2. 2.0 g of powdered matcha was added to 1, was left to blend well therewith, and was subsequently stirred for 1 minute using a tea whisk.
3. After stirring, an outward spiral was drawn in the mixture, and the mixture was transferred to a vessel.

TABLE 2
Contents of various amino acid compositions and
powdered matcha in matcha beverage specimens

| | | Amino acid | Powdered | |
|---|---|---|---|---|
| | | composition | matcha | Matcha beverage |
| Specimen | Added amino acid | [g parts | [g parts | (final volume) |
| name | composition | by mass] | by mass] | [mL] |
| Con | Control | 0.0 | 2.0 | 80 |
| L | L 500 mg | 0.5 | 2.0 | 80 |
| LD | L 440 mg + D 60 mg | 0.5 | 2.0 | 80 |
| LIVD | L 280 mg + I 80 mg + | 0.5 | 2.0 | 80 |
| | V 80 mg + D 60 mg | | | |

### <Test Method>

The four types of matcha beverage specimens (Con, L, LD, LIVD) that had been prepared, inclusive of the control, were each poured into a paper cup, and these matcha beverage specimens were randomly assigned the letters A to D as specimen names in order that the testers would not know which amino acid composition had been added. The testers tasted each of these matcha beverage specimens and gave a scored evaluation for a total of five parameters (“bitterness”, “umami”, “aroma”, “richness”, and “flavor”) from viewpoints of “strength” and “preferability” thereof, and also from a viewpoint of “overall evaluation” taking into account texture, appearance, and so forth in addition to taste.

### <Scored Evaluation>

With regards to “strength” of “bitterness”, “umami”, “aroma”, “richness”, and “flavor”, the four types of matcha beverage specimens that had been prepared, inclusive of the control, were ranked in order from 1^{st} to 4^{th} for the “strength” of each evaluation parameter, and then the specimen ranked as strongest (1^{st}) was allotted 4 points, the specimen ranked as 2^{nd} strongest was allotted 3 points, the specimen ranked as 3^{rd} strongest was allotted 2 points, and the specimen ranked as 4^{th} strongest was allotted 1 point. Averages were calculated from the evaluation scores of testers a, b, c, and d, and these averages were compared.

With regards to “preferability” of “bitterness”, “umami”, “aroma”, “richness”, and “flavor” and also with regards to “overall evaluation” taking into account texture, appearance, and so forth in addition to taste, the four types of matcha beverage specimens that had been prepared, inclusive of the control, were ranked in order from 1^{st} to 4^{th} for the “preferability” of each evaluation parameter, and then the specimen ranked most preferable (1^{st}) was allotted 4 points, the specimen ranked 2^{nd} most preferable was allotted 3 points, the specimen ranked 3^{rd} most preferable was allotted 2 points, and the specimen ranked 4^{th} most preferable was allotted 1 point. Averages were calculated from the evaluation scores of testers a, b, c, and d, and these averages were compared.

### <Results>

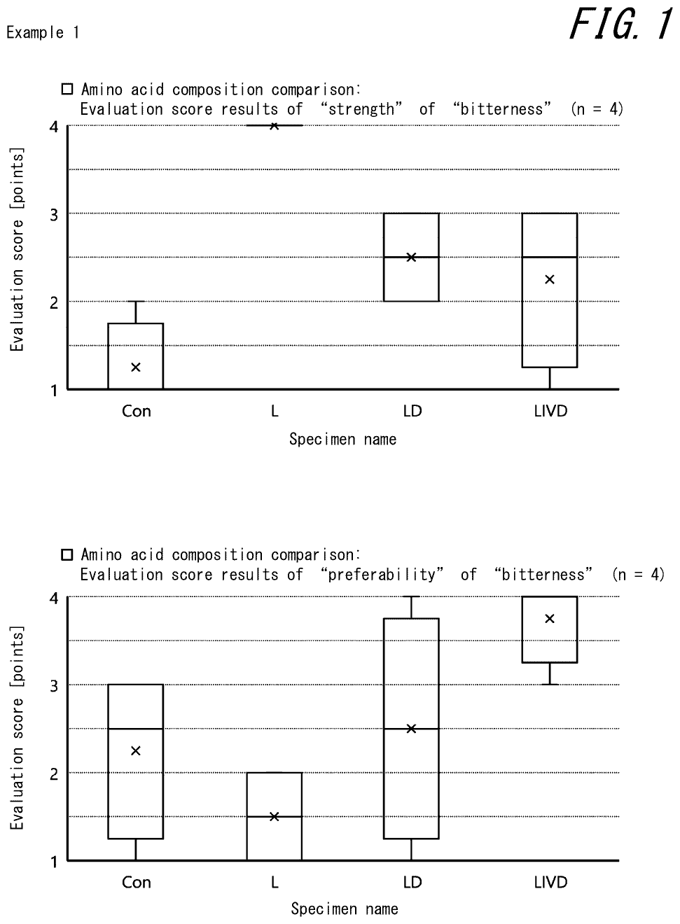

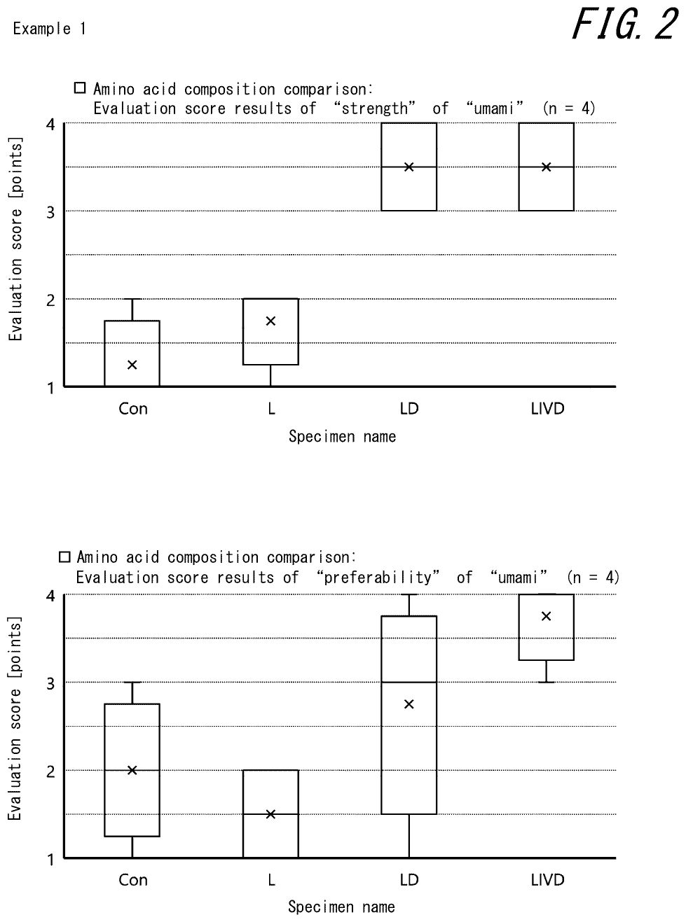

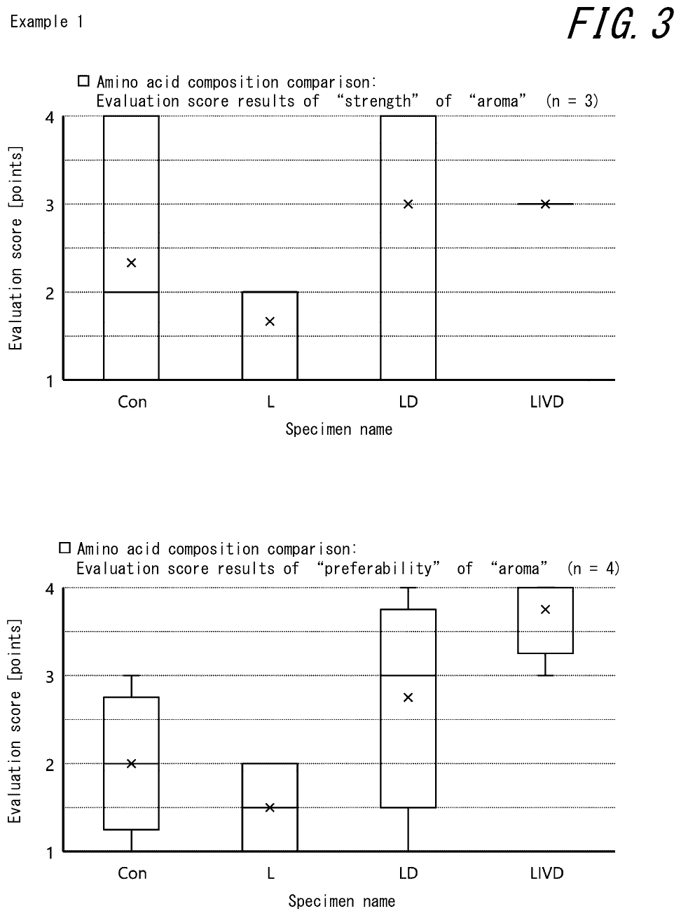

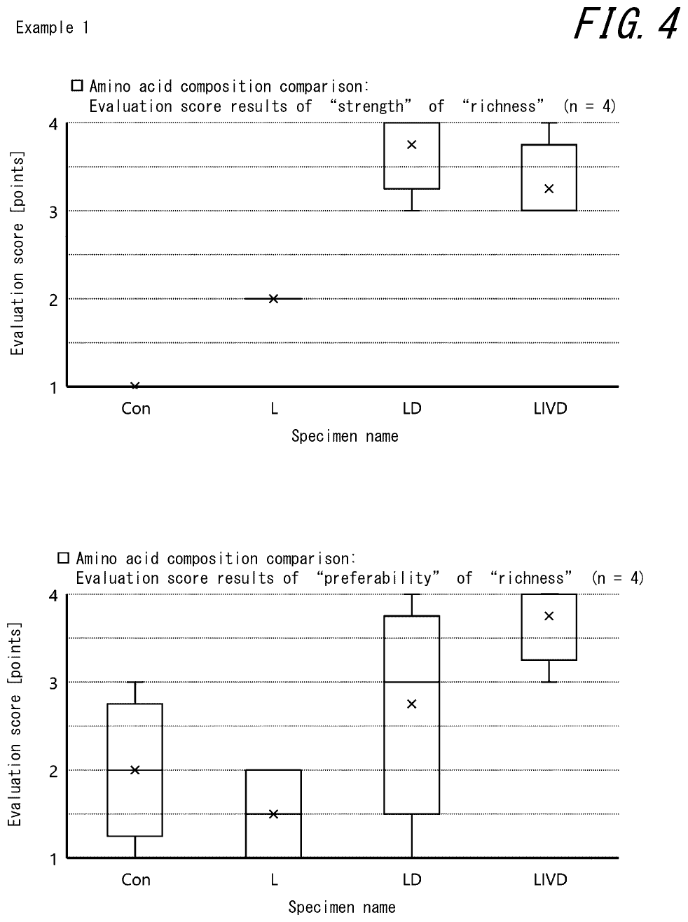

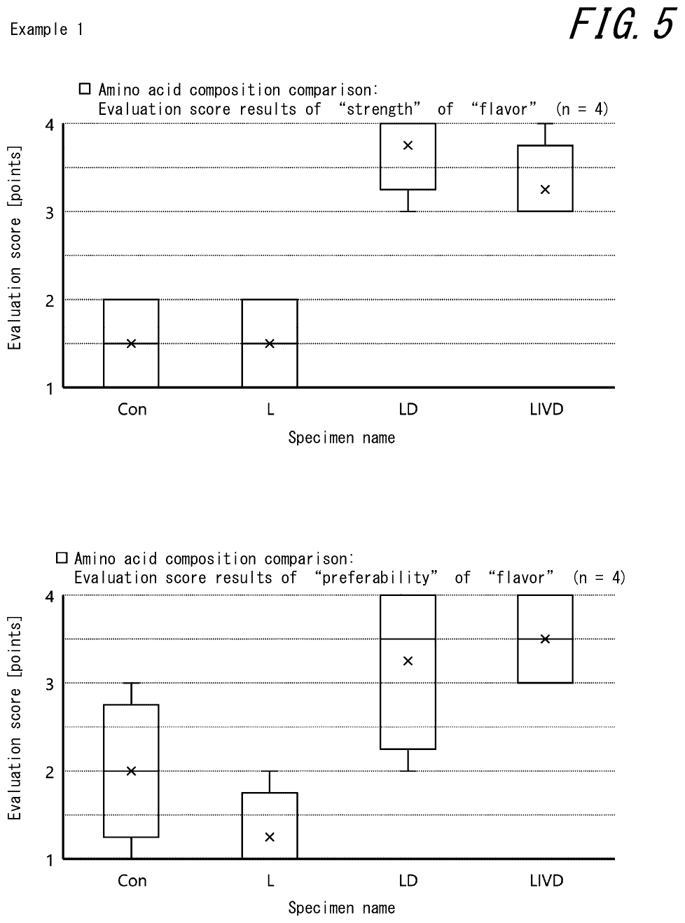

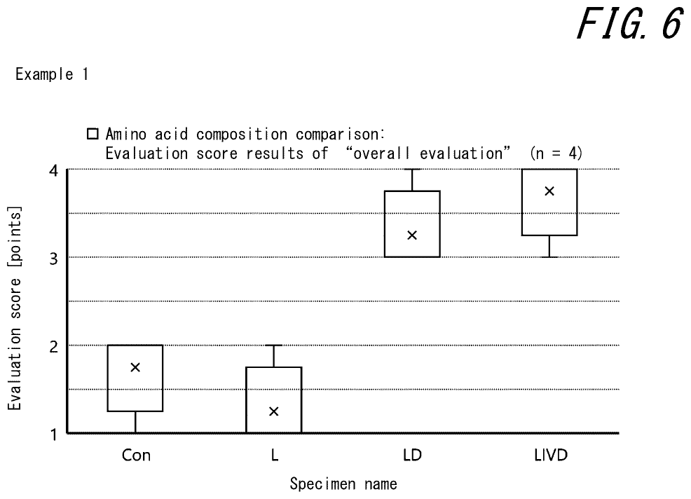

The evaluation score results and averages thereof in this example are presented in the following Tables 3 to 13 and in FIGS. 1 to 6.

TABLE 3
Comparison of amino acid compositions: Evaluation
score results of “strength” of “bitterness”
(n = 4)

| | | | |
|---|---|---|---|
| Specimen | Tester | Total | Average |

| name | a | b | c | d | [points] | [points] |
|---|---|---|---|---|---|---|
| Con | 1 | 2 | 1 | 1 | 5 | 1.25 |
| L | 4 | 4 | 4 | 4 | 16 | 4.00 |
| LD | 3 | 3 | 2 | 2 | 10 | 2.50 |
| LIVD | 2 | 1 | 3 | 3 | 9 | 2.25 |

TABLE 4
Comparison of amino acid compositions: Evaluation
score results of “preferability”
of “bitterness” (n = 4)

| | | | |
|---|---|---|---|
| Specimen | Tester | Total | Average |

| name | a | b | c | d | [points] | [points] |
|---|---|---|---|---|---|---|
| Con | 1 | 3 | 2 | 3 | 9 | 2.25 |
| L | 2 | 2 | 1 | 1 | 6 | 1.50 |
| LD | 3 | 1 | 4 | 2 | 10 | 2.50 |
| LIVD | 4 | 4 | 3 | 4 | 15 | 3.75 |

TABLE 5
Comparison of amino acid compositions: Evaluation score results of
“strength” of “umami” (n = 4)

| | | | |
|---|---|---|---|
| Specimen | Tester | Total | Average |

| name | a | b | c | d | [points] | [points] |
|---|---|---|---|---|---|---|
| Con | 2 | 1 | 1 | 1 | 5 | 1.25 |
| L | 1 | 2 | 2 | 2 | 7 | 1.75 |
| LD | 3 | 3 | 4 | 4 | 14 | 3.50 |
| LIVD | 4 | 4 | 3 | 3 | 14 | 3.50 |

TABLE 6
Comparison of amino acid compositions: Evaluation
score results of “preferability”
of “umami” (n = 4)

| | | | |
|---|---|---|---|
| Specimen | Tester | Total | Average |

| name | a | b | c | d | [points] | [points] |
|---|---|---|---|---|---|---|
| Con | 1 | 3 | 2 | 2 | 8 | 2.00 |
| L | 2 | 2 | 1 | 1 | 6 | 1.50 |
| LD | 3 | 1 | 4 | 3 | 11 | 2.75 |
| LIVD | 4 | 4 | 3 | 4 | 15 | 3.75 |

TABLE 7
Comparison of amino acid compositions: Evaluation score results of
“strength” of “aroma” (n = 3)

| | | | |
|---|---|---|---|
| Specimen | Tester | Total | Average |

| name | a | b | c | d | [points] | [points] |
|---|---|---|---|---|---|---|
| Con | — | 4 | 2 | 1 | 7 | 2.33 |
| L | — | 2 | 1 | 2 | 5 | 1.67 |
| LD | — | 1 | 4 | 4 | 9 | 3.00 |
| LIVD | — | 3 | 3 | 3 | 9 | 3.00 |

TABLE 8
Comparison of amino acid compositions: Evaluation
score results of “preferability”
of “aroma” (n = 4)

| | | | |
|---|---|---|---|
| Specimen | Tester | Total | Average |

| name | a | b | c | d | [points] | [points] |
|---|---|---|---|---|---|---|
| Con | 1 | 3 | 2 | 2 | 8 | 2.00 |
| L | 2 | 2 | 1 | 1 | 6 | 1.50 |
| LD | 3 | 1 | 4 | 3 | 11 | 2.75 |
| LIVD | 4 | 4 | 3 | 4 | 15 | 3.75 |

TABLE 9
Comparison of amino acid compositions: Evaluation
score results of “strength” of
“richness” (n = 4)

| | | | |
|---|---|---|---|
| Specimen | Tester | Total | Average |

| name | a | b | c | d | [points] | [points] |
|---|---|---|---|---|---|---|
| Con | 1 | 1 | 1 | 1 | 4 | 1.00 |
| L | 2 | 2 | 2 | 2 | 8 | 2.00 |
| LD | 4 | 3 | 4 | 4 | 15 | 3.75 |
| LIVD | 3 | 4 | 3 | 3 | 13 | 3.25 |

TABLE 10
Comparison of amino acid compositions: Evaluation
score results of “preferability”
of “richness” (n = 4)

| | | | |
|---|---|---|---|
| Specimen | Tester | Total | Average |

| name | a | b | c | d | [points] | [points] |
|---|---|---|---|---|---|---|
| Con | 1 | 3 | 2 | 2 | 8 | 2.00 |
| L | 2 | 2 | 1 | 1 | 6 | 1.50 |
| LD | 3 | 1 | 4 | 3 | 11 | 2.75 |
| LIVD | 4 | 4 | 3 | 4 | 15 | 3.75 |

TABLE 11
Comparison of amino acid compositions:
Evaluation score results of “strength”
of “flavor” (n = 4)

| | | | |
|---|---|---|---|
| Specimen | Tester | Total | Average |

| name | a | b | c | d | [points] | [points] |
|---|---|---|---|---|---|---|
| Con | 1 | 1 | 2 | 2 | 6 | 1.50 |
| L | 2 | 2 | 1 | 1 | 6 | 1.50 |
| LD | 4 | 3 | 4 | 4 | 15 | 3.75 |
| LIVD | 3 | 4 | 3 | 3 | 13 | 3.25 |

TABLE 12
Comparison of amino acid compositions: Evaluation
score results of “preferability”
of “flavor” (n = 4)

| | | | |
|---|---|---|---|
| Specimen | Tester | Total | Average |

| name | a | b | c | d | [points] | [points] |
|---|---|---|---|---|---|---|
| Con | 1 | 3 | 2 | 2 | 8 | 2.00 |
| L | 2 | 1 | 1 | 1 | 5 | 1.25 |
| LD | 4 | 2 | 4 | 3 | 13 | 3.25 |
| LIVD | 3 | 4 | 3 | 4 | 14 | 3.50 |

TABLE 13
Comparison of amino acid compositions: Evaluation score results
of “overall evaluation” (n = 4)

| | | | |
|---|---|---|---|
| Specimen | Tester | Total | Average |

| name | a | b | c | d | [points] | [points] |
|---|---|---|---|---|---|---|
| Con | 1 | 2 | 2 | 2 | 7 | 1.75 |
| L | 2 | 1 | 1 | 1 | 5 | 1.25 |
| LD | 3 | 3 | 4 | 3 | 13 | 3.25 |
| LIVD | 4 | 4 | 3 | 4 | 15 | 3.75 |

The amino acid compositions “L 500 mg”, “L 440 mg+D 60 mg”, and “L 280 mg+ I 80 mg+V 80 mg+D 60 mg” adjusted the “strength” and “preferability” of “bitterness”, “umami”, “aroma”, “richness”, and “flavor” of matcha in a matcha food or beverage. In particular, the “strength” of “richness” of matcha in a matcha food or beverage was enhanced by the amino acid composition “L 500 mg”, and was further enhanced by the amino acid compositions “L 280 mg+1 80 mg+V 80 mg+D 60 mg” and “L 440 mg+D 60 mg”.

### Example 2: Comparative Evaluation of Quantitative Ratio of BCAA (Leucine) and Aspartic Acid Salt and Additive Amount of Amino Acid Composition Added to Matcha Food or Beverage

This test was conducted in order to investigate the effect that an amino acid composition added to a matcha food or beverage has on the “bitterness”, “sweetness”, “richness”, “flavor”, and “aroma” of matcha in the matcha food or beverage by altering the quantitative ratio of BCAA (leucine) and an aspartic acid salt in the amino acid composition and the additive amount of the amino acid composition.

### <Ingredients>

Used ingredients and sources thereof were as follows.
Powdered matcha (Ito En, Ltd.)
Amino acid composition (L-leucine and sodium L-aspartate)

TABLE 14
Make-up of amino acid compositions 1, 2, and 3

| | Blending ratio in terms of parts by | | |
|---|---|---|---|
| | mass in each amino acid composition [%] | | |
| | Amino acid composition | | |
| Amino acid | Amino acid | Amino acid | Amino acid |
| components | composition 1 | composition 2 | composition 3 |
| L-Leucine | 88.0 | 76.0 | 64.0 |
| Sodium L-aspartate | 12.0 | 24.0 | 36.0 |
| Total | 100.0 | 100.0 | 100.0 |

### <Preparation Method of Test Specimens>

After adding 1 g of powdered matcha relative to 190 mL of water in a plastic bottle, a specific amount (65 mg, 130 mg, 195 mg, or 270 mg) of an amino acid composition 1, an amino acid composition 2, or an amino acid composition 3 was further added, a cap was attached to the bottle, and the bottle was shaken to cause complete dissolution and obtain a test specimen. A test specimen obtained by only adding powdered matcha without adding any of the amino acid compositions was taken to be a control.

### <Scored Evaluation>

Three testers a, b, and c who regularly consume matcha beverages tasted each of the types of test specimens that had been prepared and evaluated the “strength” and “preferability” for a total of five parameters (“bitterness”, “sweetness”, “richness”, “flavor”, and “aroma”) of matcha. In this evaluation, the “strength” was compared to the control and was given a 9-level scored evaluation in units of 0.5 in a range of 1 point to 5 points set as follows.
Extremely strong: 5 points
Strong: 4 points
Same level: 3 points
Weak: 2 points
Extremely weak: 1 point
   (For example, 4.5 points is a score expressing a “strength” that is midway between “extremely strong” and “strong”.)

Likewise, the “preferability” was compared to the control and was given a 9-level scored evaluation in units of 0.5 in a range of 1 point to 5 points set as follows.
Extremely preferable: 5 points
Preferable: 4 points
Same level: 3 points
Unpreferable: 2 points
Extremely unpreferable: 1 point
   (For example, 4.5 points is a score expressing a “preferability” that is midway between “extremely preferable” and “preferable”.)

### <Results>

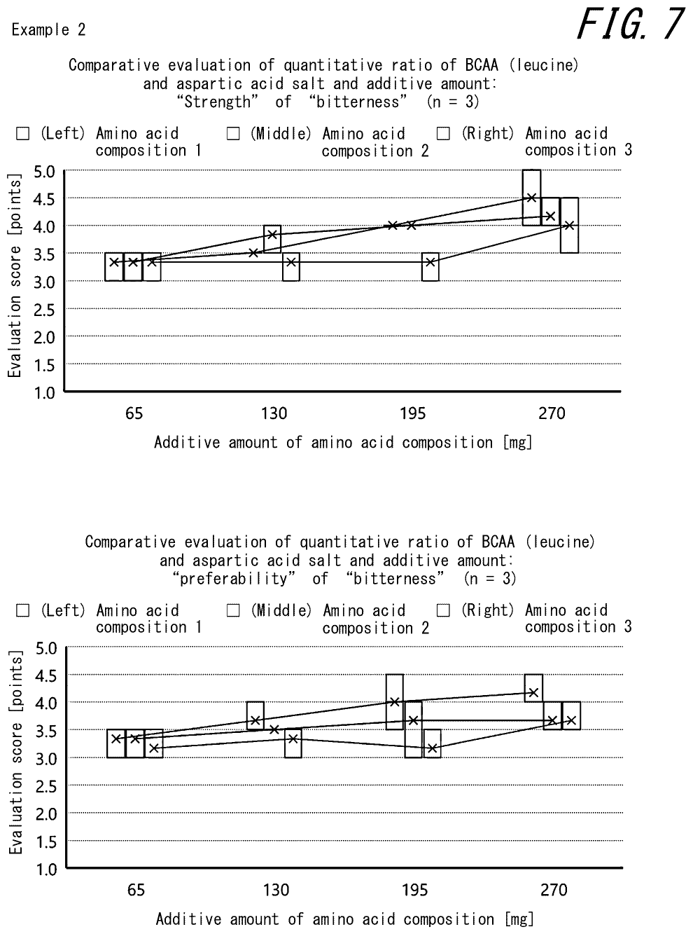

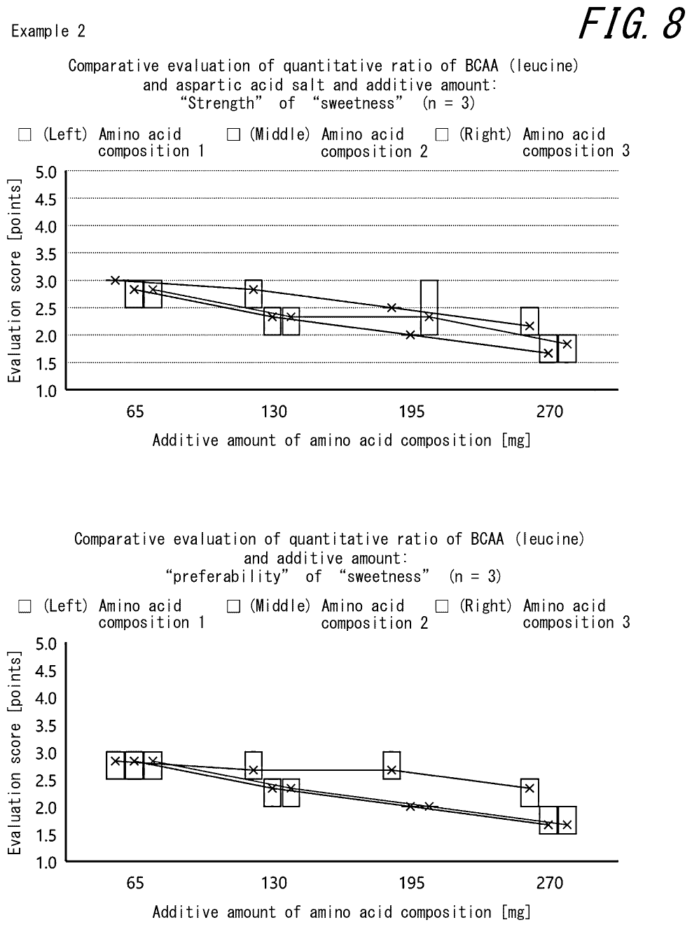

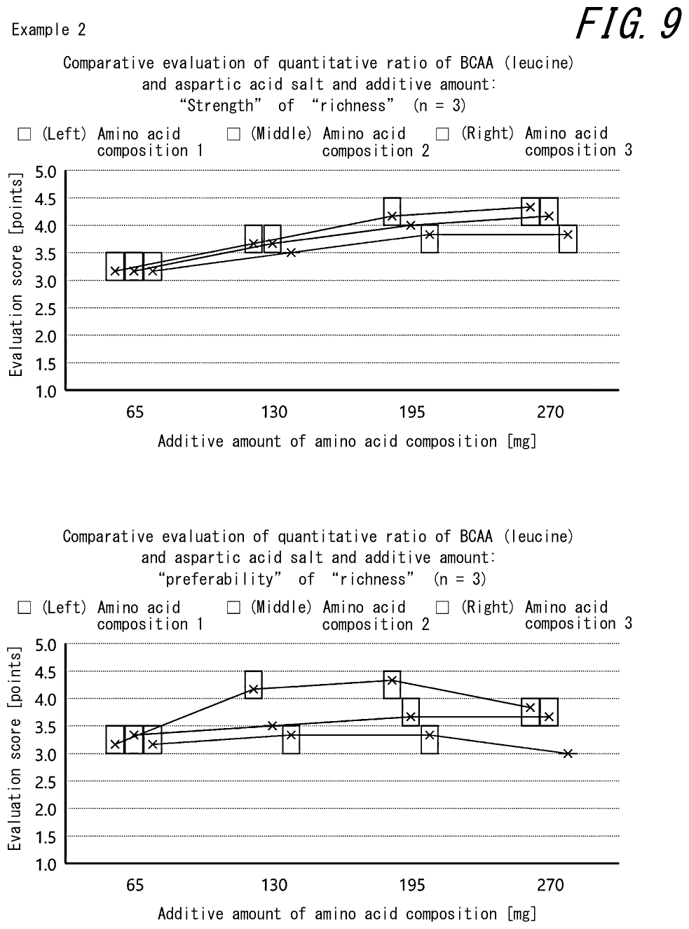

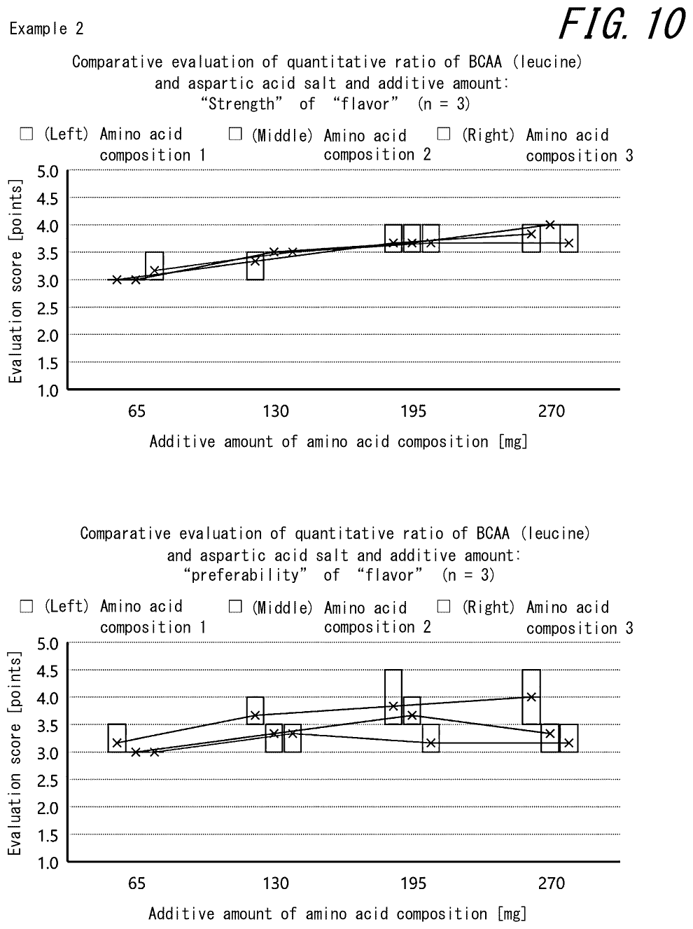

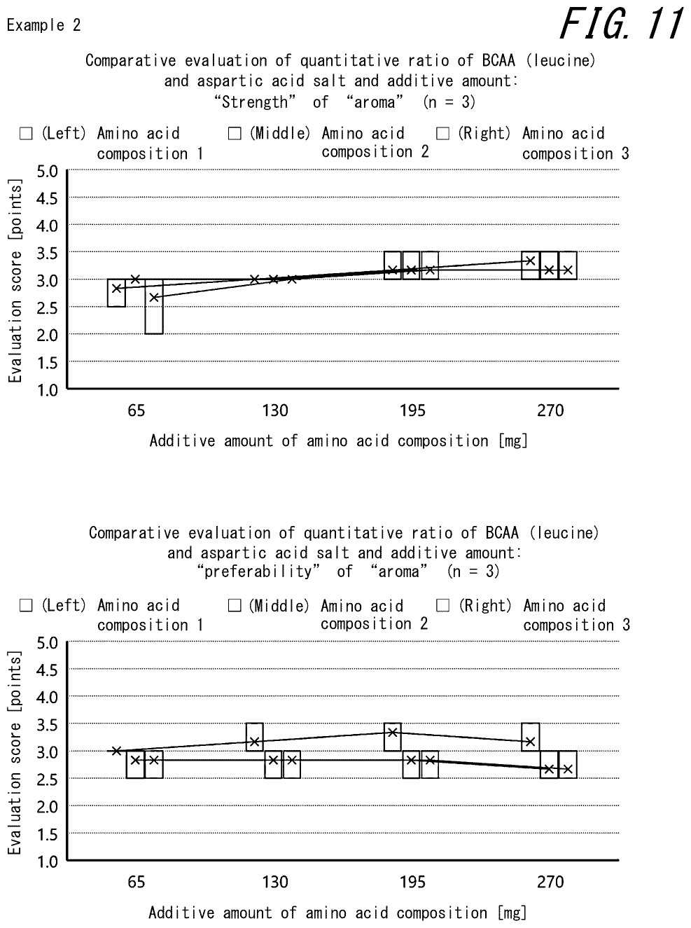

Evaluation score results and averages thereof in this example are presented in the following Tables 15 to 24 and in FIGS. 7 to 11.

TABLE 15
Comparative evaluation of quantitative ratio of BCAA (leucine) and aspartic acid
salt and additive amount: “strength” of “bitterness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3.5 | 3 | 3.5 | 3.33 | 3.5 | 3 | 3.5 | 3.33 | 3.5 | 3 | 3.5 | 3.33 |
| 130 | 3.5 | 3.5 | 3.5 | 3.50 | 4 | 4 | 3.5 | 3.83 | 3.5 | 3 | 3.5 | 3.33 |
| 195 | 4 | 4 | 4 | 4.00 | 4 | 4 | 4 | 4.00 | 3.5 | 3 | 3.5 | 3.33 |
| 270 | 4 | 4.5 | 5 | 4.50 | 4 | 4 | 4.5 | 4.17 | 3.5 | 4 | 4.5 | 4.00 |

TABLE 16
Comparative evaluation of quantitative ratio of BCAA (leucine) and aspartic
acid salt and additive amount: “preferability” of “bitterness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3.5 | 3.5 | 3.33 | 3 | 3.5 | 3.5 | 3.33 | 3 | 3 | 3.5 | 3.17 |
| 130 | 3.5 | 4 | 3.5 | 3.67 | 3.5 | 3.5 | 3.5 | 3.50 | 3.5 | 3 | 3.5 | 3.33 |
| 195 | 4 | 4.5 | 3.5 | 4.00 | 4 | 3 | 4 | 3.67 | 3 | 3 | 3.5 | 3.17 |
| 270 | 4 | 4 | 4.5 | 4.17 | 4 | 3.5 | 3.5 | 3.67 | 3.5 | 3.5 | 4 | 3.67 |

TABLE 17
Comparative evaluation of quantitative ratio of BCAA (leucine) and aspartic acid
salt and additive amount: “strength” of “sweetness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3 | 3 | 3.00 | 3 | 2.5 | 3 | 2.83 | 3 | 3 | 2.5 | 2.83 |
| 130 | 3 | 3 | 2.5 | 2.83 | 2.5 | 2 | 2.5 | 2.33 | 2.5 | 2 | 2.5 | 2.33 |
| 195 | 2.5 | 2.5 | 2.5 | 2.50 | 2 | 2 | 2 | 2.00 | 3 | 2 | 2 | 2.33 |
| 270 | 2 | 2 | 2.5 | 2.17 | 1.5 | 1.5 | 2 | 1.67 | 2 | 1.5 | 2 | 1.83 |

TABLE 18
Comparative evaluation of quantitative ratio of BCAA (leucine) and aspartic
acid salt and additive amount: “preferability” of “sweetness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3 | 2.5 | 2.83 | 3 | 2.5 | 3 | 2.83 | 3 | 2.5 | 3 | 2.83 |
| 130 | 2.5 | 2.5 | 3 | 2.67 | 2.5 | 2 | 2.5 | 2.33 | 2.5 | 2 | 2.5 | 2.33 |
| 195 | 2.5 | 3 | 2.5 | 2.67 | 2 | 2 | 2 | 2.00 | 2 | 2 | 2 | 2.00 |
| 270 | 2.5 | 2 | 2.5 | 2.33 | 1.5 | 1.5 | 2 | 1.67 | 1.5 | 1.5 | 2 | 1.67 |

TABLE 19
Comparative evaluation of quantitative ratio of BCAA (leucine) and aspartic acid
salt and additive amount: “strength” of “richness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3.5 | 3 | 3 | 3.17 | 3.5 | 3 | 3 | 3.17 | 3.5 | 3 | 3 | 3.17 |
| 130 | 4 | 3.5 | 3.5 | 3.67 | 4 | 3.5 | 3.5 | 3.67 | 3.5 | 3.5 | 3.5 | 3.50 |
| 195 | 4 | 4 | 4.5 | 4.17 | 4 | 4 | 4 | 4.00 | 3.5 | 4 | 4 | 3.83 |
| 270 | 4.5 | 4 | 4.5 | 4.33 | 4.5 | 4 | 4 | 4.17 | 3.5 | 4 | 4 | 3.83 |

TABLE 20
Comparative evaluation of quantitative ratio of BCAA (leucine) and aspartic
acid salt and additive amount: “preferability” of “richness”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3.5 | 3 | 3.17 | 3.5 | 3.5 | 3 | 3.33 | 3.5 | 3 | 3 | 3.17 |
| 130 | 4.5 | 4 | 4 | 4.17 | 3.5 | 3.5 | 3.5 | 3.50 | 3.5 | 3 | 3.5 | 3.33 |
| 195 | 4.5 | 4 | 4.5 | 4.33 | 3.5 | 3.5 | 4 | 3.67 | 3.5 | 3.5 | 3 | 3.33 |
| 270 | 4 | 3.5 | 4 | 3.83 | 4 | 3.5 | 3.5 | 3.67 | 3 | 3 | 3 | 3.00 |

TABLE 21
Comparative evaluation of quantitative ratio of BCAA (leucine) and aspartic acid
salt and additive amount: “strength” of “flavor”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3 | 3 | 3.00 | 3 | 3 | 3 | 3.00 | 3.5 | 3 | 3 | 3.17 |
| 130 | 3.5 | 3 | 3.5 | 3.33 | 3.5 | 3.5 | 3.5 | 3.50 | 3.5 | 3.5 | 3.5 | 3.50 |
| 195 | 4 | 3.5 | 3.5 | 3.67 | 4 | 3.5 | 3.5 | 3.67 | 4 | 3.5 | 3.5 | 3.67 |
| 270 | 4 | 3.5 | 4 | 3.83 | 4 | 4 | 4 | 4.00 | 3.5 | 4 | 3.5 | 3.67 |

TABLE 22
Comparative evaluation of quantitative ratio of BCAA (leucine) and aspartic acid
salt and additive amount: “preferability” of “flavor”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3.5 | 3 | 3.17 | 3 | 3 | 3 | 3.00 | 3 | 3 | 3 | 3.00 |
| 130 | 4 | 3.5 | 3.5 | 3.67 | 3.5 | 3 | 3.5 | 3.33 | 3.5 | 3 | 3.5 | 3.33 |
| 195 | 4.5 | 3.5 | 3.5 | 3.83 | 4 | 3.5 | 3.5 | 3.67 | 3.5 | 3 | 3 | 3.17 |
| 270 | 4.5 | 3.5 | 4 | 4.00 | 3.5 | 3 | 3.5 | 3.33 | 3.5 | 3 | 3 | 3.17 |

TABLE 23
Comparative evaluation of quantitative ratio of BCAA (leucine) and aspartic
acid salt and additive amount: “strength” of “aroma”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 2.5 | 3 | 2.83 | 3 | 3 | 3 | 3.00 | 3 | 3 | 2 | 2.67 |
| 130 | 3 | 3 | 3 | 3.00 | 3 | 3 | 3 | 3.00 | 3 | 3 | 3 | 3.00 |
| 195 | 3 | 3 | 3.5 | 3.17 | 3 | 3 | 3.5 | 3.17 | 3 | 3 | 3.5 | 3.17 |
| 270 | 3.5 | 3 | 3.5 | 3.33 | 3.5 | 3 | 3 | 3.17 | 3.5 | 3 | 3 | 3.17 |

TABLE 24
Comparative evaluation of quantitative ratio of BCAA (leucine) and aspartic acid
salt and additive amount: “preferability” of “aroma”

| Additive amount of | Name of amino acid composition | | | | | | | | | | | |
|---|---|---|---|---|---|---|---|---|---|---|---|---|
| amino acid composition | Amino acid composition 1 | | | | Amino acid composition 2 | | | | Amino acid composition 3 | | | |
| relative to 1,000 mg of | Tester | | | | Tester | | | | Tester | | | |
| powdered matcha [mg] | a | b | c | Average | a | b | c | Average | a | b | c | Average |
| 65 | 3 | 3 | 3 | 3.00 | 3 | 3 | 2.5 | 2.83 | 3 | 3 | 2.5 | 2.83 |
| 130 | 3.5 | 3 | 3 | 3.17 | 3 | 3 | 2.5 | 2.83 | 3 | 3 | 2.5 | 2.83 |
| 195 | 3 | 3.5 | 3.5 | 3.33 | 3 | 2.5 | 3 | 2.83 | 3 | 2.5 | 3 | 2.83 |
| 270 | 3 | 3 | 3.5 | 3.17 | 3 | 2.5 | 2.5 | 2.67 | 3 | 2.5 | 2.5 | 2.67 |

The amino acid compositions 1, 2, and 3 each adjusted the “strength” and “preferability” of “bitterness”, “sweetness”, “richness”, “flavor”, and “aroma” of matcha in a matcha food or beverage in a manner that was dependent on the additive amount thereof. In particular, the “strength” of “richness” and “flavor” tended to increase as the additive amount increased from 65 mg to 130 mg to 195 mg to 270 mg for each of the amino acid compositions 1, 2, and 3. The enhancement effect on “richness” was strongest with the amino acid composition 1, followed by the amino acid composition 2 and the amino acid composition 3 in this order. Moreover, overall inclusive of “preferability”, the amino acid composition 1 was the best, followed by the amino acid composition 2 and the amino acid composition 3 in this order (amino acid composition 1>amino acid composition 2>amino acid composition 3).

### Example 3: Evaluation of Change Over Time of “Strength” of “Bitterness”, “Sweetness”, “Richness”, “Flavor”, and “Aroma” of Matcha in Matcha Food or Beverage and Prevention of Deterioration Over Time by Amino Acid Composition

The change over time of the “strength” of “bitterness”, “sweetness”, “richness”, “flavor”, and “aroma” of matcha in a matcha food or beverage and an effect of preventing deterioration over time by an amino acid composition were evaluated.

### <Ingredients>

Used ingredients and sources thereof were as follows.
Powdered matcha (Ito En, Ltd.)
Amino acid composition (56 parts by mass of L-leucine, 16 parts by mass of L-isoleucine, 16 parts by mass of L-valine, and 12 parts by mass of sodium L-aspartate)

### <Preparation Method of Test Specimens>

After adding 1 g of powdered matcha relative to 190 ml of water in a plastic bottle, an amino acid composition was not added (specimen A(−)0) or 300 mg of the amino acid composition was further added (specimen A(+)0), a cap was attached to the bottle, and the bottle was shaken to cause complete dissolution and obtain a test specimen. The time at which the specimen A(−)0 was prepared was taken to be 0 minutes, and test specimens to which an amino acid composition was not added were prepared in the same manner as controls at 45 minutes and 90 minutes after that time (respectively specimen A(−)45 and specimen A(−)90). Moreover, the time at which the specimen A(+)0 was prepared was taken to be 0 minutes, and test specimens to which 300 mg of the amino acid composition was added were prepared in the same manner as controls at 45 minutes and 90 minutes after that time (respectively specimen A(+)45 and specimen A(+)90).

### <Scored Evaluation>

Three testers a, b, and c who regularly consume matcha beverages tasted each of the types of test specimens that had been prepared and evaluated the “strength” for a total of five parameters (“bitterness”, “sweetness”, “richness”, “flavor”, and “aroma”) of matcha. In this evaluation, a comparison was made to the control for each time (45 minutes and 90 minutes after preparation of specimen A(−)0 or 45 minutes and 90 minutes after preparation of specimen A(+)0), and a 9-level scored evaluation in units of 0.5 in a range of 1 point to 5 points set as follows was made.
Extremely strong: 5 points
Strong: 4 points
Same level: 3 points
Weak: 2 points
Extremely weak: 1 point
   (For example, 4.5 points is a score expressing a “strength” that is midway between “extremely strong” and “strong”.)

Note that at a time of 0 minutes, the specimen A(−)0 and the specimen A(+)0 also serve as controls for themselves, and thus the scored evaluation result was automatically taken to be 3 points. The evaluation schedule of the specimen A(−)0, the specimen A(−)45, and the specimen A(−)90 is also presented below in Table 25, and the evaluation schedule of the specimen A(+)0, the specimen A(+)45, and the specimen A(+)90 is also presented below in Table 26.

TABLE 25
Evaluation schedule of specimen A(−)0, specimen A(−)45, and specimen A(−)90

| Evaluation | Test specimen name | | |
|---|---|---|---|
| time | Specimen A(−)0 | Specimen A(−)45 | Specimen A(−)90 |
| 0 min | Preparation | — | — |
| 45 min | Comparative evaluation | Preparation | — |
| | of specimen A(−)0 and | Comparative evaluation | |
| | specimen A(−)45 | of specimen A(−)0 and | |
| | | specimen A(−)45 | |
| 90 min | Comparative evaluation | — | Preparation |
| | of specimen A(−)0 and | | Comparative evaluation |
| | specimen A(−)90 | | of specimen A(−)0 and |
| | | | specimen A(−)90 |

TABLE 26
Evaluation schedule of specimen A(+)0, specimen A(+)45, and specimen A(+)90
Test specimen name

| Evaluation | Test specimen name | | |
|---|---|---|---|
| time | Specimen A(+)0 | Specimen A(+)45 | Specimen A(+)90 |
| 0 min | Preparation | — | — |
| 45 min | Comparative evaluation | Preparation | — |
| | of specimen A(+)0 and | Comparative evaluation | |
| | specimen A(+)45 | of specimen A(+)0 and | |
| | | specimen A(+)45 | |
| 90 min | Comparative evaluation | — | Preparation |
| | of specimen A(+)0 and | | Comparative evaluation |
| | specimen A(+)90 | | of specimen A(+)0 and |
| | | | specimen A(+)90 |

### <Results>

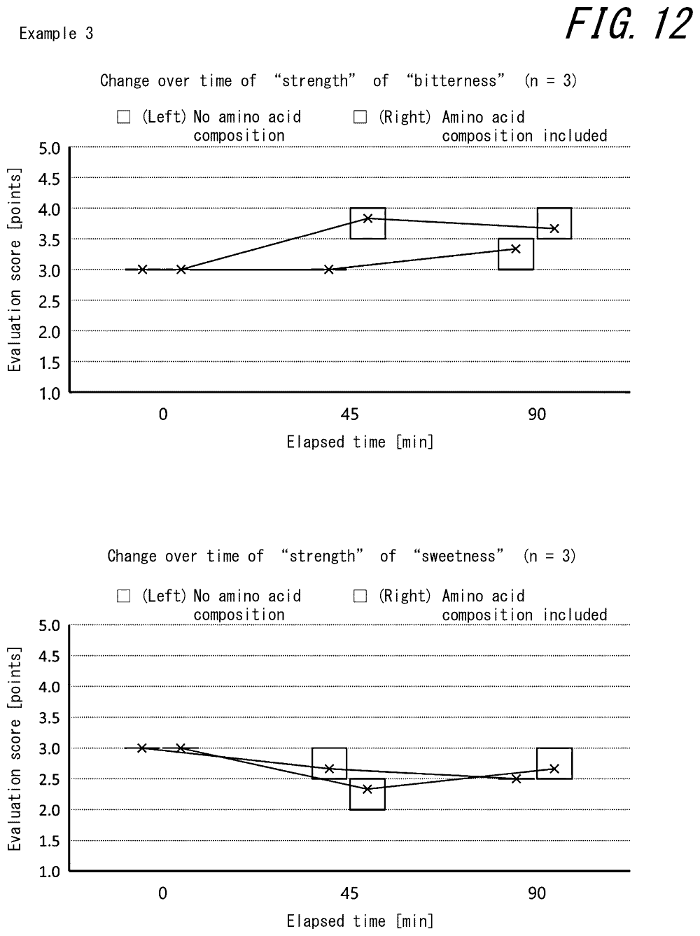

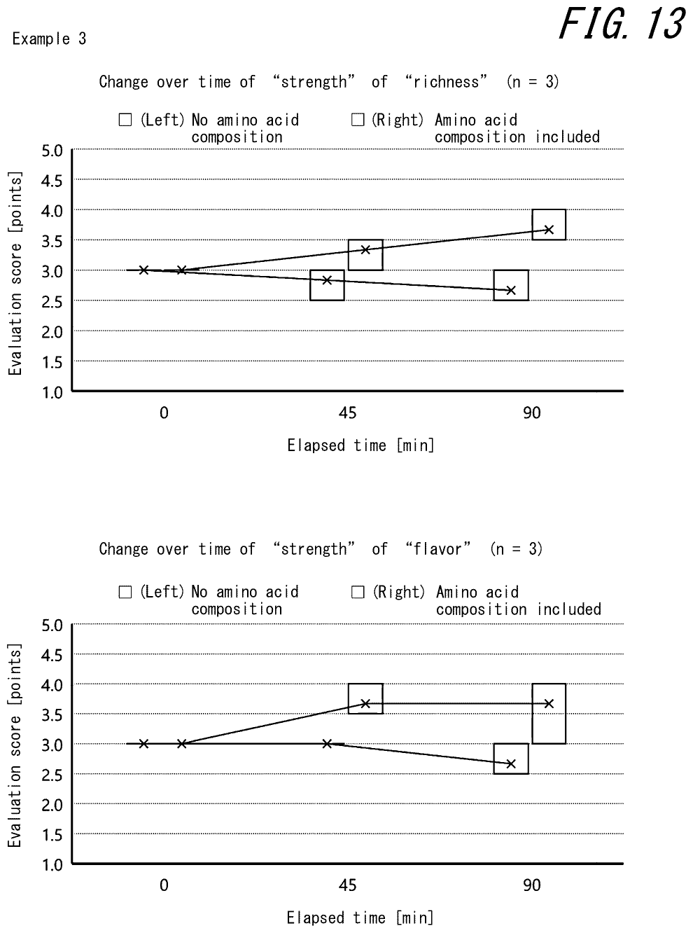

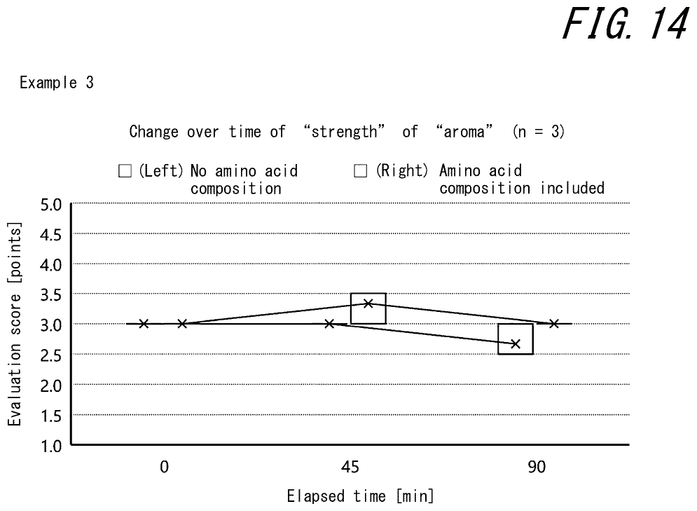

Evaluation score results and averages thereof in this example are presented in the following Tables 27 to 30 and in FIGS. 12 to 14.

TABLE 27
Comparative evaluation results of specimen A(−)0
and specimen A(−)45 at 45 minutes

| 45 min | | Tester | | | |
|---|---|---|---|---|---|
| Specimen A(−)0 vs. Specimen A(−)45 | | a | b | c | Average |
| Parameter | Bitterness | 3 | 3 | 3 | 3.0 |
| | Sweetness | 3 | 2.5 | 2.5 | 2.7 |
| | Richness | 3 | 2.5 | 3 | 2.8 |
| | Flavor | 3 | 3 | 3 | 3.0 |
| | Aroma | 3 | 3 | 3 | 3.0 |

TABLE 28
Comparative evaluation results of specimen A(−)0
and specimen A(−)90 at 90 minutes

| 90 min | | Tester | | | |
|---|---|---|---|---|---|
| Specimen A(−)0 vs. Specimen A(−)90 | | a | b | c | Average |
| Parameter | Bitterness | 3.5 | 3.5 | 3 | 3.3 |
| | Sweetness | 2.5 | 2.5 | 2.5 | 2.5 |
| | Richness | 2.5 | 2.5 | 3 | 2.7 |
| | Flavor | 3 | 2.5 | 2.5 | 2.7 |
| | Aroma | 3 | 2.5 | 2.5 | 2.7 |

TABLE 29
Comparative evaluation results of specimen A(+)0
and specimen A(+)45 at 45 minutes

| 45 min | | Tester | | | |
|---|---|---|---|---|---|
| Specimen A(+)0 vs. Specimen A(+)45 | | a | b | c | Average |
| Parameter | Bitterness | 4 | 3.5 | 4 | 3.8 |
| | Sweetness | 2.5 | 2.5 | 2 | 2.3 |
| | Richness | 3.5 | 3.5 | 3 | 3.3 |
| | Flavor | 3.5 | 4 | 3.5 | 3.7 |
| | Aroma | 3 | 3.5 | 3.5 | 3.3 |

TABLE 30
Comparative evaluation results of specimen A(+)0
and specimen A(+)90 at 90 minutes

| 90 min | | Tester | | | |
|---|---|---|---|---|---|
| Specimen A(+)0 vs. Specimen A(+)90 | | a | b | c | Average |
| Parameter | Bitterness | 3.5 | 3.5 | 4 | 3.7 |
| | Sweetness | 2.5 | 2.5 | 3 | 2.7 |
| | Richness | 3.5 | 4 | 3.5 | 3.7 |
| | Flavor | 3 | 4 | 4 | 3.7 |
| | Aroma | 3 | 3 | 3 | 3.0 |

Upon comparative evaluation of the specimen A(−)0, the specimen A(−)45, and the specimen A(−)90, it was demonstrated that in the case of a specimen to which an amino acid composition is not added, the “strength” of “richness” and “flavor” of matcha deteriorates as time elapses from post-preparation to 45 minutes later and then 90 minutes later. On the other hand, upon comparative evaluation of the specimen A(+)0, the specimen A(+)45, and the specimen A(+)90, it was demonstrated that in the case of a specimen to which the amino acid composition is added, deterioration of the “strength” of “richness” and “flavor” of matcha is suppressed even as times elapses from post-preparation to 45 minutes later and then 90 minutes later.

### Example 4: Change Over Time of Relative “Strength” of “Bitterness”, “Sweetness”, “Richness”, “Flavor”, and “Aroma” of Matcha in Matcha Food or Beverage for Specimen in which Amino Acid Composition was Added as Compared to Specimen in which Amino Acid Composition was not Added

The change over time of relative “strength” of “bitterness”, “sweetness”, “richness”, “flavor”, and “aroma” of matcha in a matcha food or beverage for a specimen in which an amino acid composition was added as compared to a specimen in which an amino acid composition was not added was evaluated.

### <Ingredients>

Used ingredients and sources thereof were as follows.
Powdered matcha (Ito En, Ltd.)
Amino acid composition (56 parts by mass of L-leucine, 16 parts by mass of L-isoleucine, 16 parts by mass of L-valine, and 12 parts by mass of sodium L-aspartate)

### <Preparation Method of Test Specimens>

After adding 1 g of powdered matcha relative to 190 mL of water in a plastic bottle, 300 mg of the amino acid composition was further added, a cap was attached to the bottle, and the bottle was shaken to cause complete dissolution and obtain a test specimen (specimen A). A test specimen obtained by only adding powdered matcha without adding an amino acid composition was taken to be a control (specimen C).

### <Scored Evaluation>

Three testers a, b, and c who regularly consume matcha beverages tasted each of the types of test specimens that had been prepared and evaluated the “strength” for a total of five parameters (“bitterness”, “sweetness”, “richness”, “flavor”, and “aroma”) of matcha. In this evaluation, the “strength” was compared to the control and was given a 9-level scored evaluation in units of 0.5 in a range of 1 point to 5 points set as follows.
Extremely strong: 5 points
Strong: 4 points
Same level: 3 points
Weak: 2 points
Extremely weak: 1 point
   (For example, 4.5 points is a score expressing a “strength” that is midway between “extremely strong” and “strong”.)

In addition, in order to observe the change over time of the “strength” of each of the parameters after preparation, the time at which the specimen C and the specimen A were prepared was taken to be 0 minutes, and the above-described evaluations were performed at three times: 0 minutes, 45 minutes after preparation, and 90 minutes after preparation.

TABLE 31
Evaluation schedule

Test specimen name

| | | |
|---|---|---|
| Evaluation time | Specimen C | Specimen A |

| | |
|---|---|
| 0 min | Comparative evaluation |
| After 45 min | Comparative evaluation |
| After 90 min | Comparative evaluation |

### <Results>

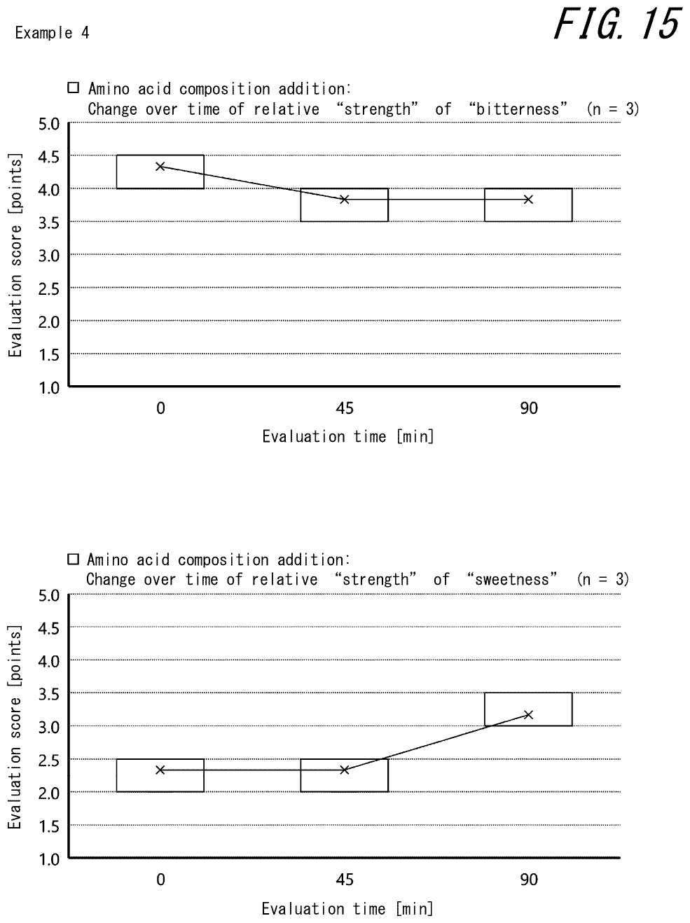

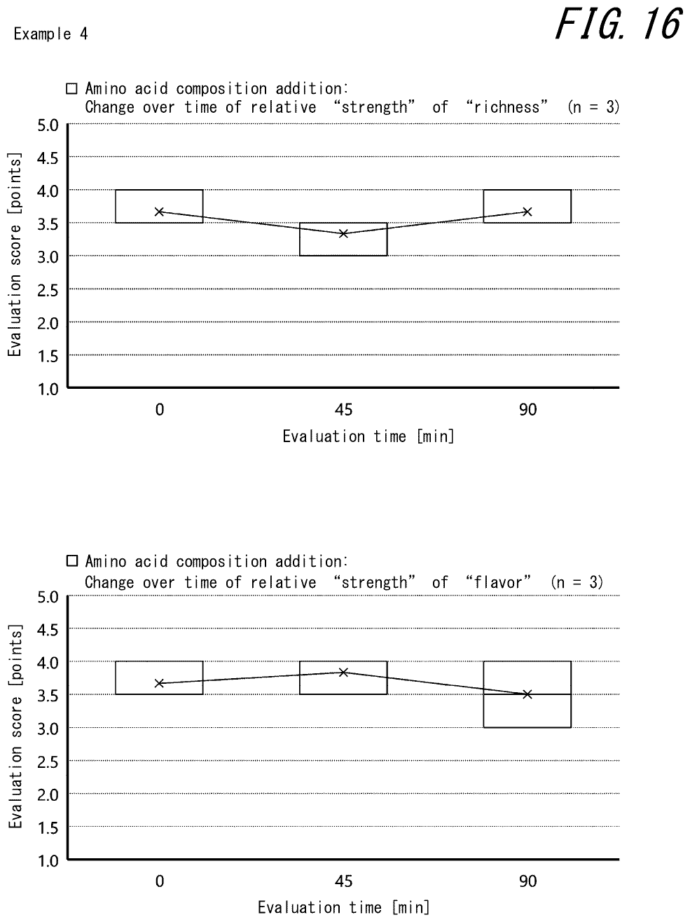

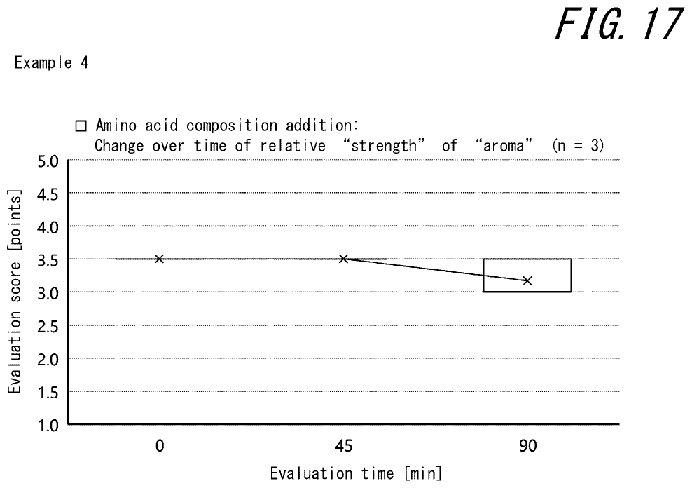

Evaluation score results and averages thereof in this example are presented in the following Tables 32 to 34 and in FIGS. 15 to 17.

TABLE 32
Scored evaluation results at time of preparation
(0 min) of specimen C and specimen A

| | Tester | | | |
|---|---|---|---|---|
| 0 min | a | b | c | Average |

| | | | | | |
|---|---|---|---|---|---|
| Parameter | Bitterness | 4 | 4.5 | 4.5 | 4.3 |
| | Sweetness | 2 | 2.5 | 2.5 | 2.3 |
| | Richness | 3.5 | 3.5 | 4 | 3.7 |
| | Flavor | 3.5 | 3.5 | 4 | 3.7 |
| | Aroma | 3.5 | 3.5 | 3.5 | 3.5 |

TABLE 33
Scored evaluation results at 45 minutes after
preparation of specimen C and specimen A

| | Tester | | | |
|---|---|---|---|---|
| After 45 min | a | b | c | Average |

| | | | | | |
|---|---|---|---|---|---|
| Parameter | Bitterness | 3.5 | 4 | 4 | 3.8 |
| | Sweetness | 2 | 2.5 | 2.5 | 2.3 |
| | Richness | 3.5 | 3.5 | 3 | 3.3 |
| | Flavor | 4 | 3.5 | 4 | 3.8 |
| | Aroma | 3.5 | 3.5 | 3.5 | 3.5 |

TABLE 34
Scored evaluation results at 90 minutes after
preparation of specimen C and specimen A

| | Tester | | | |
|---|---|---|---|---|
| After 90 min | a | b | c | Average |

| | | | | | |
|---|---|---|---|---|---|
| Parameter | Bitterness | 3.5 | 4 | 4 | 3.8 |
| | Sweetness | 3.5 | 3 | 3 | 3.2 |
| | Richness | 3.5 | 3.5 | 4 | 3.7 |
| | Flavor | 3 | 3.5 | 4 | 3.5 |
| | Aroma | 3 | 3.5 | 3 | 3.2 |

### Example 5: Investigation of Additive Amount of Amino Acid Composition in Matcha Beverage

Matcha beverages (sweetener-free matcha beverages) were prepared with various amounts of an amino acid composition added thereto. The “strength” and “preferability” of “bitterness”, “aroma”, “richness”, “umami”, and “flavor” of matcha in these matcha beverages were evaluated.

### <Ingredients>

Used ingredients and sources thereof were as follows.
Powdered matcha: Powdered Tencha produced in Toyota (Yamauchi Yoshimasa) (Hekien Yamauchi Junpei Shoten)
Water: Okudaisen Mineral Water (Suntory Holdings Limited)
Amino acid composition (L-valine, L-leucine, L-isoleucine, and sodium L-aspartate with make-up shown below in Table 35)

TABLE 35
Make-up of amino acid composition

| | | Blending ratio |
|---|---|---|
| Amino acid components | Parts by mass | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. A specific amount (0.1 g mass, 0.2 g mass, 0.3 g mass, 0.4 g mass, or 0.5 g mass) of the amino acid composition was added into a tea bowl, 80° C. hot water was poured into the tea bowl, and a tea whisk was used to cause dissolution until the amino acid composition was completely dissolved.
2. 1.5 g of powdered matcha was added to 1, was left to blend well therewith, and was subsequently stirred for 1 minute using a tea whisk.
3. After stirring, an outward spiral was drawn in the mixture, and the mixture was transferred to a vessel.

TABLE 36
Contents of amino acid composition and powdered
matcha in matcha beverage specimens

| | Amino acid | Powdered | Matcha beverage |
|---|---|---|---|
| Matcha beverage | composition | matcha | (final volume) |
| specimen name | [g mass] | [g mass] | [mL] |
| Control | 0 | 1.5 | 81.5 |
| Sample 1 | 0.1 | 1.5 | 81.5 |
| Sample 2 | 0.2 | 1.5 | 81.5 |
| Sample 3 | 0.3 | 1.5 | 81.5 |
| Sample 4 | 0.4 | 1.5 | 81.5 |
| Sample 5 | 0.5 | 1.5 | 81.5 |

### <Test Method>

Six types of matcha beverage specimens that had been prepared, inclusive of a control, were each poured into a paper cup, and these matcha beverage specimens were randomly assigned the letters A to F as specimen names in order that the testers would not know the additive amount of the amino acid composition in each thereof. The testers tasted each of these matcha beverage specimens and gave a scored evaluation for a total of five parameters (“bitterness”, “aroma”, “richness”, “umami”, and “flavor”) of matcha in the matcha beverage from viewpoints of “strength” and “preferability” thereof, and also from a viewpoint of “overall evaluation” taking into account texture, appearance, and so forth in addition to taste.

### <Scored Evaluation>

The “strength” of “bitterness”, “aroma”, “richness”, umami”, and “flavor” was given a 5-level scored evaluation of 1 point, 2 points, 3 points, 4 points, or 5 points, where a larger score represents an evaluation of greater “strength”. Averages were calculated from the evaluation scores of testers a, b, and c, and these averages were compared.

The “preferability” of “bitterness”, “aroma”, “richness”, umami”, and “flavor” was given a 5-level scored evaluation of 1 point, 2 points, 3 points, 4 points, or 5 points, where a larger score represents an evaluation of better “preferability”. Averages were calculated from the evaluation scores of testers a, b, and c, and these averages were compared.

With regards to “overall evaluation” taking into account texture, appearance, and so forth in addition to taste, the six types of matcha beverage specimens, inclusive of the control, were ranked in order from 1^{st} to 6th for overall “preferability”, and then the specimen ranked most preferable (1^{st}) was allotted 5 points, the specimen ranked 2^{nd} most preferable was allotted 4 points, 5 the specimen ranked 3^{rd} most preferable was allotted 3 points, the specimen ranked 4^{th} most preferable was allotted 2 points, the specimen ranked 5^{th} most preferable was allotted 1 point, and the specimen ranked 6th most preferable was allotted 0 points. Averages were calculated from the evaluation scores of testers a, b, and c, and these averages were compared.

### <Results>

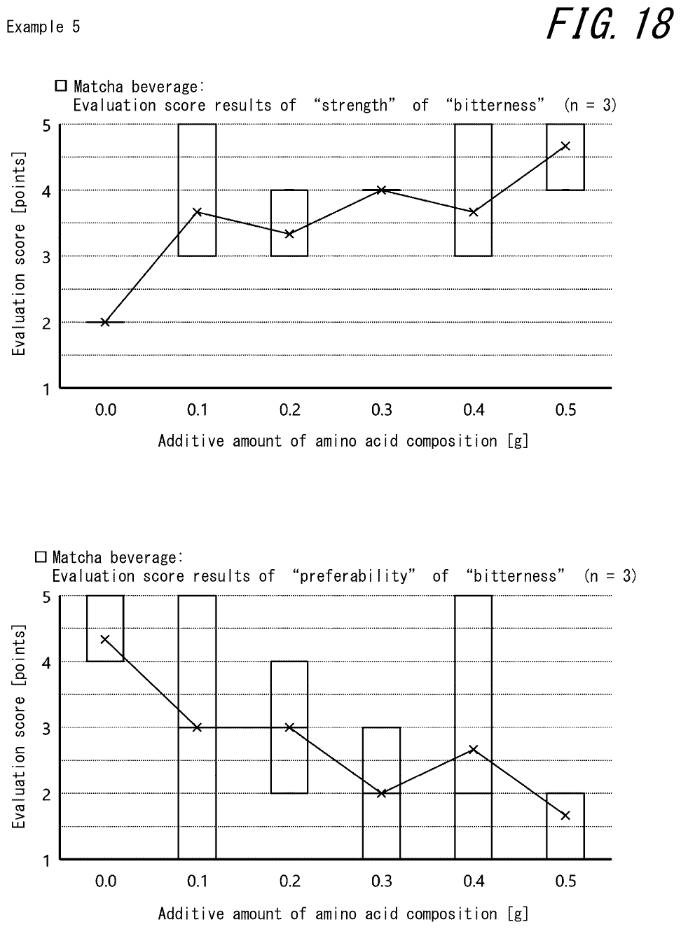

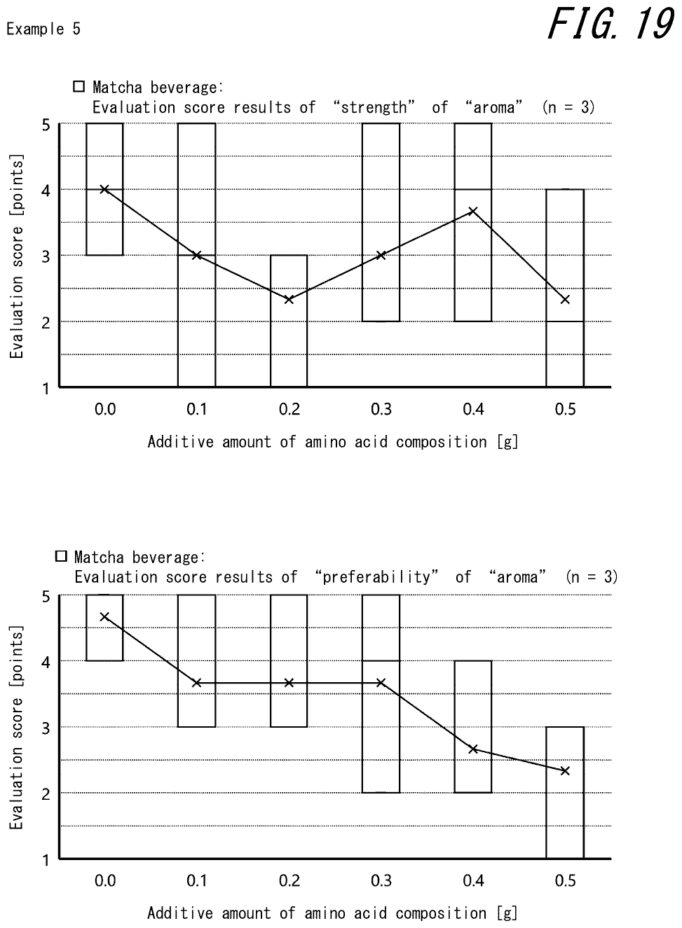

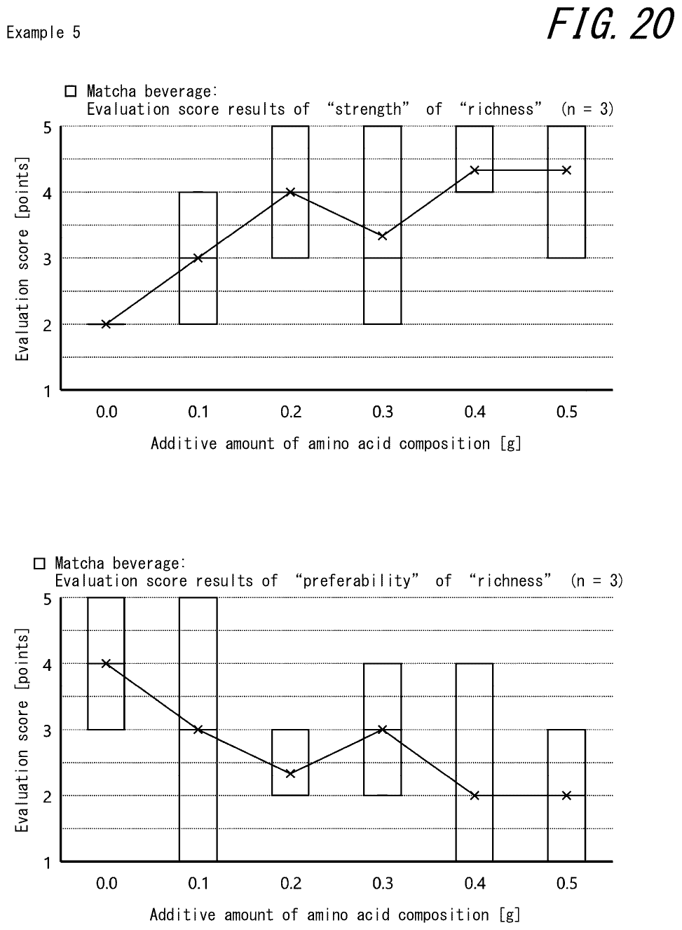

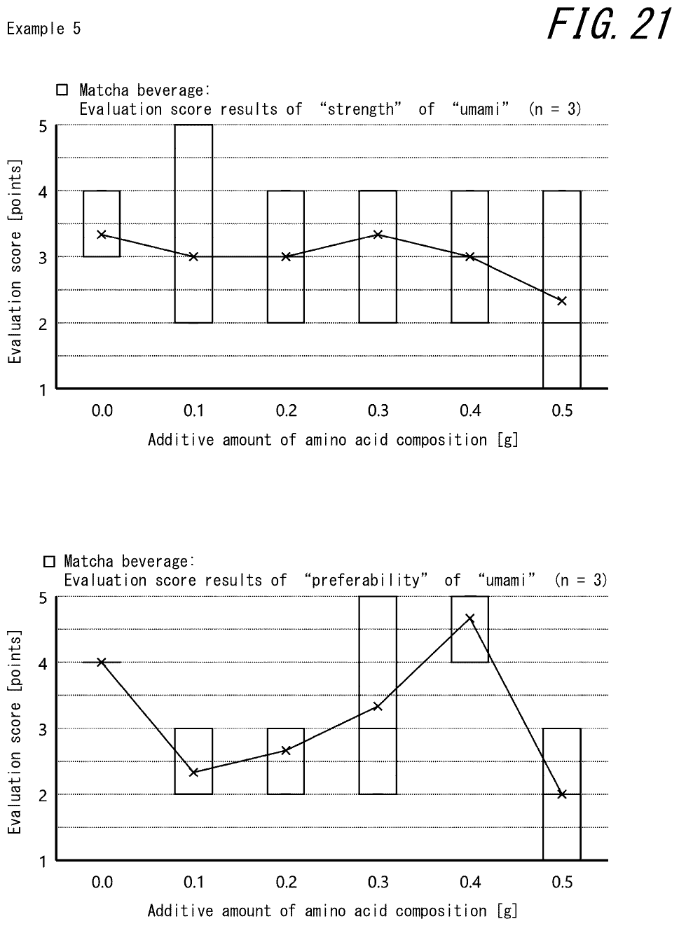

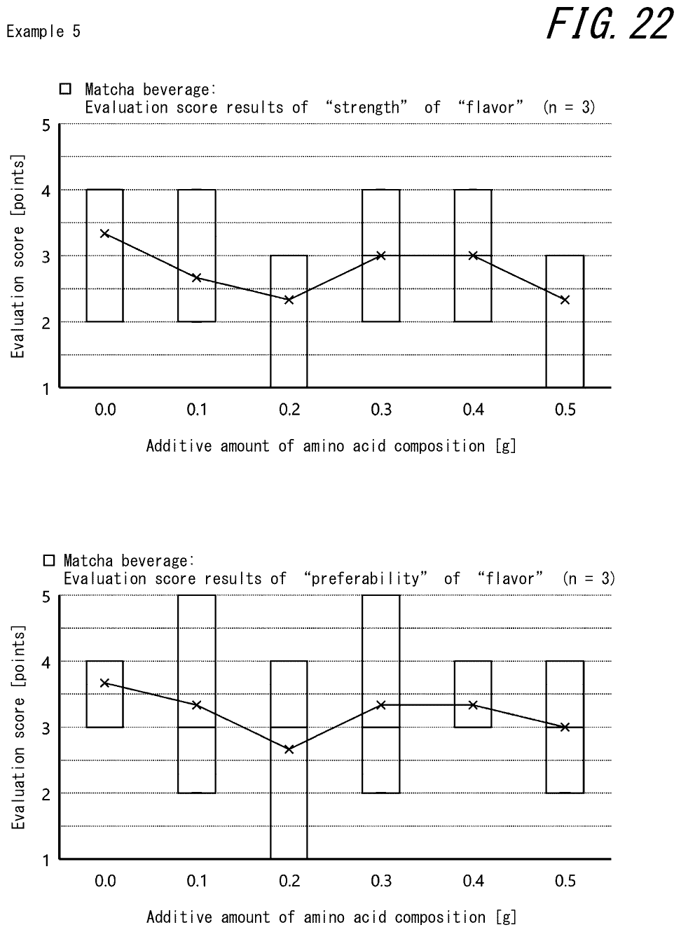

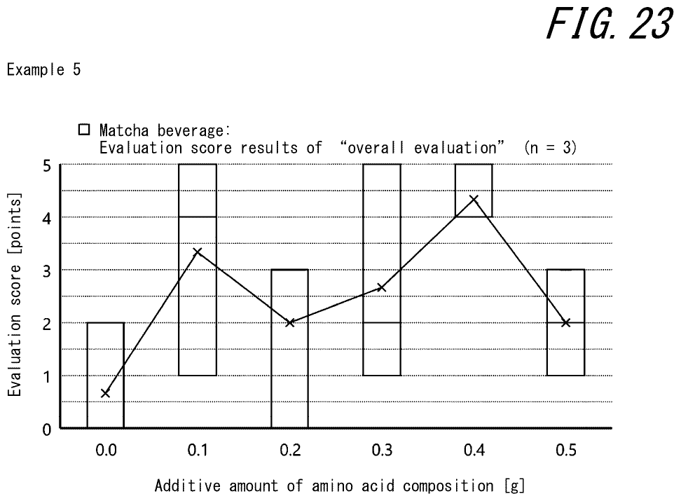

Evaluation score results and averages thereof in this example are presented in the following Tables 37 to 47 and in FIGS. 18 to 23.

TABLE 37
Matcha beverage: Evaluation score results of “strength”
of “bitterness” (n = 3)

| Additive amount of amino | Tester | | | Total | Average |
|---|---|---|---|---|---|
| acid composition [g] | a | b | c | [points] | [points] |
| 0 | 2 | 2 | 2 | 6 | 2.00 |
| 0.1 | 3 | 3 | 5 | 11 | 3.67 |
| 0.2 | 3 | 4 | 3 | 10 | 3.33 |
| 0.3 | 4 | 4 | 4 | 12 | 4.00 |
| 0.4 | 5 | 3 | 3 | 11 | 3.67 |
| 0.5 | 4 | 5 | 5 | 14 | 4.67 |

TABLE 38
Matcha beverage: Evaluation score results of “preferability”
of “bitterness” (n = 3)

| Additive amount of amino | Tester | | | Total | Average |
|---|---|---|---|---|---|
| acid composition [g] | a | b | c | [points] | [points] |
| 0 | 4 | 4 | 5 | 13 | 4.33 |
| 0.1 | 3 | 5 | 1 | 9 | 3.00 |
| 0.2 | 2 | 3 | 4 | 9 | 3.00 |
| 0.3 | 1 | 3 | 2 | 6 | 2.00 |
| 0.4 | 1 | 5 | 2 | 8 | 2.67 |
| 0.5 | 2 | 2 | 1 | 5 | 1.67 |

TABLE 39
Matcha beverage: Evaluation score results of “strength”
of “aroma” (n = 3)

| Additive amount of amino | Tester | | | Total | Average |
|---|---|---|---|---|---|
| acid composition [g] | a | b | c | [points] | [points] |
| 0 | 5 | 4 | 3 | 12 | 4.00 |
| 0.1 | 3 | 5 | 1 | 9 | 3.00 |
| 0.2 | 1 | 3 | 3 | 7 | 2.33 |
| 0.3 | 5 | 2 | 2 | 9 | 3.00 |
| 0.4 | 4 | 2 | 5 | 11 | 3.67 |
| 0.5 | 2 | 1 | 4 | 7 | 2.33 |

TABLE 40
Matcha beverage: Evaluation score results of “preferability”
of “aroma” (n = 3)

| Additive amount of amino | Tester | | | Total | Average |
|---|---|---|---|---|---|
| acid composition [g] | a | b | c | [points] | [points] |
| 0 | 5 | 4 | 5 | 14 | 4.67 |
| 0.1 | 3 | 5 | 3 | 11 | 3.67 |
| 0.2 | 3 | 3 | 5 | 11 | 3.67 |
| 0.3 | 5 | 2 | 4 | 11 | 3.67 |
| 0.4 | 4 | 2 | 2 | 8 | 2.67 |
| 0.5 | 3 | 1 | 3 | 7 | 2.33 |

TABLE 41
Matcha beverage: Evaluation score results of “strength”
of “richness” (n = 3)

| Additive amount of amino | Tester | | | Total | Average |
|---|---|---|---|---|---|
| acid composition [g] | a | b | c | [points] | [points] |
| 0 | 2 | 2 | 2 | 6 | 2.00 |
| 0.1 | 3 | 2 | 4 | 9 | 3.00 |
| 0.2 | 4 | 5 | 3 | 12 | 4.00 |
| 0.3 | 2 | 5 | 3 | 10 | 3.33 |
| 0.4 | 5 | 4 | 4 | 13 | 4.33 |
| 0.5 | 5 | 5 | 3 | 13 | 4.33 |

TABLE 42
Matcha beverage: Evaluation score results of “preferability”
of “richness” (n = 3)

| Additive amount of amino | Tester | | | Total | Average |
|---|---|---|---|---|---|
| acid composition [g] | a | b | c | [points] | [points] |
| 0 | 4 | 5 | 3 | 12 | 4.00 |
| 0.1 | 3 | 5 | 1 | 9 | 3.00 |
| 0.2 | 2 | 3 | 2 | 7 | 2.33 |
| 0.3 | 4 | 3 | 2 | 9 | 3.00 |
| 0.4 | 1 | 4 | 1 | 6 | 2.00 |
| 0.5 | 1 | 3 | 2 | 6 | 2.00 |

TABLE 43
Matcha beverage: Evaluation score results of “strength”
of “umami” (n = 3)

| Additive amount of amino | Tester | | | Total | Average |
|---|---|---|---|---|---|
| acid composition [g] | a | b | c | [points] | [points] |
| 0 | 4 | 3 | 3 | 10 | 3.33 |
| 0.1 | 2 | 2 | 5 | 9 | 3.00 |
| 0.2 | 3 | 2 | 4 | 9 | 3.00 |
| 0.3 | 2 | 4 | 4 | 10 | 3.33 |
| 0.4 | 4 | 3 | 2 | 9 | 3.00 |
| 0.5 | 1 | 2 | 4 | 7 | 2.33 |

TABLE 44
Matcha beverage: Evaluation score results of “preferability”
of “umami” (n = 3)

| Additive amount of amino | Tester | | | Total | Average |
|---|---|---|---|---|---|
| acid composition [g] | a | b | c | [points] | [points] |
| 0 | 4 | 4 | 4 | 12 | 4.00 |
| 0.1 | 2 | 3 | 2 | 7 | 2.33 |
| 0.2 | 3 | 2 | 3 | 8 | 2.67 |
| 0.3 | 2 | 5 | 3 | 10 | 3.33 |
| 0.4 | 5 | 4 | 5 | 14 | 4.67 |
| 0.5 | 1 | 2 | 3 | 6 | 2.00 |

TABLE 45
Matcha beverage: Evaluation score results of “strength”
of “flavor” (n = 3)

| Additive amount of amino | Tester | | | Total | Average |
|---|---|---|---|---|---|
| acid composition [g] | a | b | c | [points] | [points] |
| 0 | 4 | 4 | 2 | 10 | 3.33 |
| 0.1 | 2 | 2 | 4 | 8 | 2.67 |
| 0.2 | 1 | 3 | 3 | 7 | 2.33 |
| 0.3 | 2 | 3 | 4 | 9 | 3.00 |
| 0.4 | 4 | 3 | 2 | 9 | 3.00 |
| 0.5 | 3 | 1 | 3 | 7 | 2.33 |

TABLE 46
Matcha beverage: Evaluation score results of “preferability”
of “flavor” (n = 3)

| Additive amount of amino | Tester | | | Total | Average |
|---|---|---|---|---|---|
| acid composition [g] | a | b | c | [points] | [points] |
| 0 | 4 | 4 | 3 | 11 | 3.67 |
| 0.1 | 3 | 2 | 5 | 10 | 3.33 |
| 0.2 | 1 | 3 | 4 | 8 | 2.67 |
| 0.3 | 2 | 3 | 5 | 10 | 3.33 |
| 0.4 | 4 | 3 | 3 | 10 | 3.33 |
| 0.5 | 3 | 2 | 4 | 9 | 3.00 |

TABLE 47
Matcha beverage: Evaluation score results of “overall evaluation”
of “preferability” (n = 3)

| Additive amount of amino | Tester | | | Total | Average |
|---|---|---|---|---|---|
| acid composition [g] | a | b | c | [points] | [points] |
| 0 | 0 | 2 | 0 | 2 | 0.67 |
| 0.1 | 4 | 1 | 5 | 10 | 3.33 |
| 0.2 | 3 | 0 | 3 | 6 | 2.00 |
| 0.3 | 1 | 5 | 2 | 8 | 2.67 |
| 0.4 | 5 | 4 | 4 | 13 | 4.33 |
| 0.5 | 2 | 3 | 1 | 6 | 2.00 |

This amino acid composition adjusted the “strength” and “preferability” of “bitterness”, “aroma”, “richness”, “umami”, and “flavor” of matcha in a matcha beverage. In particular, the “strength” of “bitterness” and “richness” of matcha in a matcha beverage was enhanced through the addition of 0.1 g to 0.5 g of this amino acid composition relative to 1.5 g of powdered matcha. Moreover, the addition of 0.4 g of this amino acid composition relative to 1.5 g of powdered matcha resulted in a better evaluation for the “preferability” of “umami” of matcha in a matcha beverage as compared to the matcha beverage specimen serving as an additive-free control (0 g). Furthermore, with regards to the “overall evaluation”, the matcha beverage specimens to which this amino acid composition had been added each gave an excellent evaluation result compared to the matcha beverage specimen serving as an additive-free control (0 g).

### Example 6: Investigation of Additive Amount of Amino Acid Composition in Sweetener-Containing Matcha Beverage

Sweetener-containing matcha beverages were prepared with various amounts of an amino acid composition added thereto. The “strength” and “preferability” of “bitterness”, “aroma”, “richness”, “umami”, and “flavor” of matcha in these matcha beverages were evaluated.

### <Ingredients>

Used ingredients and sources thereof were as follows.
Powdered matcha: Powdered Tencha produced in Toyota (Yamauchi Yoshimasa) (Hekien Yamauchi Junpei Shoten)
Sugar: Spoon Brand Super Refined Sugar (Mitsui DM Sugar Co., Ltd.)
Water: Okudaisen Mineral Water (Suntory Holdings Limited)
Amino acid composition (L-valine, L-leucine, L-isoleucine, and sodium L-aspartate with make-up shown below in Table 48)

TABLE 48
Make-up of amino acid composition

| | | Blending ratio |
|---|---|---|
| Amino acid components | Parts by mass | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. 1.5 g of powdered matcha and 7.5 g of super refined sugar were thoroughly mixed together in advance.
2. A specific amount (0.1 g mass, 0.2 g mass, 0.3 g mass, 0.4 g mass, or 0.5 g mass) of the amino acid composition was added into a tea bowl, 80° C. hot water was poured into the tea bowl, and a tea whisk was used to cause dissolution until the amino acid composition was completely dissolved.
3. 1 was added to 2, was left to blend well therewith, and was subsequently stirred for 1 minute using a tea whisk.
4. After stirring, an outward spiral was drawn in the mixture, and the mixture was transferred to a vessel.

TABLE 49
Contents of amino acid composition and powdered
matcha in sweetener-containing matcha beverage

| Sweetener-containing | Amino acid | Powdered | Matcha beverage |
|---|---|---|---|
| matcha beverage | composition | matcha | (final volume) |
| specimen name | [g mass] | [g mass] | [mL] |
| Control | 0 | 1.5 | 89.0 |
| Sample 1 | 0.1 | 1.5 | 89.0 |
| Sample 2 | 0.2 | 1.5 | 89.0 |
| Sample 3 | 0.3 | 1.5 | 89.0 |
| Sample 4 | 0.4 | 1.5 | 89.0 |
| Sample 5 | 0.5 | 1.5 | 89.0 |

### <Test Method>

Six types of sweetener-containing matcha beverage specimens that had been prepared, inclusive of a control, were each poured into a paper cup, and these matcha beverage specimens were randomly assigned the letters A to F as specimen names in order that the testers would not know the additive amount of the amino acid composition in each thereof. The testers tasted each of these sweetener-containing matcha beverage specimens and gave a scored evaluation for a total of five parameters (“bitterness”, “aroma”, “richness”, “umami”, and “flavor”) of matcha in the sweetener-containing matcha beverage from viewpoints of “strength” and “preferability” thereof, and also from a viewpoint of “overall evaluation” taking into account texture, appearance, and so forth in addition to taste.

### <Scored Evaluation>

The “strength” of “bitterness”, “aroma”, “richness”, umami”, and “flavor” was given a 5-level scored evaluation of 1 point, 2 points, 3 points, 4 points, or 5 points, where a larger score represents an evaluation of greater “strength”. Averages were calculated from the evaluation scores of testers a, b, and c, and these averages were compared.

The “preferability” of “bitterness”, “aroma”, “richness”, umami”, and “flavor” was given a 5-level scored evaluation of 1 point, 2 points, 3 points, 4 points, or 5 points, where a larger score represents an evaluation of better “preferability”. Averages were calculated from the evaluation scores of testers a, b, and c, and these averages were compared.

With regards to “overall evaluation” taking into account texture, appearance, and so forth in addition to taste, the six types of sweetener-containing matcha beverage specimens, inclusive of the control, were ranked in order from 1^{st} to 6^{th} for overall “preferability”, and then the specimen ranked most preferable (1^{st}) was allotted 5 points, the specimen ranked 2^{nd} most preferable was allotted 4 points, the specimen ranked 3^{rd} most preferable was allotted 3 points, the specimen ranked 4^{th} most preferable was allotted 2 points, the specimen ranked 5^{th} most preferable was allotted 1 point, and the specimen ranked 6^{th} most preferable was allotted 0 points. Averages were calculated from the evaluation scores of testers a, b, and c, and these averages were compared.

### <Results>

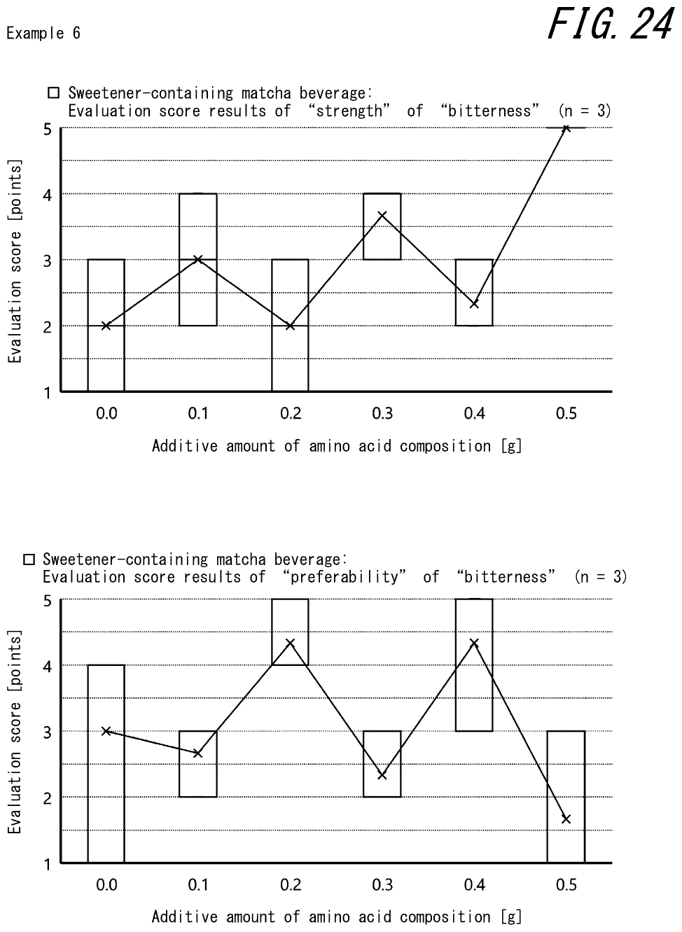

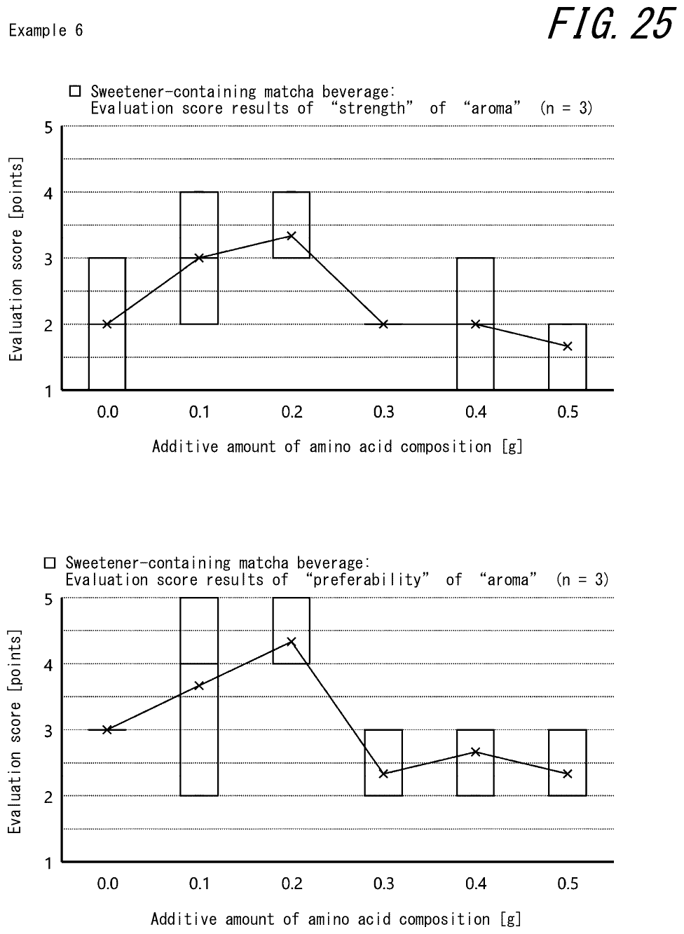

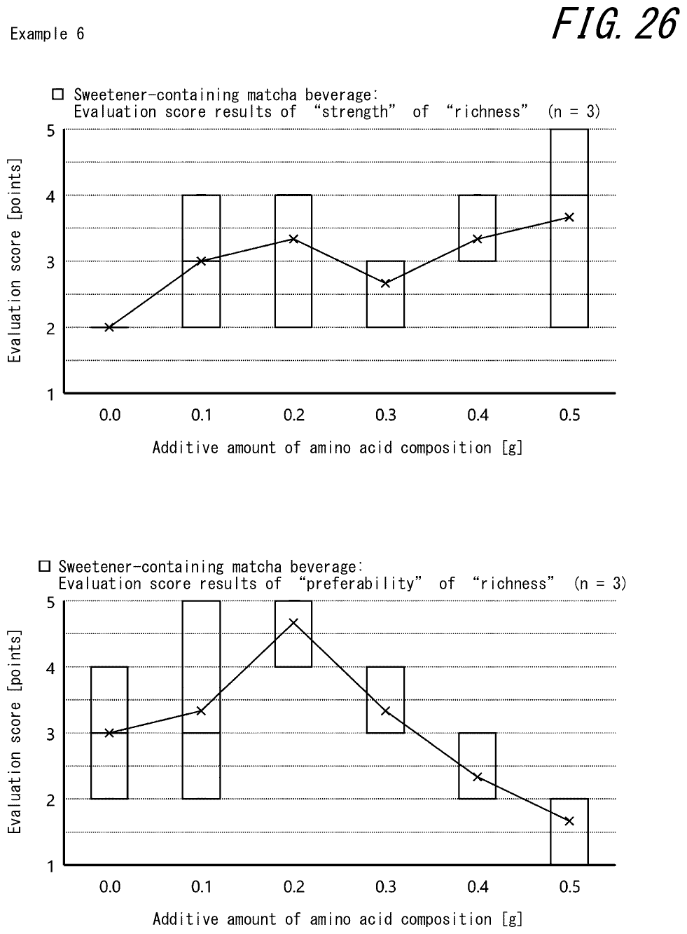

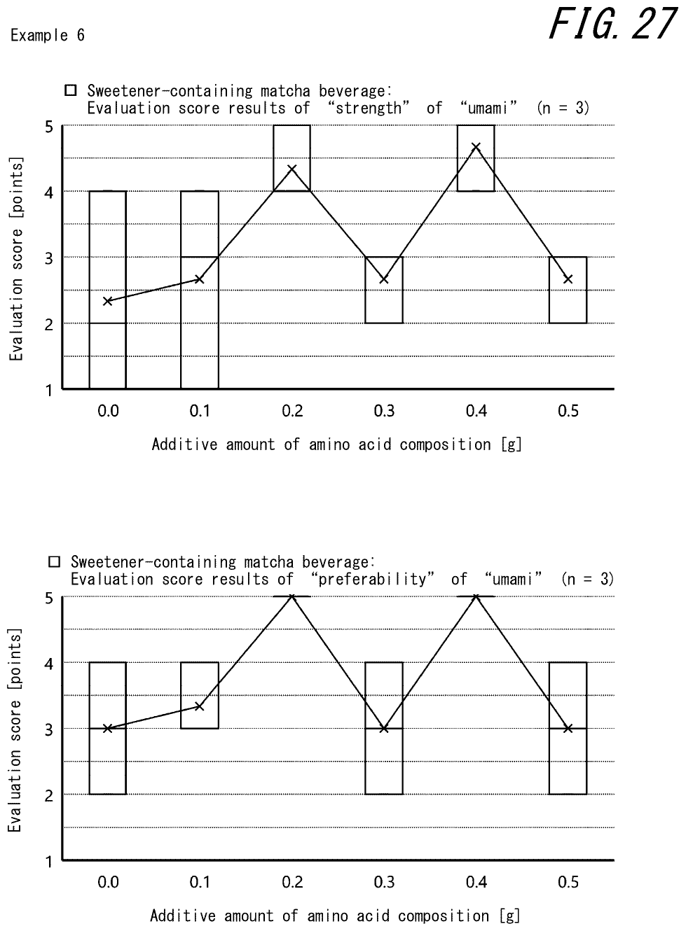

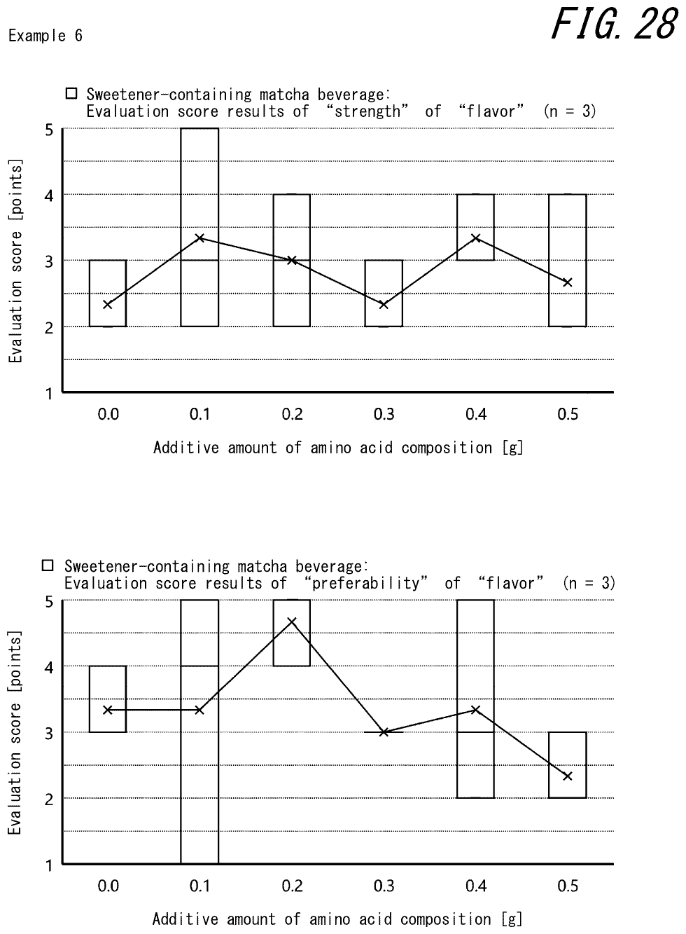

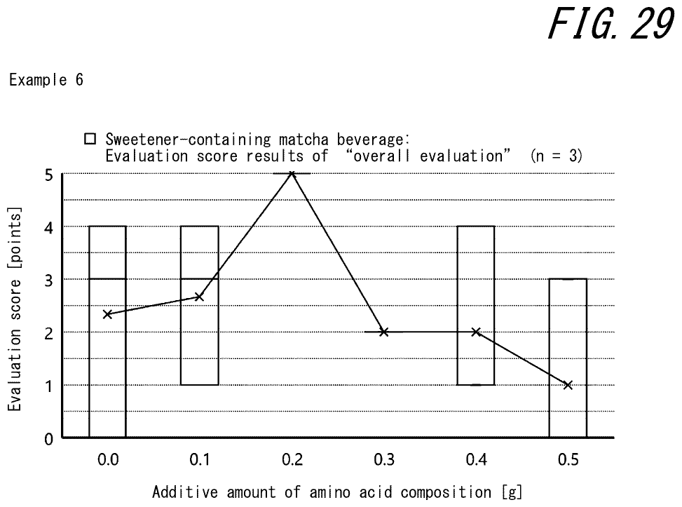

Evaluation score results and averages thereof in this example are presented in the following Tables 50 to 60 and in FIGS. 24 to 29.

TABLE 50
Sweetener-containing matcha beverage: Evaluation
score results of “strength” of
“bitterness” (n = 3)

| Additive amount of amino | Tester | | | Total | Average |
|---|---|---|---|---|---|
| acid composition [g] | a | b | c | [points] | [points] |
| 0 | 3 | 1 | 2 | 6 | 2.00 |
| 0.1 | 4 | 2 | 3 | 9 | 3.00 |
| 0.2 | 2 | 3 | 1 | 6 | 2.00 |
| 0.3 | 4 | 3 | 4 | 11 | 3.67 |
| 0.4 | 2 | 3 | 2 | 7 | 2.33 |
| 0.5 | 5 | 5 | 5 | 15 | 5.00 |

TABLE 51
Sweetener-containing matcha beverage: Evaluation
score results of “preferability”
of “bitterness” (n = 3)

| Additive amount of amino | Tester | | | Total | Average |
|---|---|---|---|---|---|
| acid composition [g] | a | b | c | [points] | [points] |
| 0 | 4 | 1 | 4 | 9 | 3.00 |
| 0.1 | 2 | 3 | 3 | 8 | 2.67 |
| 0.2 | 5 | 4 | 4 | 13 | 4.33 |
| 0.3 | 2 | 3 | 2 | 7 | 2.33 |
| 0.4 | 5 | 3 | 5 | 13 | 4.33 |
| 0.5 | 1 | 1 | 3 | 5 | 1.67 |

TABLE 52
Sweetener-containing matcha beverage: Evaluation
score results of “strength” of
“aroma” (n = 3)

| Additive amount of amino | Tester | | | Total | Average |
|---|---|---|---|---|---|
| acid composition [g] | a | b | c | [points] | [points] |
| 0 | 2 | 1 | 3 | 6 | 2.00 |
| 0.1 | 4 | 3 | 2 | 9 | 3.00 |
| 0.2 | 3 | 3 | 4 | 10 | 3.33 |
| 0.3 | 2 | 2 | 2 | 6 | 2.00 |
| 0.4 | 1 | 2 | 3 | 6 | 2.00 |
| 0.5 | 2 | 1 | 2 | 5 | 1.67 |

TABLE 53
Sweetener-containing matcha beverage: Evaluation
score results of “preferability”
of “aroma” (n = 3)

| Additive amount of amino | Tester | | | Total | Average |
|---|---|---|---|---|---|
| acid composition [g] | a | b | c | [points] | [points] |
| 0 | 3 | 3 | 3 | 9 | 3.00 |
| 0.1 | 5 | 4 | 2 | 11 | 3.67 |
| 0.2 | 5 | 4 | 4 | 13 | 4.33 |
| 0.3 | 2 | 3 | 2 | 7 | 2.33 |
| 0.4 | 2 | 3 | 3 | 8 | 2.67 |
| 0.5 | 2 | 3 | 2 | 7 | 2.33 |

TABLE 54
Sweetener-containing matcha beverage: Evaluation score results of
“strength” of “richness” (n = 3)

| Additive amount of amino | Tester | | | Total | Average |
|---|---|---|---|---|---|
| acid composition [g] | a | b | c | [points] | [points] |
| 0 | 2 | 2 | 2 | 6 | 2.00 |
| 0.1 | 4 | 2 | 3 | 9 | 3.00 |
| 0.2 | 4 | 4 | 2 | 10 | 3.33 |
| 0.3 | 2 | 3 | 3 | 8 | 2.67 |
| 0.4 | 3 | 3 | 4 | 10 | 3.33 |
| 0.5 | 2 | 5 | 4 | 11 | 3.67 |

TABLE 55
Sweetener-containing matcha beverage: Evaluation
score results of “preferability”
of “richness” (n = 3)

| Additive amount of amino | Tester | | | Total | Average |
|---|---|---|---|---|---|
| acid composition [g] | a | b | c | [points] | [points] |
| 0 | 3 | 2 | 4 | 9 | 3.00 |
| 0.1 | 5 | 2 | 3 | 10 | 3.33 |
| 0.2 | 5 | 5 | 4 | 14 | 4.67 |
| 0.3 | 3 | 4 | 3 | 10 | 3.33 |
| 0.4 | 2 | 3 | 2 | 7 | 2.33 |
| 0.5 | 2 | 1 | 2 | 5 | 1.67 |

TABLE 56
Sweetener-containing matcha beverage: Evaluation
score results of “strength” of
“umami” (n = 3)

| Additive amount of amino | Tester | | | Total | Average |
|---|---|---|---|---|---|
| acid composition [g] | a | b | c | [points] | [points] |
| 0 | 1 | 4 | 2 | 7 | 2.33 |
| 0.1 | 1 | 4 | 3 | 8 | 2.67 |
| 0.2 | 4 | 5 | 4 | 13 | 4.33 |
| 0.3 | 3 | 3 | 2 | 8 | 2.67 |
| 0.4 | 5 | 5 | 4 | 14 | 4.67 |
| 0.5 | 3 | 2 | 3 | 8 | 2.67 |

TABLE 57
Sweetener-containing matcha beverage: Evaluation
score results of “preferability”
of “umami” (n = 3)

| Additive amount of amino | Tester | | | Total | Average |
|---|---|---|---|---|---|
| acid composition [g] | a | b | c | [points] | [points] |
| 0 | 3 | 4 | 2 | 9 | 3.00 |
| 0.1 | 3 | 4 | 3 | 10 | 3.33 |
| 0.2 | 5 | 5 | 5 | 15 | 5.00 |
| 0.3 | 4 | 3 | 2 | 9 | 3.00 |
| 0.4 | 5 | 5 | 5 | 15 | 5.00 |
| 0.5 | 4 | 2 | 3 | 9 | 3.00 |

TABLE 58
Sweetener-containing matcha beverage: Evaluation score results of
“strength” of “flavor” (n = 3)

| Additive amount of amino | Tester | | | Total | Average |
|---|---|---|---|---|---|
| acid composition [g] | a | b | c | [points] | [points] |
| 0 | 2 | 2 | 3 | 7 | 2.33 |
| 0.1 | 3 | 2 | 5 | 10 | 3.33 |
| 0.2 | 3 | 2 | 4 | 9 | 3.00 |
| 0.3 | 2 | 3 | 2 | 7 | 2.33 |
| 0.4 | 3 | 4 | 3 | 10 | 3.33 |
| 0.5 | 2 | 4 | 2 | 8 | 2.67 |

TABLE 59
Sweetener-containing matcha beverage: Evaluation
score results of “preferability”
of “flavor” (n = 3)

| Additive amount of amino | Tester | | | Total | Average |
|---|---|---|---|---|---|
| acid composition [g] | a | b | c | [points] | [points] |
| 0 | 3 | 4 | 3 | 10 | 3.33 |
| 0.1 | 5 | 4 | 1 | 10 | 3.33 |
| 0.2 | 5 | 5 | 4 | 14 | 4.67 |
| 0.3 | 3 | 3 | 3 | 9 | 3.00 |
| 0.4 | 5 | 2 | 3 | 10 | 3.33 |
| 0.5 | 3 | 2 | 2 | 7 | 2.33 |

TABLE 60
Sweetener-containing matcha beverage: Evaluation
score results of “overall evaluation”
of “preferability” (n = 3)

| Additive amount of amino | Tester | | | Total | Average |
|---|---|---|---|---|---|
| acid composition [g] | a | b | c | [points] | [points] |
| 0 | 0 | 3 | 4 | 7 | 2.33 |
| 0.1 | 4 | 1 | 3 | 8 | 2.67 |
| 0.2 | 5 | 5 | 5 | 15 | 5.00 |
| 0.3 | 2 | 2 | 2 | 6 | 2.00 |
| 0.4 | 1 | 4 | 1 | 6 | 2.00 |
| 0.5 | 3 | 0 | 0 | 3 | 1.00 |

This amino acid composition adjusted the “strength” and “preferability” of “bitterness”, “aroma”, “richness”, “umami”, and “flavor” of matcha in a sweetener-containing matcha beverage. In particular, the “strength” of “bitterness”, “aroma”, “richness”, “umami”, and “flavor” of matcha in a sweetener-containing matcha beverage was enhanced through the addition of 0.1 g to 0.5 g of this amino acid composition relative to 1.5 g of powdered matcha as compared to the additive-free control (0 g), and particularly the “strength” of “richness” was enhanced. Moreover, with regards to the “overall evaluation”, the addition of 0.1 g or 0.2 g of this amino acid composition relative to 1.5 g of powdered matcha gave an excellent evaluation result as compared to the sweetener-containing matcha beverage specimen serving as an additive-free control (0 g).

### Example 7: Investigation of Additive Amount of Amino Acid Composition in Matcha Candy

Matcha candies were prepared with various amounts of an amino acid composition added thereto. The “strength” and “preferability” of “bitterness”, “sweetness”, “richness”, “flavor”, and “aroma” of matcha in these matcha candies were evaluated.

### <Ingredients>

Used ingredients and sources thereof were as follows.
Powdered matcha: Powdered Tencha produced in Toyota (Yamauchi Yoshimasa) (Hekien Yamauchi Junpei Shoten)
Canola oil
Sugar
Starch syrup
Amino acid composition (L-valine, L-leucine, L-isoleucine, and sodium L-aspartate with make-up shown below in Table 61)

TABLE 61
Make-up of amino acid composition

| | | Blending ratio |
|---|---|---|
| Amino acid components | Parts by mass | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. Specific amounts of the amino acid composition and powdered matcha in the following table were kneaded with 50 g of canola oil to obtain an “amino acid+matcha paste”.
2. 570 g of sugar and 330 g of starch syrup were mixed and boiled down to obtain a candy base.
3. 135 g of the “amino acid+matcha paste” was kneaded into 900 g of the candy base on a cooling plate (kneaded matcha candy).
4. The kneaded matcha candy of 3 was cooled and was shaped to obtain spherical candies of approximately 3 g/candy using a high-speed molding machine.

TABLE 62
Contents of amino acid composition and powdered
matcha in matcha candy specimens

| | Amino acid | Powdered | Kneaded |
|---|---|---|---|
| Matcha candy | composition | matcha | matcha candy |
| specimen name | [g mass] | [g mass] | [g mass] |
| Control | 0 | 85.0 | 1035 |
| Sample 1 | 20.0 | 65.0 | 1035 |
| Sample 2 | 35.0 | 50.0 | 1035 |
| Sample 3 | 42.5 | 42.5 | 1035 |
| Sample 4 | 55.0 | 30.0 | 1035 |

### <Scored Evaluation>

Five testers a, b, c, d, and e who regularly consume matcha beverages tasted each of five types of matcha candy specimens that had been prepared, inclusive of a control, and evaluated the “strength” of a total of five parameters (“bitterness”, “sweetness”, “richness”, “flavor”, and “aroma”) of matcha in the matcha candy specimens. In this evaluation, the “strength” was compared to the control and was given a 9-level scored evaluation in units of 0.5 in a range of 1 point to 5 points set as follows.
Extremely strong: 5 points
Strong: 4 points
Same level: 3 points (evaluation score of control is automatically taken to be 3 points)
Weak: 2 points
Extremely weak: 1 point
   (For example, 4.5 points is a score expressing a “strength” that is midway between “extremely strong” and “strong”.)

Averages were calculated from the evaluations scores of testers a, b, c, d, and e, and these averages were compared.

With regards to “overall evaluation” taking into account texture, appearance, and so forth in addition to taste, the five types of matcha candy specimens, inclusive of the control, were ranked in order from 1^{st} to 5^{th} for “preferability”, and then the specimen ranked most preferable (1^{st}) was allotted 5 points, the specimen ranked 2^{nd} most preferable was allotted 4 points, the specimen ranked 3^{rd} most preferable was allotted 3 points, the specimen ranked 4^{th} most preferable was allotted 2 points, and the specimen ranked 5^{th} most preferable was allotted 1 point.

### <Results>

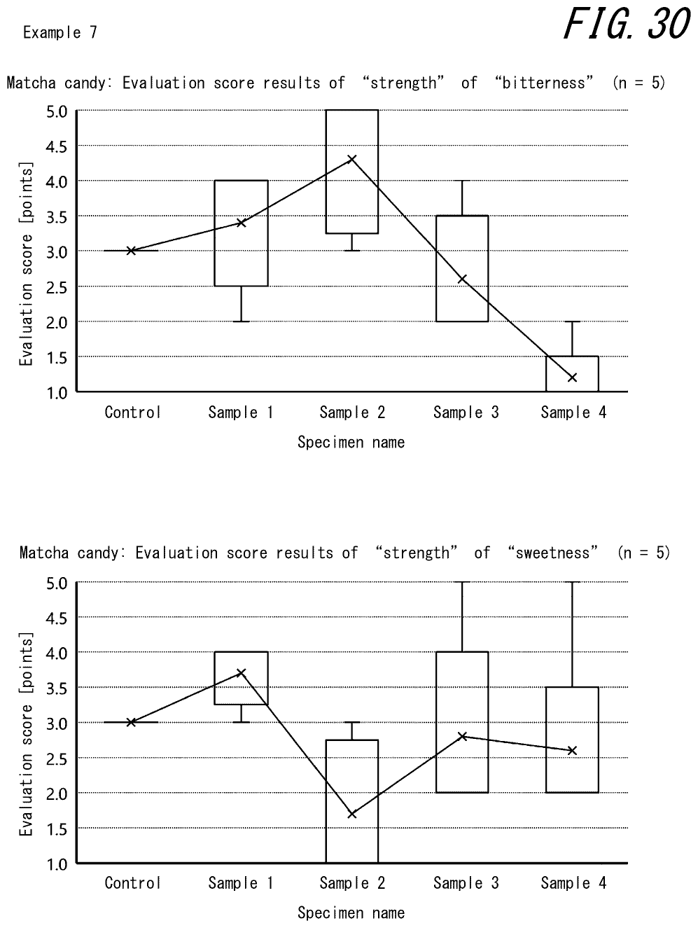

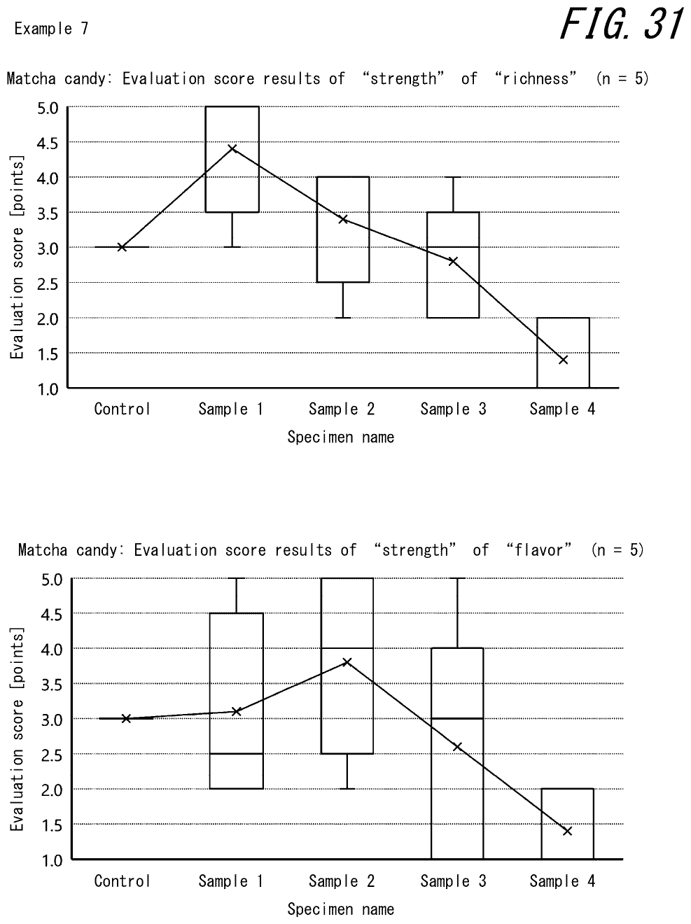

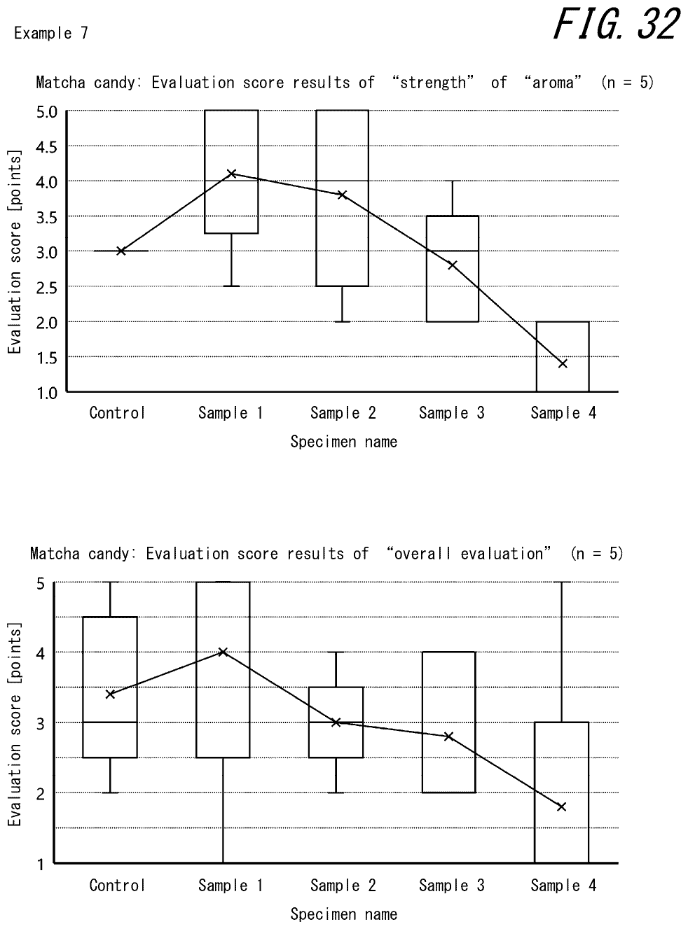

Evaluation score results and averages thereof in this example are presented in the following Tables 63 to 68 and in FIGS. 30 to 32.

TABLE 63
Matcha candy: Evaluation score results of “strength”
of “bitterness” (n = 5)

| Matcha candy | Tester | | | | | Total | Average |
|---|---|---|---|---|---|---|---|
| specimen name | a | b | c | d | e | [points] | [points] |
| Control | 3 | 3 | 3 | 3 | 3 | 15 | 3 |
| Sample 1 | 3 | 4 | 4 | 2 | 4 | 17 | 3.4 |
| Sample 2 | 3.5 | 3 | 5 | 5 | 5 | 21.5 | 4.3 |
| Sample 3 | 3 | 2 | 2 | 4 | 2 | 13 | 2.6 |
| Sample 4 | 1 | 2 | 1 | 1 | 1 | 6 | 1.2 |

TABLE 64
Matcha candy: Evaluation score results of “strength”
of “sweetness” (n = 5)

| Matcha candy | Tester | | | | | Total | Average |
|---|---|---|---|---|---|---|---|
| specimen name | a | b | c | d | e | [points] | [points] |
| Control | 3 | 3 | 3 | 3 | 3 | 15 | 3 |
| Sample 1 | 3.5 | 3 | 4 | 4 | 4 | 18.5 | 3.7 |
| Sample 2 | 2.5 | 3 | 1 | 1 | 1 | 8.5 | 1.7 |
| Sample 3 | 3 | 2 | 5 | 2 | 2 | 14 | 2.8 |
| Sample 4 | 2 | 2 | 2 | 5 | 2 | 13 | 2.6 |

TABLE 65
Matcha candy: Evaluation score results of “strength”
of “richness” (n = 5)

| Matcha candy | Tester | | | | | Total | Average |
|---|---|---|---|---|---|---|---|
| specimen name | a | b | c | d | e | [points] | [points] |
| Control | 3 | 3 | 3 | 3 | 3 | 15 | 3 |
| Sample 1 | 3 | 4 | 5 | 5 | 5 | 22 | 4.4 |
| Sample 2 | 3 | 4 | 2 | 4 | 4 | 17 | 3.4 |
| Sample 3 | 3 | 3 | 4 | 2 | 2 | 14 | 2.8 |
| Sample 4 | 2 | 2 | 1 | 1 | 1 | 7 | 1.4 |

TABLE 66
Matcha candy: Evaluation score results of “strength”
of “flavor” (n = 5)

| Matcha candy | Tester | | | | | Total | Average |
|---|---|---|---|---|---|---|---|
| specimen name | a | b | c | d | e | [points] | [points] |
| Control | 3 | 3 | 3 | 3 | 3 | 15 | 3 |
| Sample 1 | 2.5 | 5 | 4 | 2 | 2 | 15.5 | 3.1 |
| Sample 2 | 3 | 4 | 2 | 5 | 5 | 19 | 3.8 |
| Sample 3 | 3 | 3 | 5 | 1 | 1 | 13 | 2.6 |
| Sample 4 | 2 | 2 | 1 | 1 | 1 | 7 | 1.4 |

TABLE 67
Matcha candy: Evaluation score results of “strength”
of “aroma” (n = 5)

| Matcha candy | Tester | | | | | Total | Average |
|---|---|---|---|---|---|---|---|
| specimen name | a | b | c | d | e | [points] | [points] |
| Control | 3 | 3 | 3 | 3 | 3 | 15 | 3 |
| Sample 1 | 2.5 | 5 | 5 | 4 | 4 | 20.5 | 4.1 |
| Sample 2 | 3 | 4 | 2 | 5 | 5 | 19 | 3.8 |
| Sample 3 | 3 | 3 | 4 | 2 | 2 | 14 | 2.8 |
| Sample 4 | 2 | 2 | 1 | 1 | 1 | 7 | 1.4 |

TABLE 68
Matcha candy: Evaluation score results of “overall
evaluation” (n = 5)

| Matcha candy | Tester | | | | | Total | Average |
|---|---|---|---|---|---|---|---|
| specimen name | a | b | c | d | e | [points] | [points] |
| Control | 5 | 3 | 2 | 4 | 3 | 17 | 3.4 |
| Sample 1 | 4 | 5 | 5 | 5 | 1 | 20 | 4 |
| Sample 2 | 3 | 4 | 3 | 3 | 2 | 15 | 3 |
| Sample 3 | 2 | 2 | 4 | 2 | 4 | 14 | 2.8 |
| Sample 4 | 1 | 1 | 1 | 1 | 5 | 9 | 1.8 |

This amino acid composition adjusted the “strength” and “preferability” of “bitterness”, “aroma”, “richness”, “umami”, and “flavor” of matcha in a matcha candy. In particular, although the “bitterness” of matcha in a matcha candy was strengthened in sample 1 and sample 2, the “aroma”, “richness”, and “flavor” were also enhanced, and the “sweetness” was also enhanced in sample 1. This amino acid composition particularly enhanced the “strength” of “richness” of matcha in a matcha candy. In terms of “overall evaluation”, sample 1 gave the best evaluation result for “preferability”.

### Example 8: Investigation of Additive Amount of Amino Acid Composition in Matcha Baked Sweet

### <Ingredients>

Used ingredients and sources thereof were as follows.
Powdered matcha: Powdered Tencha produced in Toyota (Yamauchi Yoshimasa) (Hekien Yamauchi Junpei Shoten)
Egg white
Sugar: Spoon Brand Super Refined Sugar (Mitsui DM Sugar Co., Ltd.)
Butter: Snow Brand Hokkaido Butter (unsalted) (MEGMILK SNOW BRAND Co., Ltd.)
Flour: Cake flour (Nisshin Seifun Welna Inc.)
Almond flour (no skin) (Imagawa Seika)
Confectionery baking powder (aluminum-free) (Nishi Nihon Shokuhin Kogyo K.K.)
Amino acid composition (L-valine, L-leucine, L-isoleucine, and sodium L-aspartate)

TABLE 69
Make-up of amino acid composition

| | Parts by mass | Blending ratio |
|---|---|---|
| Amino acid components | [mg] | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. A small amount of butter and a small amount of cake flour (not included in recipe amounts) were sprinkled into a mold for a matcha baked in 5 sweet.
2. 7.5 g of unsalted butter was loaded into an IH-compatible single-handled pot (base diameter 15 cm×opening diameter 18 cm×height 8.5 cm×handle length 15 cm) and was heated for 3 minutes 30 seconds at medium heat to prepare browned butter. The prepared browned butter was filtered using a tea strainer in order that burnt butter was not present.
3. 8.125 g of egg white and 8.125 g of super refined sugar were loaded into a bowl and were loosened up through mixing using a whisk. During this mixing, care was taken to not cause foaming.
4. 3.125 g of cake flour, 3.125 g of almond flour, 1.25 g of matcha, and 0.125 g of baking powder were all combined and sifted into 2 and were mixed together. In a case in which the amino acid composition was to be added, a specific amount thereof was added at this time (pre-baking).
5. The browned butter was added to 3 and was mixed therewith until the mixture was uniform.
6. A spoon was used to pour the dough into the mold onto which butter and cake flour had been sprinkled.
7. The dough was heated for 15 minutes in an oven that had been preheated to 180° C.

TABLE 70
Contents of amino acid composition and powdered
matcha in matcha baked sweet specimens

| | | Powdered | |
|---|---|---|---|
| Matcha | Amino acid | matcha | Matcha baked sweet |
| baked sweet | composition | [g parts | (mass pre-baking) |
| specimen name | [g parts by mass] | by mass] | [g parts by mass] |
| Control | 0 | 1.25 | 31 |
| Sample 1 | 1.0 | 1.25 | 31 |
| Sample 2 | 2.0 | 1.25 | 31 |
| Sample 3 | 3.0 | 1.25 | 31 |

### <Test Method>

Four types of matcha baked sweet specimens that had been prepared, inclusive of a control, were randomly assigned the letters A to D as specimen names in order that the testers would not know the additive amount of the amino acid composition in each thereof. The testers tasted each of these matcha baked sweet specimens and gave a scored evaluation for a total of five parameters (“bitterness”, “aroma”, “richness”, “sweetness”, and “flavor”) from viewpoints of “strength” and “preferability” thereof, and also from a viewpoint of “overall evaluation” taking into account texture, appearance, and so forth in addition to taste.

### <Scored Evaluation>

With regards to the “strength” of “bitterness”, “aroma”, “richness”, “sweetness”, and “flavor”, the four types of matcha baked sweet specimens, inclusive of the control, were ranked in order from 1^{st} to 4^{th} for the “strength” of each evaluation parameter, and then the specimen ranked strongest (1^{st}) was allotted 4 points, the specimen ranked 2^{nd} strongest was allotted 3 points, the specimen ranked 3^{rd} strongest was allotted 2 points, and the specimen ranked 4^{th} strongest was allotted 1 point. Averages were calculated from the evaluations scores of testers a, b, c, and d, and these averages were compared.

With regards to the “preferability” of “bitterness”, “aroma”, “richness”, “sweetness”, and “flavor” and “overall evaluation” taking into account texture, appearance, and so forth in addition to taste, the four types of matcha baked sweet specimens, inclusive of the control, were ranked in order from 1^{st} to 4^{th} for the “preferability” of each evaluation parameter, and then the specimen ranked most preferable (1^{st}) was allotted 4 points, the specimen ranked 2^{nd} most preferable was allotted 3 points, the specimen ranked 3^{rd} most preferable was allotted 2 points, and the specimen ranked 4^{th} most preferable was allotted 1 point. Averages were calculated from the evaluations scores of testers a, b, c, and d, and these averages were compared.

### <Results>

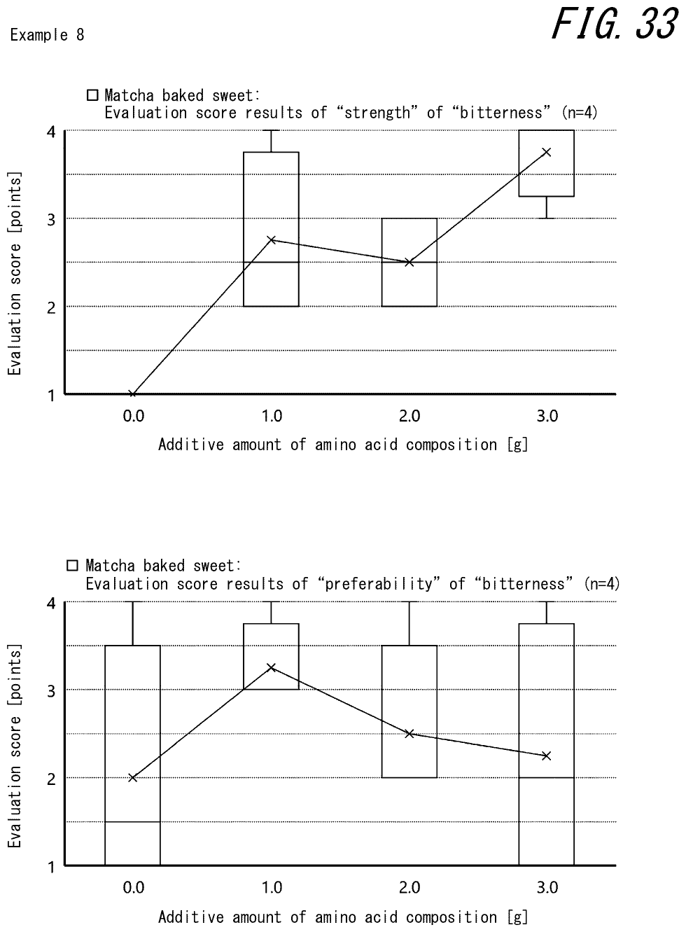

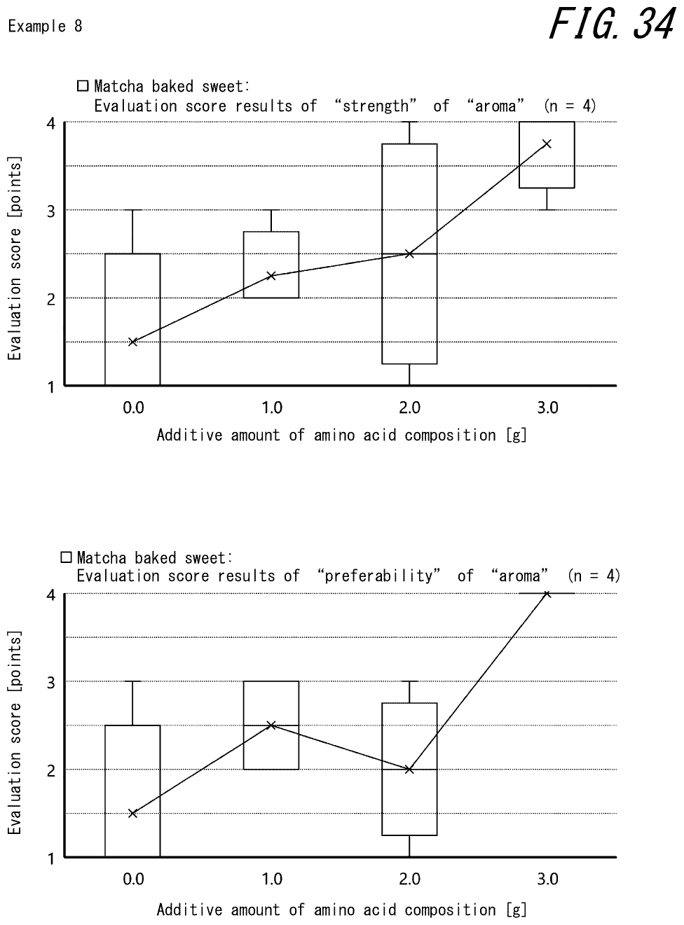

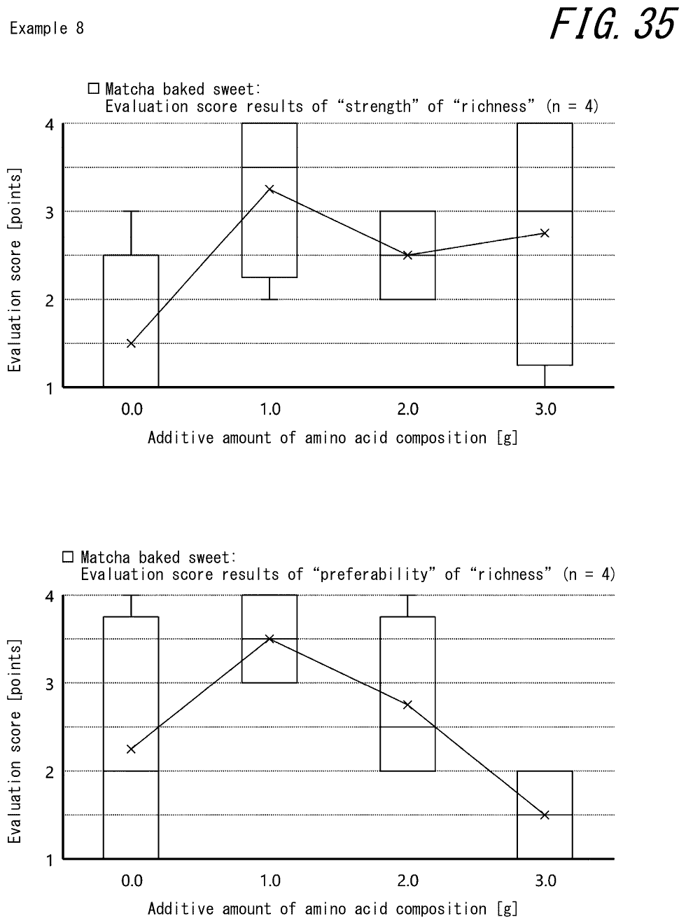

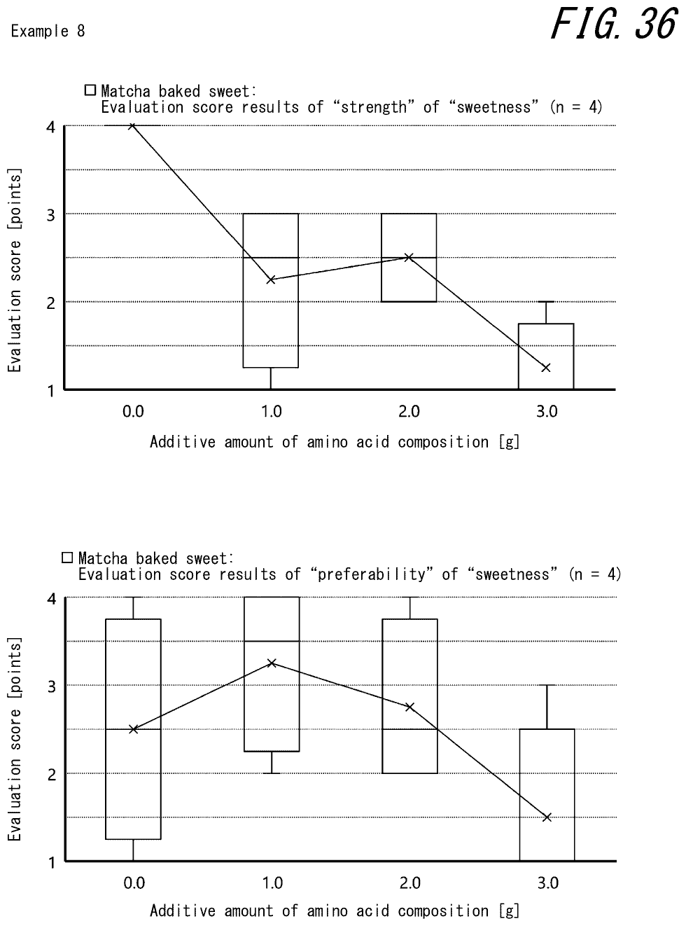

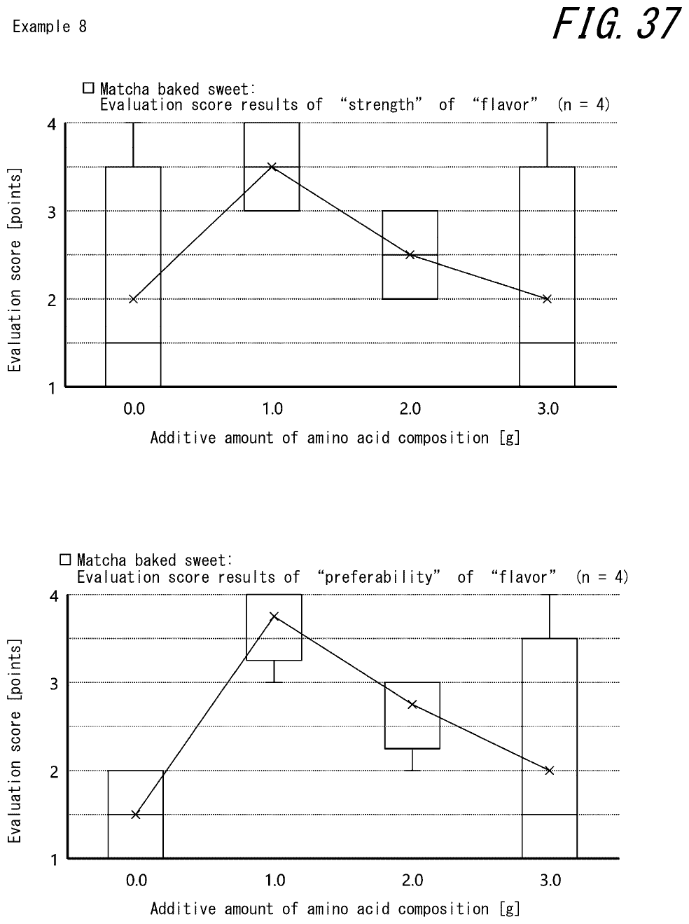

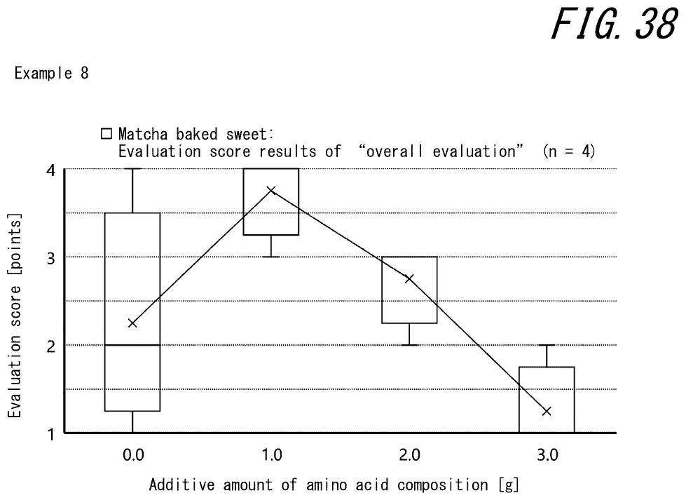

Evaluation score results and averages thereof in this example are presented in the following Tables 71 to 81 and in FIGS. 33 to 38.

TABLE 71
Matcha baked sweet: Evaluation score results of “strength”
of “bitterness” (n = 4)

| Additive amount of amino | Tester | | | | Total | Average |
|---|---|---|---|---|---|---|
| acid composition [g] | a | b | c | d | [points] | [points] |
| 0.0 | 1 | 1 | 1 | 1 | 4 | 1.00 |
| 1.0 | 3 | 4 | 2 | 2 | 11 | 2.75 |
| 2.0 | 2 | 2 | 3 | 3 | 10 | 2.50 |
| 3.0 | 4 | 3 | 4 | 4 | 15 | 3.75 |

TABLE 72
Matcha baked sweet: Evaluation score results of “preferability”
of “bitterness” (n = 4)

| Additive amount of amino | Tester | | | | Total | Average |
|---|---|---|---|---|---|---|
| acid composition [g] | a | b | c | d | [points] | [points] |
| 0.0 | 1 | 1 | 2 | 4 | 8 | 2.00 |
| 1.0 | 3 | 4 | 3 | 3 | 13 | 3.25 |
| 2.0 | 2 | 2 | 4 | 2 | 10 | 2.50 |
| 3.0 | 4 | 3 | 1 | 1 | 9 | 2.25 |

TABLE 73
Matcha baked sweet: Evaluation score results of “strength”
of “aroma” (n = 4)

| Additive amount of amino | Tester | | | | Total | Average |
|---|---|---|---|---|---|---|
| acid composition [g] | a | b | c | d | [points] | [points |
| 0.0 | 3 | 1 | 1 | 1 | 6 | 1.50 |
| 1.0 | 2 | 3 | 2 | 2 | 9 | 2.25 |
| 2.0 | 1 | 2 | 4 | 3 | 10 | 2.50 |
| 3.0 | 4 | 4 | 3 | 4 | 15 | 3.75 |

TABLE 74
Matcha baked sweet: Evaluation score results of “preferability”
of “aroma” (n = 4)

| Additive amount of amino | Tester | | | | Total | Average |
|---|---|---|---|---|---|---|
| acid composition [g] | a | b | c | d | [points] | [points] |
| 0.0 | 3 | 1 | 1 | 1 | 6 | 1.50 |
| 1.0 | 2 | 3 | 3 | 2 | 10 | 2.50 |
| 2.0 | 1 | 2 | 2 | 3 | 8 | 2.00 |
| 3.0 | 4 | 4 | 4 | 4 | 16 | 4.00 |

TABLE 75
Matcha baked sweet: Evaluation score results of “strength”
of “richness” (n = 4)

| Additive amount of amino | Tester | | | | Total | Average |
|---|---|---|---|---|---|---|
| acid composition [g] | a | b | c | d | [points] | [points] |
| 0.0 | 3 | 1 | 1 | 1 | 6 | 1.50 |
| 1.0 | 4 | 4 | 3 | 2 | 13 | 3.25 |
| 2.0 | 2 | 3 | 2 | 3 | 10 | 2.50 |
| 3.0 | 1 | 2 | 4 | 4 | 11 | 2.75 |

TABLE 76
Matcha baked sweet: Evaluation score results of “preferability”
of “richness” (n = 4)

| Additive amount of amino | Tester | | | | Total | Average |
|---|---|---|---|---|---|---|
| acid composition [g] | a | b | c | d | [points] | [points] |
| 0.0 | 3 | 1 | 1 | 4 | 9 | 2.25 |
| 1.0 | 4 | 4 | 3 | 3 | 14 | 3.50 |
| 2.0 | 2 | 3 | 4 | 2 | 11 | 2.75 |
| 3.0 | 1 | 2 | 2 | 1 | 6 | 1.50 |

TABLE 77
Matcha baked sweet: Evaluation score results of “strength”
of “sweetness” (n = 4)

| Additive amount of amino | Tester | | | | Total | Average |
|---|---|---|---|---|---|---|
| acid composition [g] | a | b | c | d | [points] | [points] |
| 0.0 | 4 | 4 | 4 | 4 | 16 | 4.00 |
| 1.0 | 2 | 1 | 3 | 3 | 9 | 2.25 |
| 2.0 | 3 | 3 | 2 | 2 | 10 | 2.50 |
| 3.0 | 1 | 2 | 1 | 1 | 5 | 1.25 |

TABLE 78
Matcha baked sweet: Evaluation score results of “preferability”
of “sweetness” (n = 4)

| Additive amount of amino | Tester | | | | Total | Average |
|---|---|---|---|---|---|---|
| acid composition [g] | a | b | c | d | [points] | [points] |
| 0.0 | 3 | 1 | 2 | 4 | 10 | 2.50 |
| 1.0 | 2 | 4 | 4 | 3 | 13 | 3.25 |
| 2.0 | 4 | 2 | 3 | 2 | 11 | 2.75 |
| 3.0 | 1 | 3 | 1 | 1 | 6 | 1.50 |

TABLE 79
Matcha baked sweet: Evaluation score results of “strength”
of “flavor” (n = 4)

| Additive amount of amino | Tester | | | | Total | Average |
|---|---|---|---|---|---|---|
| acid composition [g] | a | b | c | d | [points] | [points] |
| 0.0 | 2 | 1 | 4 | 1 | 8 | 2.00 |
| 1.0 | 4 | 4 | 3 | 3 | 14 | 3.50 |
| 2.0 | 3 | 3 | 2 | 2 | 10 | 2.50 |
| 3.0 | 1 | 2 | 1 | 4 | 8 | 2.00 |

TABLE 80
Matcha baked sweet: Evaluation score results of “preferability”
of “flavor” (n = 4)

| Additive amount of amino | Tester | | | | Total | Average |
|---|---|---|---|---|---|---|
| acid composition [g] | a | b | c | d | [points] | [points] |
| 0.0 | 2 | 1 | 2 | 1 | 6 | 1.50 |
| 1.0 | 4 | 4 | 4 | 3 | 15 | 3.75 |
| 2.0 | 3 | 3 | 3 | 2 | 11 | 2.75 |
| 3.0 | 1 | 2 | 1 | 4 | 8 | 2.00 |

TABLE 81
Matcha baked sweet: Evaluation score results of
“overall evaluation” (n = 4)

| Additive amount of amino | Tester | | | | Total | Average |
|---|---|---|---|---|---|---|
| acid composition [g] | a | b | c | d | [points] | [points] |
| 0.0 | 2 | 1 | 2 | 4 | 9 | 2.25 |
| 1.0 | 4 | 4 | 4 | 3 | 15 | 3.75 |
| 2.0 | 3 | 3 | 3 | 2 | 11 | 2.75 |
| 3.0 | 1 | 2 | 1 | 1 | 5 | 1.25 |

This amino acid composition adjusted the “strength” and “preferability” of “bitterness”, “aroma”, “richness”, “sweetness”, and “flavor” of matcha in a matcha baked sweet. In particular, the addition of 1.0 g, 2.0 g, or 3.0 g of this amino acid composition relative to 1.25 g of powdered matcha enhanced the “strength” of “bitterness”, “aroma”, “richness”, and “flavor” of matcha in a matcha baked sweet as compared to the additive-free control (0 g), and the same trend was also demonstrated with regards to “preferability” thereof. This amino acid composition particularly enhanced the “strength” of “richness” of matcha in a matcha baked sweet. In terms of “overall evaluation”, the addition of 1.0 g or 2.0 g of this amino acid composition relative to 1.25 g of powdered matcha gave an excellent evaluation result compared to a case in which the amino acid composition was not added (0 g).

### Example 9: Investigation of Additive Amount of Amino Acid Composition in Matcha Ice Cream

### <Ingredients>

Used ingredients and sources thereof were as follows.
Powdered matcha: Powdered Tencha produced in Toyota (Yamauchi Yoshimasa) (Hekien Yamauchi Junpei Shoten)
Milk fat cream with fresh cream from Hokkaido (MEGMILK SNOW BRAND Co., Ltd.)
Sugar: Spoon Brand Light Brown Sugar (Mitsui DM Sugar Co., Ltd.) Egg yolk
Amino acid composition (L-valine, L-leucine, L-isoleucine, and sodium L-aspartate)

TABLE 82
Make-up of amino acid composition

| Amino acid | | Blending ratio |
|---|---|---|
| components | Parts by mass | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. 6.4 g of egg yolk was loaded into a bowl and was stirred by a whisk until it became whiteish. 14.4 g of light brown sugar was added thereto in two portions and was stirred until white and cloudy.
2. 90.0 g of fresh cream was stirred by a hand mixer until a film formed at the surface thereof, 12.0 g of matcha was added, and whisking was performed until a stiff peak formed. In a case in which the amino acid composition was to be added, a specific amount thereof was added at this time.
3. 2 was added to 1 and was thoroughly mixed therewith using a rubber spatula while avoiding squashing the foam (pre-freezing).
4. The mixture was cooled and solidified overnight in a −21° C. freezer.

TABLE 83
Contents of amino acid composition and powdered
matcha in matcha ice cream specimens

| Matcha | | | Matcha ice cream |
|---|---|---|---|
| ice cream | Amino acid | Powdered | (mass pre- |
| specimen | composition | matcha | freezing) |
| name | [g parts by mass] | [g parts by mass] | [g parts by mass] |
| Control | 0 | 12 | 112 |
| Sample 1 | 1.0 | 12 | 112 |
| Sample 2 | 2.0 | 12 | 112 |
| Sample 3 | 3.0 | 12 | 112 |
| Sample 4 | 4.0 | 12 | 112 |

### <Test Method>

Five types of matcha ice cream specimens that had been prepared, inclusive of a control, were randomly assigned the letters A to E as specimen names in order that the testers would not know the additive amount of the amino acid composition in each thereof. The testers tasted each of these matcha ice cream specimens and gave a scored evaluation for a total of five parameters (“bitterness”, “aroma”, “richness”, “sweetness”, and “flavor”) from viewpoints of “strength” and “preferability” thereof, and also from a viewpoint of “overall evaluation” taking into account texture, appearance, and so forth in addition to taste.

### <Scored Evaluation>

With regards to the “strength” of “bitterness”, “aroma”, “richness”, “sweetness”, and “flavor”, the five types of matcha ice cream specimens, inclusive of the control, were ranked in order from 1^{st} to 5^{th} for the “strength” of each evaluation parameter, and then the specimen ranked strongest (1^{st}) was allotted 5 points, the specimen ranked 2^{nd} strongest was allotted 4 points, the specimen ranked 3^{rd} strongest was allotted 3 points, the specimen ranked 4^{th} strongest was allotted 2 points, and the specimen ranked 5^{th} strongest was allotted 1 point. Averages were calculated from the evaluations scores of testers a, b, and c, and these averages were compared.

With regards to the “preferability” of “bitterness”, “aroma”, “richness”, “sweetness”, and “flavor” and “overall evaluation” taking into account texture, appearance, and so forth in addition to taste, the five types of matcha ice cream specimens, inclusive of the control, were ranked in order from 1^{st} to 5^{th} for the “preferability” of each evaluation parameter, and then the specimen ranked most preferable (1^{st}) was allotted 5 points, the specimen ranked 2^{nd} most preferable was allotted 4 points, the specimen ranked 3^{rd} most preferable was allotted 3 points, and the specimen ranked 4^{th} most preferable was allotted 2 points, and the specimen ranked 5^{th} most preferable was allotted 1 point. Averages were calculated from the evaluations scores of testers a, b, and c, and these averages were compared.

### <Results>

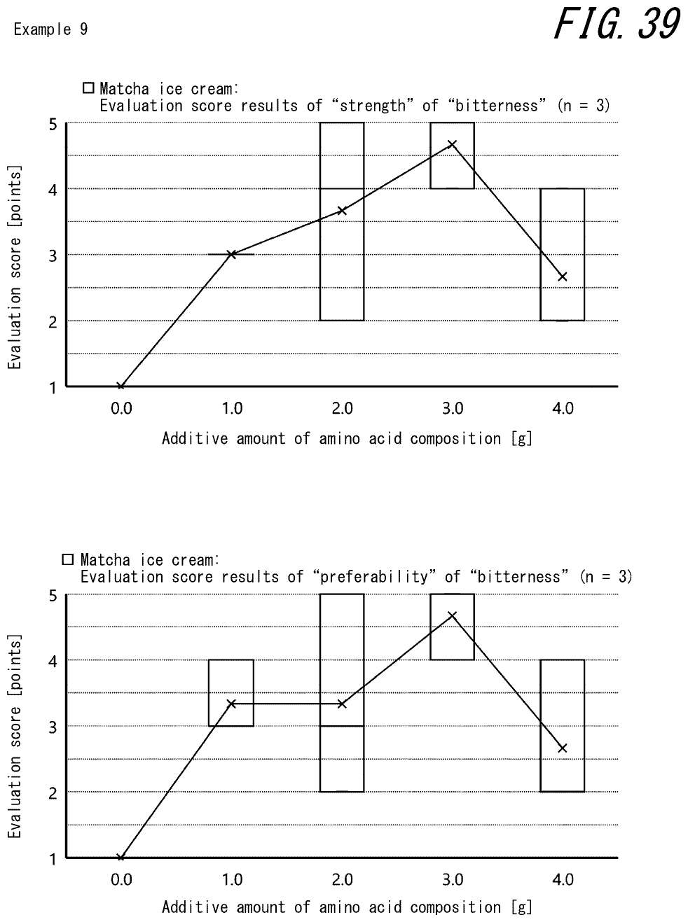

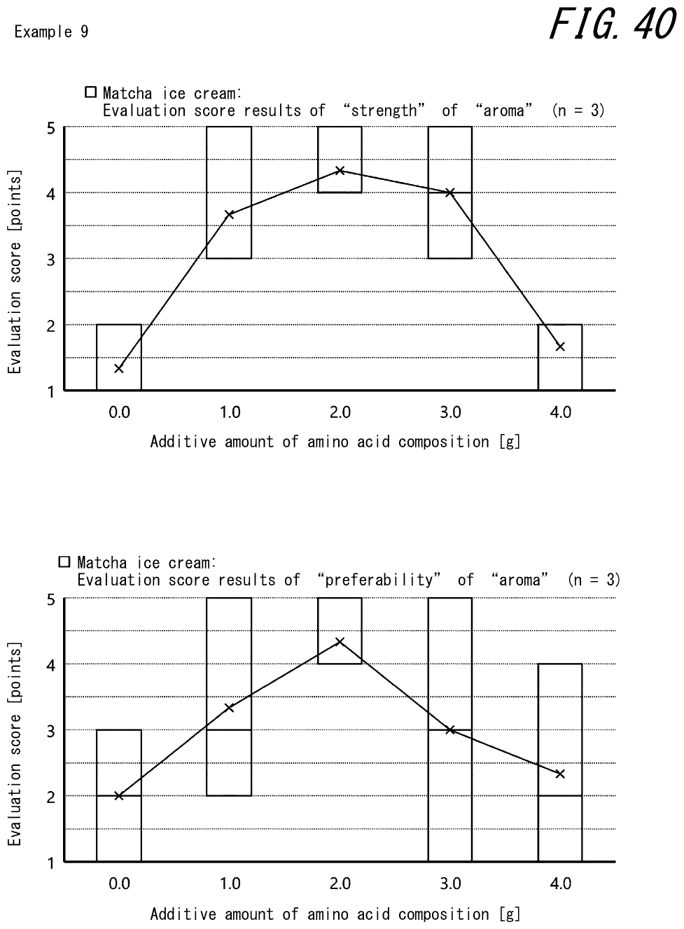

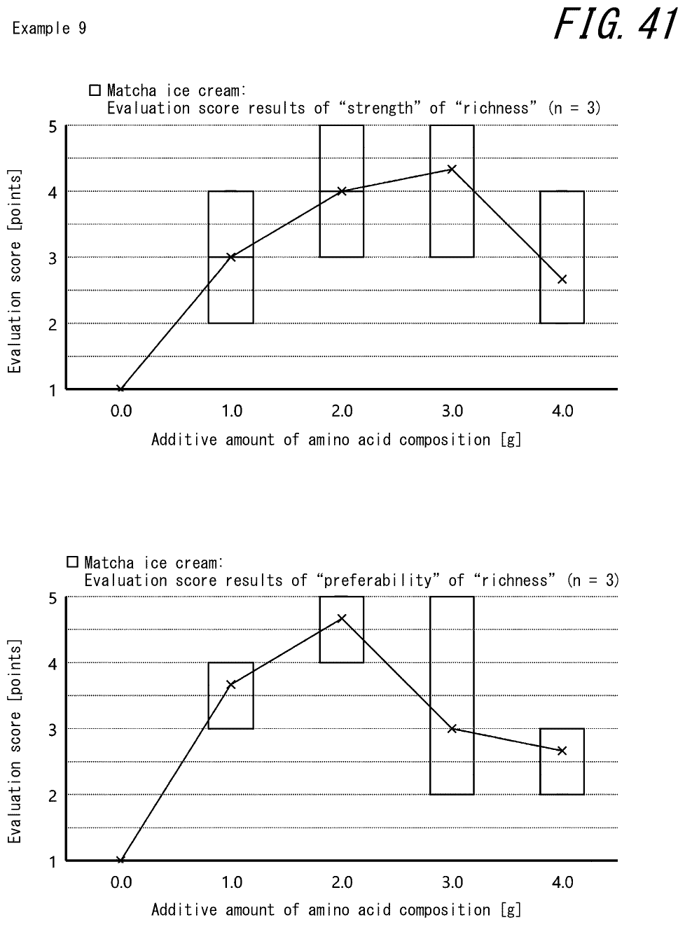

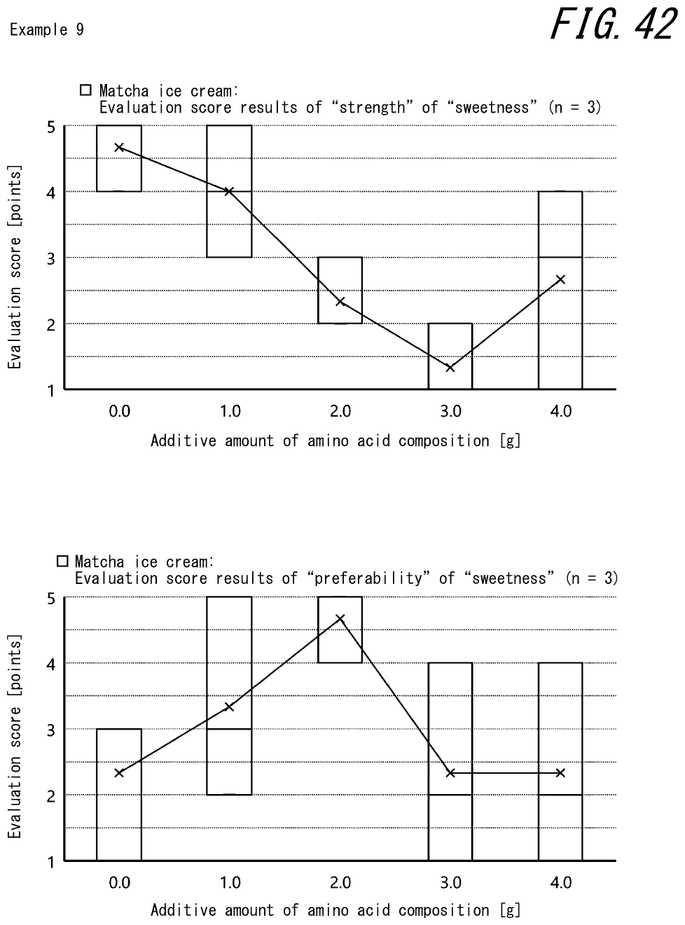

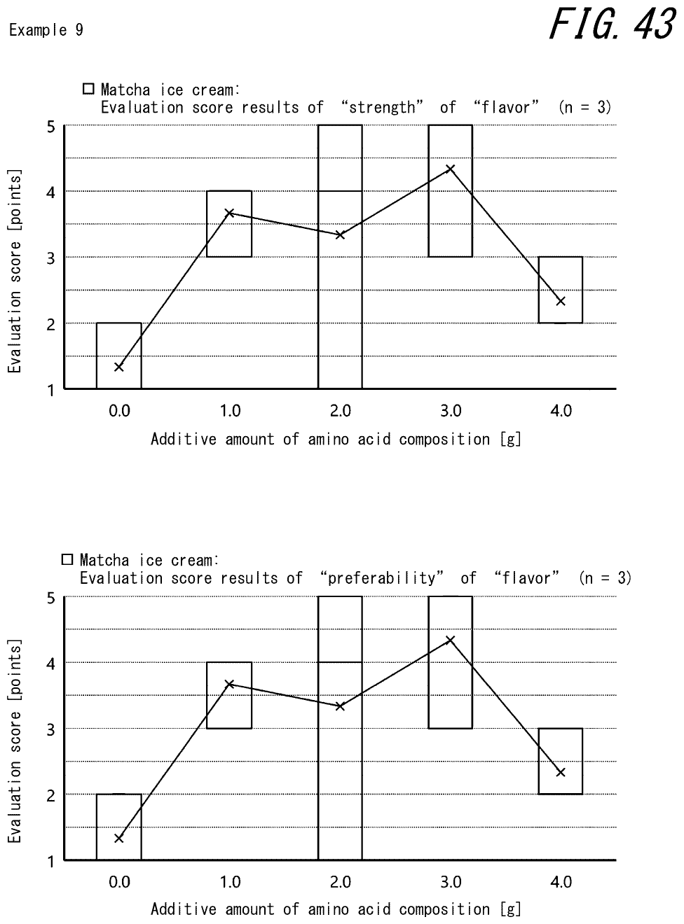

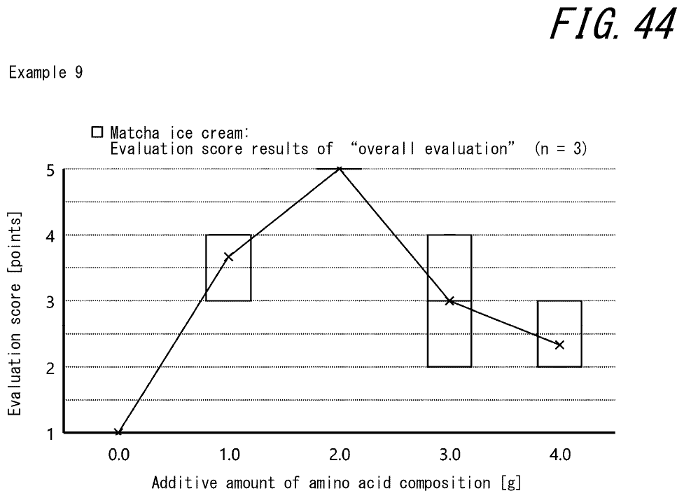

Evaluation score results and averages thereof in this example are presented in the following Tables 84 to 94 and in FIGS. 39 to 44.

TABLE 84
Matcha ice cream: Evaluation score results of “strength”
of “bitterness” (n = 3)

| Additive amount of amino | Tester | | | Total | Average |
|---|---|---|---|---|---|
| acid composition [g] | a | b | c | [points] | [points] |
| 0.0 | 1 | 1 | 1 | 3 | 1.00 |
| 1.0 | 3 | 3 | 3 | 9 | 3.00 |
| 2.0 | 5 | 2 | 4 | 11 | 3.67 |
| 3.0 | 4 | 5 | 5 | 14 | 4.67 |
| 4.0 | 2 | 4 | 2 | 8 | 2.67 |

TABLE 85
Matcha ice cream: Evaluation score results of “preferability”
of “bitterness” (n = 3)

| Additive amount of amino | Tester | | | Total | Average |
|---|---|---|---|---|---|
| acid composition [g] | a | b | c | [points] | [points] |
| 0.0 | 1 | 1 | 1 | 3 | 1.00 |
| 1.0 | 3 | 3 | 4 | 10 | 3.33 |
| 2.0 | 5 | 2 | 3 | 10 | 3.33 |
| 3.0 | 4 | 5 | 5 | 14 | 4.67 |
| 4.0 | 2 | 4 | 2 | 8 | 2.67 |

TABLE 86
Matcha ice cream: Evaluation score results of “strength”
of “aroma” (n = 3)

| Additive amount of amino | Tester | | | Total | Average |
|---|---|---|---|---|---|
| acid composition [g] | a | b | c | [points] | [points] |
| 0.0 | 1 | 2 | 1 | 4 | 1.33 |
| 1.0 | 3 | 5 | 3 | 11 | 3.67 |
| 2.0 | 4 | 4 | 5 | 13 | 4.33 |
| 3.0 | 5 | 3 | 4 | 12 | 4.00 |
| 4.0 | 2 | 1 | 2 | 5 | 1.67 |

TABLE 87
Matcha ice cream: Evaluation score results of “preferability”
of “aroma” (n = 3)

| Additive amount of amino | Tester | | | Total | Average |
|---|---|---|---|---|---|
| acid composition [g] | a | b | c | [points] | [points] |
| 0.0 | 1 | 2 | 3 | 6 | 2.00 |
| 1.0 | 3 | 5 | 2 | 10 | 3.33 |
| 2.0 | 4 | 4 | 5 | 13 | 4.33 |
| 3.0 | 5 | 3 | 1 | 9 | 3.00 |
| 4.0 | 2 | 1 | 4 | 7 | 2.33 |

TABLE 88
Matcha ice cream: Evaluation score results of “strength”
of “richness” (n = 3)

| Additive amount of amino | Tester | | | Total | Average |
|---|---|---|---|---|---|
| acid composition [g] | a | b | c | [points] | [points] |
| 0.0 | 1 | 1 | 1 | 3 | 1.00 |
| 1.0 | 2 | 3 | 4 | 9 | 3.00 |
| 2.0 | 3 | 4 | 5 | 12 | 4.00 |
| 3.0 | 5 | 5 | 3 | 13 | 4.33 |
| 4.0 | 4 | 2 | 2 | 8 | 2.67 |

TABLE 89
Matcha ice cream: Evaluation score results of “preferability”
of “richness” (n = 3)

| Additive amount of amino | Tester | | | Total | Average |
|---|---|---|---|---|---|
| acid composition [g] | a | b | c | [points] | [points] |
| 0.0 | 1 | 1 | 1 | 3 | 1.00 |
| 1.0 | 4 | 3 | 4 | 11 | 3.67 |
| 2.0 | 5 | 4 | 5 | 14 | 4.67 |
| 3.0 | 2 | 5 | 2 | 9 | 3.00 |
| 4.0 | 3 | 2 | 3 | 8 | 2.67 |

TABLE 90
Matcha ice cream: Evaluation score results of “strength”
of “sweetness” (n = 3)

| Additive amount of amino | Tester | | | Total | Average |
|---|---|---|---|---|---|
| acid composition [g] | a | b | c | [points] | [points] |
| 0.0 | 4 | 5 | 5 | 14 | 4.67 |
| 1.0 | 5 | 3 | 4 | 12 | 4.00 |
| 2.0 | 2 | 2 | 3 | 7 | 2.33 |
| 3.0 | 1 | 1 | 2 | 4 | 1.33 |
| 4.0 | 3 | 4 | 1 | 8 | 2.67 |

TABLE 91
Matcha ice cream: Evaluation score results of “preferability”
of “sweetness” (n = 3)

| Additive amount of amino | Tester | | | Total | Average |
|---|---|---|---|---|---|
| acid composition [g] | a | b | c | [points] | [points] |
| 0.0 | 3 | 1 | 3 | 7 | 2.33 |
| 1.0 | 2 | 3 | 5 | 10 | 3.33 |
| 2.0 | 5 | 5 | 4 | 14 | 4.67 |
| 3.0 | 1 | 4 | 2 | 7 | 2.33 |
| 4.0 | 4 | 2 | 1 | 7 | 2.33 |

TABLE 92
Matcha ice cream: Evaluation score results of “strength”
of “flavor” (n = 3)

| Additive amount of amino | Tester | | | Total | Average |
|---|---|---|---|---|---|
| acid composition [g] | a | b | c | [points] | [points] |
| 0.0 | 1 | 2 | 1 | 4 | 1.33 |
| 1.0 | 4 | 4 | 3 | 11 | 3.67 |
| 2.0 | 5 | 1 | 4 | 10 | 3.33 |
| 3.0 | 3 | 5 | 5 | 13 | 4.33 |
| 4.0 | 2 | 3 | 2 | 7 | 2.33 |

TABLE 93
Matcha ice cream: Evaluation score results of “preferability”
of “flavor” (n = 3)

| Additive amount of amino | Tester | | | Total | Average |
|---|---|---|---|---|---|
| acid composition [g] | a | b | c | [points] | [points] |
| 0.0 | 1 | 2 | 1 | 4 | 1.33 |
| 1.0 | 4 | 4 | 3 | 11 | 3.67 |
| 2.0 | 5 | 1 | 4 | 10 | 3.33 |
| 3.0 | 3 | 5 | 5 | 13 | 4.33 |
| 4.0 | 2 | 3 | 2 | 7 | 2.33 |

TABLE 94
Matcha ice cream: Evaluation score results of “overall
evaluation” (n = 3)

| Additive amount of amino | Tester | | | Total | Average |
|---|---|---|---|---|---|
| acid composition [g] | a | b | c | [points] | [points] |
| 0.0 | 1 | 1 | 1 | 3 | 1.00 |
| 1.0 | 4 | 4 | 3 | 11 | 3.67 |
| 2.0 | 5 | 5 | 5 | 15 | 5.00 |
| 3.0 | 3 | 2 | 4 | 9 | 3.00 |
| 4.0 | 2 | 3 | 2 | 7 | 2.33 |

This amino acid composition adjusted the “strength” and “preferability” of “bitterness”, “aroma”, “richness”, “sweetness”, and “flavor” of matcha in matcha ice cream. In particular, the addition of 1.0 g, 2.0 g, 3.0 g, or 4.0 g of this amino acid composition relative to 12 g of powdered matcha enhanced the “strength” of “bitterness”, “aroma”, “richness”, and “flavor” of matcha in matcha ice cream as compared to the additive-free control (0 g), and the same trend was also demonstrated with regards to “preferability” thereof. This amino acid composition particularly enhanced the “strength” of “richness” of matcha in matcha ice cream. In terms of “overall evaluation”, the addition of 1.0 g, 2.0 g, 3.0 g, or 4.0 g of this amino acid composition relative to 12 g of powdered matcha gave an excellent evaluation result compared to a case in which the amino acid composition was not added (0 g).

### Example 10: Investigation of Additive Amount of Amino Acid Composition in Matcha Chocolate

### <Ingredients>

Used ingredients and sources thereof were as follows.
Powdered matcha: Powdered Tencha produced in Toyota (Yamauchi Yoshimasa) (Hekien Yamauchi Junpei Shoten)
White chocolate produced in Malaysia (cacao content: 28%):
   Raw ingredients: Sugar (produced in Malaysia), cacao butter, full-fat milk powder, skimmed milk powder/emulsifier (soybean origin), fragrance
   Country of origin: Malaysia
   Nutritional information (per 100 g): Energy 562 kcal, protein 8.0 g, fat 34.0 g, carbohydrate 54.0 g, sodium chloride equivalents 0.2 g
   Manufacturer: Beryl's Chocolate and Confectionery
   Importer: Marubishi Holdings
Amino acid composition (L-valine, L-leucine, L-isoleucine, and sodium L-aspartate)

TABLE 95
Make-up of amino acid composition

| | | Blending ratio |
|---|---|---|
| Amino acid components | Parts by mass | [%] |
| L-Leucine | 504 | 56.0 |
| L-Isoleucine | 144 | 16.0 |
| L-Valine | 144 | 16.0 |
| Sodium L-aspartate | 108 | 12.0 |
| Total | 900 | 100.0 |

### <Preparation Method>

1. 100 g of white chocolate was weighed into a bowl and was warmed by immersion in warm water adjusted to 55° C. In a case in which the amino acid composition was to be added, a specific amount thereof was added at this time.
2. Once the chocolate had completely melted, 16 g of powdered matcha was loaded into a tea strainer and was sifted while being added.
3. A rubber spatula was used to perform mixing until the matcha was uniformly mixed.
4. The mixture was poured into an ice tray (long side 26 cm×short side 13 cm×height 3.5 cm) and was cooled and solidified overnight in a-21° C. freezer.

TABLE 96
Contents of amino acid composition and powdered
matcha in matcha chocolate specimens

| Matcha | | | |
|---|---|---|---|
| chocolate | Amino acid | Powdered | Matcha chocolate |
| specimen | composition | matcha | (final mass) |
| name | [g parts by mass] | [g parts by mass] | [g parts by mass] |
| Control | 0 | 16 | 116 |
| Sample 1 | 2.5 | 16 | 116 |
| Sample 2 | 5.0 | 16 | 116 |
| Sample 3 | 7.5 | 16 | 116 |
| Sample 4 | 10.0 | 16 | 116 |

### <Test Method>

Five types of matcha chocolate specimens that had been prepared, inclusive of a control, were randomly assigned the letters A to E as specimen names in order that the testers would not know the additive amount of the amino acid composition in each thereof. The testers tasted each of these matcha chocolate specimens and gave a scored evaluation for a total of five parameters (“bitterness”, “aroma”, “richness”, “sweetness”, and “flavor”) from viewpoints of “strength” and “preferability” thereof, and also from a viewpoint of “overall evaluation” taking into account texture, appearance, and so forth in addition to taste.

### <Scored Evaluation>

With regards to the “strength” of “bitterness”, “aroma”, “richness”, “sweetness”, and “flavor”, the five types of matcha chocolate specimens, inclusive of the control, were ranked in order from 1^{st} to 5^{th} for the “strength” of each evaluation parameter, and then the specimen ranked strongest (1^{st}) was allotted 5 points, the specimen ranked 2^{nd} strongest was allotted 4 points, the specimen ranked 3^{rd} strongest was allotted 3 points, the specimen ranked 4^{th} strongest was allotted 2 points, and the specimen ranked 5^{th} strongest was allotted 1 point. Averages were calculated from the evaluations scores of testers a, b, c, and d, and these averages were compared.

With regards to the “preferability” of “bitterness”, “aroma”, “richness”, “sweetness”, and “flavor” and “overall evaluation” taking into account texture, appearance, and so forth in addition to taste, the five types of matcha chocolate specimens, inclusive of the control, were ranked in order from 1^{st} to 5^{th} for the “preferability” of each evaluation parameter, and then the specimen ranked most preferable (1^{st}) was allotted 5 points, the specimen ranked 2^{nd} most preferable was allotted 4 points, the specimen ranked 3^{rd} most preferable was allotted 3 points, the specimen ranked 4^{th} most preferable was allotted 2 points, and the specimen ranked 5^{th} most preferable was allotted 1 point. Averages were calculated from the evaluations scores of testers a, b, c, and d, and these averages were compared.

### <Results>

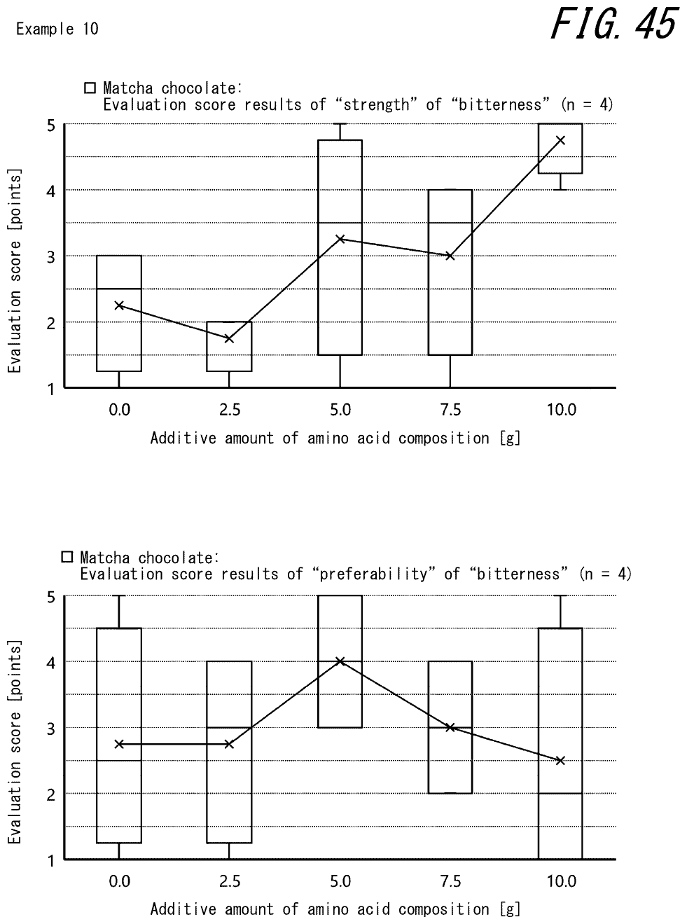

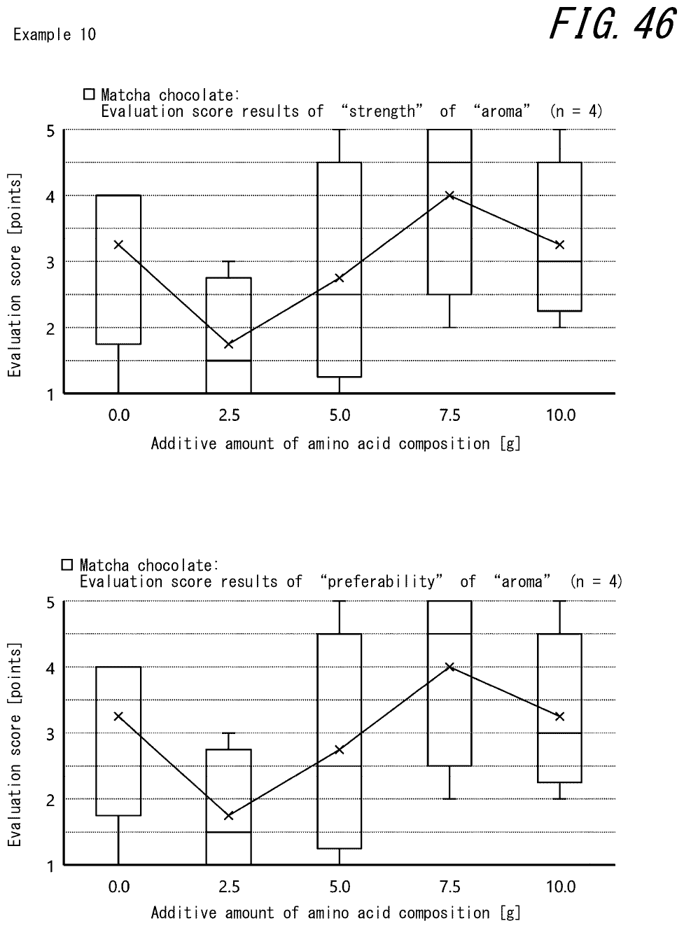

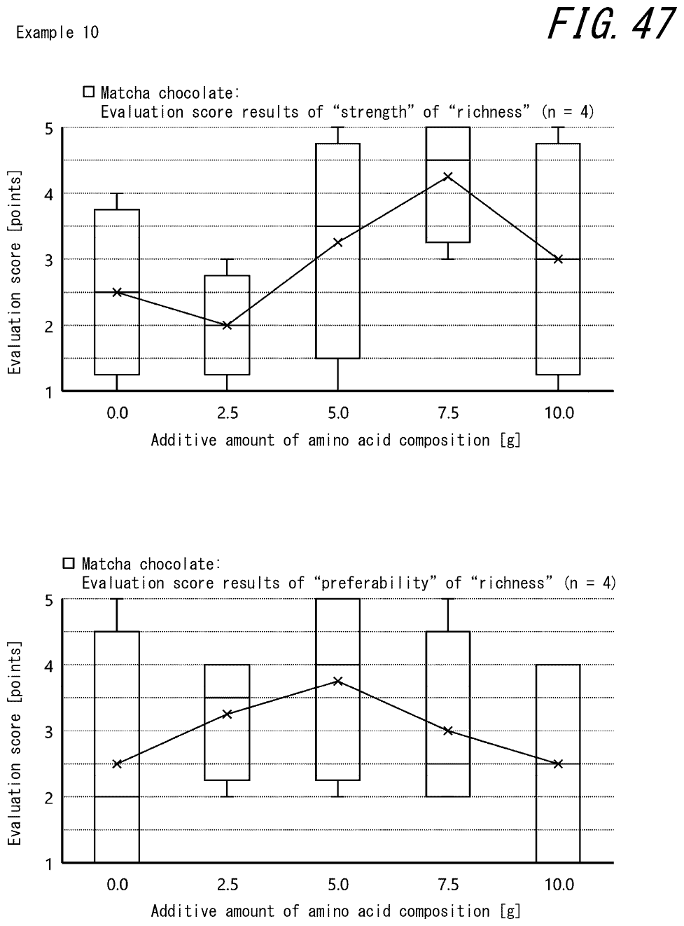

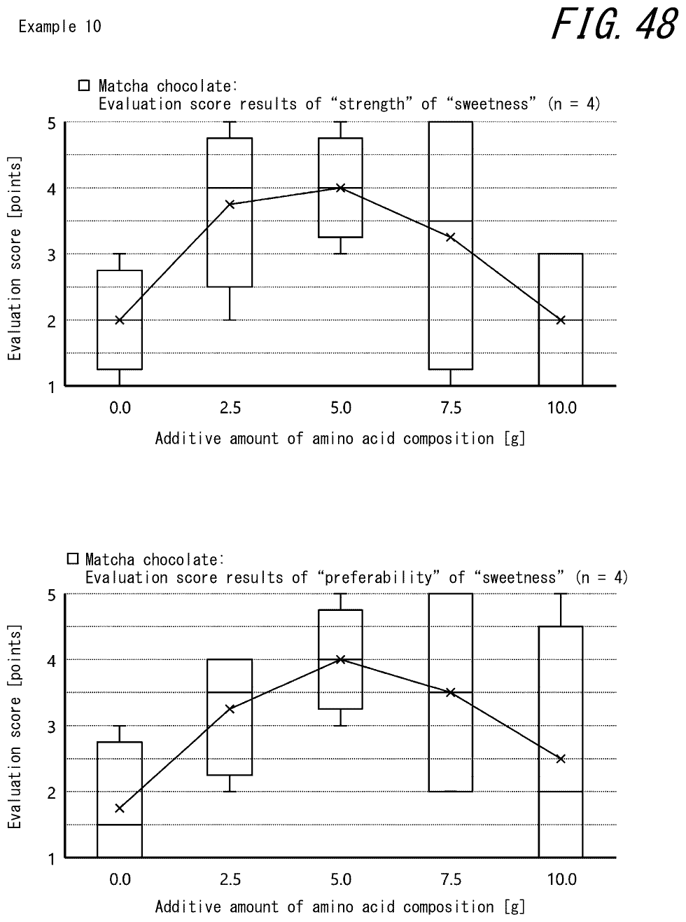

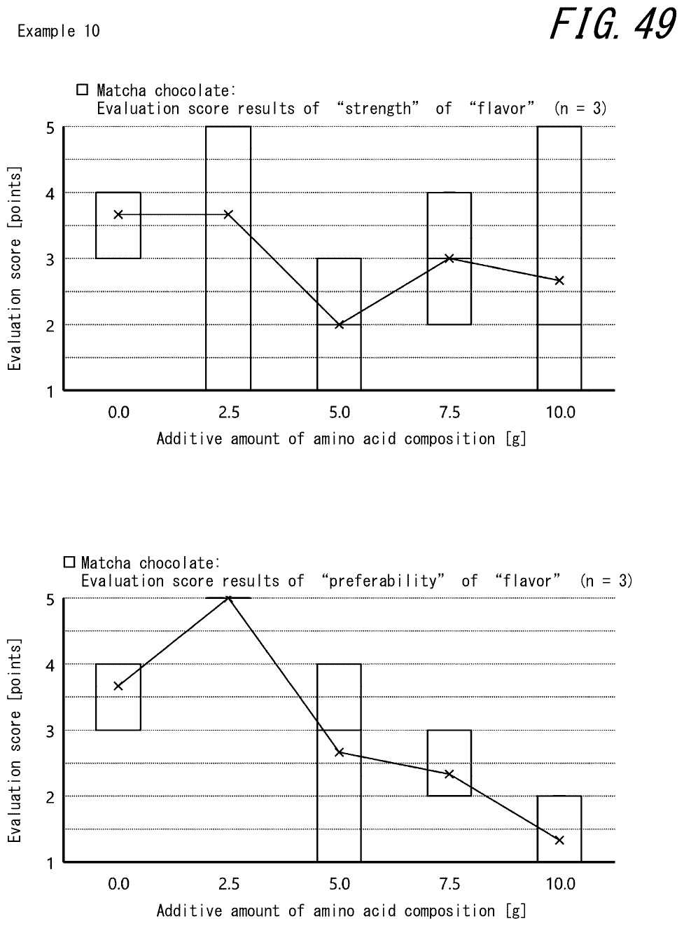

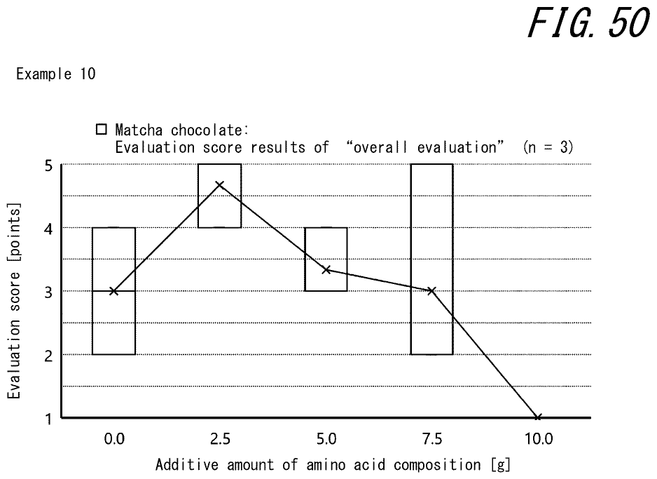

Evaluation score results and averages thereof in this example are presented in the following Tables 97 to 107 and in FIGS. 45 to 50.

TABLE 97
Matcha chocolate: Evaluation score results of “strength”
of “bitterness” (n = 4)

| Additive amount of amino | Tester | | | | Total | Average |
|---|---|---|---|---|---|---|
| acid composition [g] | a | b | c | d | [points] | [points] |
| 0.0 | 1 | 2 | 3 | 3 | 9 | 2.25 |
| 2.5 | 2 | 1 | 2 | 2 | 7 | 1.75 |
| 5.0 | 3 | 4 | 1 | 5 | 13 | 3.25 |
| 7.5 | 4 | 3 | 4 | 1 | 12 | 3.00 |
| 10.0 | 5 | 5 | 5 | 4 | 19 | 4.75 |

TABLE 98
Matcha chocolate: Evaluation score results of “preferability”
of “bitterness” (n = 4)

| Additive amount of amino | Tester | | | | Total | Average |
|---|---|---|---|---|---|---|
| acid composition [g] | a | b | c | d | [points] | [points] |
| 0.0 | 1 | 2 | 3 | 5 | 11 | 2.75 |
| 2.5 | 2 | 1 | 4 | 4 | 11 | 2.75 |
| 5.0 | 3 | 5 | 5 | 3 | 16 | 4.00 |
| 7.5 | 4 | 4 | 2 | 2 | 12 | 3.00 |
| 10.0 | 5 | 3 | 1 | 1 | 10 | 2.50 |

TABLE 99
Matcha chocolate: Evaluation score results of “strength”
of “aroma” (n = 4)

| Additive amount of amino | Tester | | | | Total | Average |
|---|---|---|---|---|---|---|
| acid composition [g] | a | b | c | d | [points] | [points] |
| 0.0 | 4 | 4 | 4 | 1 | 13 | 3.25 |
| 2.5 | 3 | 1 | 1 | 2 | 7 | 1.75 |
| 5.0 | 1 | 2 | 5 | 3 | 11 | 2.75 |
| 7.5 | 5 | 5 | 2 | 4 | 16 | 4.00 |
| 10.0 | 2 | 3 | 3 | 5 | 13 | 3.25 |

TABLE 100
Matcha chocolate: Evaluation score results of “preferability”
of “aroma” (n = 4)

| Additive amount of amino | Tester | | | | Total | Average |
|---|---|---|---|---|---|---|
| acid composition [g] | a | b | c | d | [points] | [points] |
| 0.0 | 4 | 4 | 4 | 1 | 13 | 3.25 |
| 2.5 | 3 | 1 | 1 | 2 | 7 | 1.75 |
| 5.0 | 1 | 2 | 5 | 3 | 11 | 2.75 |
| 7.5 | 5 | 5 | 2 | 4 | 16 | 4.00 |
| 10.0 | 2 | 3 | 3 | 5 | 13 | 3.25 |

TABLE 101
Matcha chocolate: Evaluation score results of “strength”
of “richness” (n = 4)

| Additive amount of amino | Tester | | | | Total | Average |
|---|---|---|---|---|---|---|
| acid composition [g] | a | b | c | d | [points] | [points] |
| 0.0 | 1 | 4 | 3 | 2 | 10 | 2.50 |
| 2.5 | 2 | 1 | 2 | 3 | 8 | 2.00 |
| 5.0 | 3 | 5 | 1 | 4 | 13 | 3.25 |
| 7.5 | 5 | 3 | 4 | 5 | 17 | 4.25 |
| 10.0 | 4 | 2 | 5 | 1 | 12 | 3.00 |

TABLE 102
Matcha chocolate: Evaluation score results of “preferability”
of “richness” (n = 4)

| Additive amount of amino | Tester | | | | Total | Average |
|---|---|---|---|---|---|---|
| acid composition [g] | a | b | c | d | [points] | [points] |
| 0.0 | 1 | 1 | 3 | 5 | 10 | 2.50 |
| 2.5 | 2 | 3 | 4 | 4 | 13 | 3.25 |
| 5.0 | 3 | 5 | 5 | 2 | 15 | 3.75 |
| 7.5 | 5 | 2 | 2 | 3 | 12 | 3.00 |
| 10.0 | 4 | 4 | 1 | 1 | 10 | 2.50 |

TABLE 103
Matcha chocolate: Evaluation score results of “strength”
of “sweetness” (n = 4)

| Additive amount of amino | Tester | | | | Total | Average |
|---|---|---|---|---|---|---|
| acid composition [g] | a | b | c | d | [points] | [points] |
| 0.0 | 1 | 2 | 3 | 2 | 8 | 2.00 |
| 2.5 | 2 | 5 | 4 | 4 | 15 | 3.75 |
| 5.0 | 4 | 4 | 5 | 3 | 16 | 4.00 |
| 7.5 | 5 | 1 | 2 | 5 | 13 | 3.25 |
| 10.0 | 3 | 3 | 1 | 1 | 8 | 2.00 |

TABLE 104
Matcha chocolate: Evaluation score results of “preferability”
of “sweetness” (n = 4)

| Additive amount of amino | Tester | | | | Total | Average |
|---|---|---|---|---|---|---|
| acid composition [g] | a | b | c | d | [points] | [points] |
| 0.0 | 1 | 1 | 3 | 2 | 7 | 1.75 |
| 2.5 | 2 | 3 | 4 | 4 | 13 | 3.25 |
| 5.0 | 4 | 4 | 5 | 3 | 16 | 4.00 |
| 7.5 | 5 | 2 | 2 | 5 | 14 | 3.50 |
| 10.0 | 3 | 5 | 1 | 1 | 10 | 2.50 |

TABLE 105
Matcha chocolate: Evaluation score results of “strength”
of “flavor” (n = 3)

| Additive amount of amino | Tester | | | | Total | Average |
|---|---|---|---|---|---|---|
| acid composition [g] | a | b | c | d | [points] | [points] |
| 0.0 | 4 | 4 | 3 | — | 11 | 3.67 |
| 2.5 | 5 | 5 | 1 | — | 11 | 3.67 |
| 5.0 | 3 | 1 | 2 | — | 6 | 2.00 |
| 7.5 | 2 | 3 | 4 | — | 9 | 3.00 |
| 10.0 | 1 | 2 | 5 | — | 8 | 2.67 |

TABLE 106
Matcha chocolate: Evaluation score results of “preferability”
of “flavor” (n = 3)

| Additive amount of amino | Tester | | | | Total | Average |
|---|---|---|---|---|---|---|
| acid composition [g] | a | b | c | d | [points] | [points] |
| 0.0 | 4 | 4 | 3 | — | 11 | 3.67 |
| 2.5 | 5 | 5 | 5 | — | 15 | 5.00 |
| 5.0 | 3 | 1 | 4 | — | 8 | 2.67 |
| 7.5 | 2 | 3 | 2 | — | 7 | 2.33 |
| 10.0 | 1 | 2 | 1 | — | 4 | 1.33 |

TABLE 107
Matcha chocolate: Evaluation score results of “overall
evaluation” (n = 3)

| Additive amount of amino | Tester | | | | Total | Average |
|---|---|---|---|---|---|---|
| acid composition [g] | a | b | c | d | [points] | [points] |
| 0.0 | 4 | 2 | 3 | — | 9 | 3.00 |
| 2.5 | 5 | 4 | 5 | — | 14 | 4.67 |
| 5.0 | 3 | 3 | 4 | — | 10 | 3.33 |
| 7.5 | 2 | 5 | 2 | — | 9 | 3.00 |
| 10.0 | 1 | 1 | 1 | — | 3 | 1.00 |

This amino acid composition adjusted the “strength” and “preferability” of “bitterness”, “aroma”, “richness”, “sweetness”, and “flavor” of matcha in matcha chocolate. In particular, the addition of 2.5 g, 5.0 g, 7.5 g, or 10.0 g of this amino acid composition relative to 16 g of powdered matcha enhanced the “strength” of “bitterness”, “aroma”, “richness”, and “sweetness” of matcha in matcha chocolate as compared to the additive-free control (0 g), and the same trend was also demonstrated with regards to “preferability” thereof. This amino acid composition particularly enhanced the “strength” of “richness” of matcha in matcha chocolate. In terms of “overall evaluation”, the addition of 2.5 g, 5.0 g, or 7.5 g of this amino acid composition relative to 16 g of powdered matcha gave an equal or superior evaluation result compared to a case in which the amino acid composition was not added (0 g).

The present disclosure can be adopted in the food and beverage industry, the food service industry, and so forth where the production, provision, sale, or the like of a matcha food or beverage and/or a matcha richness enhancer that enhances the richness of matcha in a matcha food or beverage is carried out.

The following provides an appendix in which illustrative disclosed matter is presented in an itemized manner and in which advantageous effects thereof are also described.

### [Article 1]

A matcha richness enhancer that enhances the richness of matcha in a matcha food or beverage, wherein
the matcha richness enhancer contains leucine.

This matcha richness enhancer enhances the richness of matcha in a matcha food or beverage. Moreover, through this matcha richness enhancer, a matcha food or beverage that has health promoting effects from a physical perspective and a mental perspective can be further made into a matcha food or beverage that also has a beneficial effect on muscle.

### [Article 2]

The matcha richness enhancer that enhances the richness of matcha in a matcha food or beverage according to Article 1, wherein
the matcha richness enhancer further contains an aspartic acid salt.

This matcha richness enhancer enhances the richness of matcha in a matcha food or beverage. Moreover, through this matcha richness enhancer, a matcha food or beverage that has health promoting effects from a physical perspective and a mental perspective can be further made into a matcha food or beverage that also has a beneficial effect on muscle.

### [Article 3]

The matcha richness enhancer that enhances the richness of matcha in a matcha food or beverage according to Article 2, wherein
the matcha richness enhancer further contains isoleucine and valine.

This matcha richness enhancer enhances the richness of matcha in a matcha food or beverage. Moreover, through this matcha richness enhancer, a matcha food or beverage that has health promoting effects from a physical perspective and a mental perspective can be further made into a matcha food or beverage that also has a beneficial effect on muscle.

### [Article 4]

The matcha richness enhancer that enhances the richness of matcha in a matcha food or beverage according to Article 3, wherein
the matcha richness enhancer is further used in order to prevent deterioration of the richness and/or flavor of matcha in the matcha food or beverage.

This matcha richness enhancer enhances the richness of matcha in a matcha food or beverage. Moreover, this matcha richness enhancer can prevent deterioration over time of the richness and flavor of matcha in a matcha food or beverage. Furthermore, through this matcha richness enhancer, a matcha food or beverage that has health promoting effects from a physical perspective and a mental perspective can be further made into a matcha food or beverage that also has a beneficial effect on muscle.

### [Article 5]

The matcha richness enhancer that enhances the richness of matcha in a matcha food or beverage according to Article 2, wherein
the matcha richness enhancer contains leucine and an aspartic acid salt such that parts by mass of the leucine: parts by mass of the aspartic acid salt is a blending ratio within a range of 76 to 94:6 to 24.

This matcha richness enhancer enhances the richness of matcha in a matcha food or beverage. Moreover, through this matcha richness enhancer, a matcha food or beverage that has health promoting effects from a physical perspective and a mental perspective can be further made into a matcha food or beverage that also has a beneficial effect on muscle.

### [Article 6]

The matcha richness enhancer that enhances the richness of matcha in a matcha food or beverage according to Article 4, wherein
the matcha richness enhancer contains leucine, isoleucine, valine, and an aspartic acid salt such that total parts by mass of the leucine, the isoleucine, and the valine: parts by mass of the aspartic acid salt is a blending ratio within a range of 76 to 94:6 to 24.

This matcha richness enhancer enhances the richness of matcha in a matcha food or beverage. Moreover, this matcha richness enhancer can prevent deterioration over time of the richness and flavor of matcha in a matcha food or beverage. Furthermore, through this matcha richness enhancer, a matcha food or beverage that has health promoting effects from a physical perspective and a mental perspective can be further made into a matcha food or beverage that also has a beneficial effect on muscle.

### [Article 7]

The matcha richness enhancer that enhances the richness of matcha in a matcha food or beverage according to Article 6, wherein
the matcha richness enhancer contains leucine, isoleucine, and valine such that parts by mass of the leucine: parts by mass of the isoleucine: parts by mass of the valine is a blending ratio within a range of 40 to 64:6 to 24:6 to 24.

This matcha richness enhancer enhances the richness of matcha in a matcha food or beverage. Moreover, this matcha richness enhancer can prevent deterioration over time of the richness and flavor of matcha in a matcha food or beverage. Furthermore, through this matcha richness enhancer, a matcha food or beverage that has health promoting effects from a physical perspective and a mental perspective can be further made into a matcha food or beverage that also has a beneficial effect on muscle.

### [Article 8]

The matcha richness enhancer that enhances the richness of matcha in a matcha food or beverage according to any one of Articles 1 to 7, wherein
the matcha food or beverage is a powdered matcha product.

This matcha richness enhancer enhances the richness of matcha in a powdered matcha product. Moreover, this matcha richness enhancer enhances the richness of matcha in a matcha food or beverage that is produced/provided using a powdered matcha product containing the matcha richness enhancer. Furthermore, this matcha richness enhancer can prevent deterioration over time of the richness and flavor of matcha in a powdered matcha product containing the matcha richness enhancer. Also, this matcha richness enhancer can prevent deterioration over time of the richness and flavor of matcha in a matcha food or beverage that is produced/provided using a powdered matcha product containing the matcha richness enhancer. Moreover, through this matcha richness enhancer, a powdered matcha product that has health promoting effects from a physical perspective and a mental perspective can be further made into a powdered matcha product that also has a beneficial effect on muscle. Furthermore, through this matcha richness enhancer, a matcha food or beverage that is produced/provided using a powdered matcha product containing the matcha richness enhancer and that has health promoting effects from a physical perspective and a mental perspective can be further made into a matcha food or beverage that also has a beneficial effect on muscle.

### [Article 9]

The matcha richness enhancer that enhances the richness of matcha in a matcha food or beverage according to Article 8, wherein
the matcha richness enhancer is for blending such that parts by mass of powdered matcha: parts by mass of the matcha richness enhancer in the powdered matcha product is a blending ratio within a range of 1,000:33 to 334.

This matcha richness enhancer enhances the richness of matcha in a powdered matcha product. Moreover, this matcha richness enhancer enhances the richness of matcha in a matcha food or beverage that is produced/provided using a powdered matcha product containing the matcha richness enhancer. Furthermore, this matcha richness enhancer can prevent deterioration over time of the richness and flavor of matcha in a powdered matcha product containing the matcha richness enhancer. Also, this matcha richness enhancer can prevent deterioration over time of the richness and flavor of matcha in a matcha food or beverage that is produced/provided using a powdered matcha product containing the matcha richness enhancer. Moreover, through this matcha richness enhancer, a powdered matcha product that has health promoting effects from a physical perspective and a mental perspective can be further made into a powdered matcha product that also has a beneficial effect on muscle. Furthermore, through this matcha richness enhancer, a matcha food or beverage that is produced/provided using a powdered matcha product containing the matcha richness enhancer and that has health promoting effects from a physical perspective and a mental perspective can be further made into a matcha food or beverage that also has a beneficial effect on muscle.

### [Article 10]

A powdered matcha product containing the matcha richness enhancer that enhances the richness of matcha in a matcha food or beverage according to any one of Articles 1 to 7.

The richness of matcha in this powdered matcha product is enhanced. Moreover, this powdered matcha product enhances the richness of matcha in a matcha food or beverage that is produced/provided using the powdered matcha product. Furthermore, deterioration over time of the richness and flavor of matcha in this powdered matcha product is prevented. Also, deterioration over time of the richness and flavor of matcha in a matcha food or beverage that is produced/provided using the powdered matcha product is prevented. Moreover, this powdered matcha product both has health promoting effects from a physical perspective and a mental perspective and also has a beneficial effect on muscle. Furthermore, through this powdered matcha product, a matcha food or beverage that is produced/provided using the powdered matcha product can be made into a matcha food or beverage that both has health promoting effects from a physical perspective and a mental perspective and also has a beneficial effect on muscle.

### [Article 11]

The powdered matcha product according to Article 10, wherein
the powdered matcha product contains powdered matcha and the matcha richness enhancer such that parts by mass of the powdered matcha: parts by mass of the matcha richness enhancer is a blending ratio within a range of 1,000:33 to 334.

The richness of matcha in this powdered matcha product is enhanced. Moreover, this powdered matcha product enhances the richness of matcha in a matcha food or beverage that is produced/provided using the powdered matcha product. Furthermore, deterioration over time of the richness and flavor of matcha in this powdered matcha product is prevented. Also, deterioration over time of the richness and flavor of matcha in a matcha food or beverage that is produced/provided using the powdered matcha product is prevented. Moreover, this powdered matcha product both has health promoting effects from a physical perspective and a mental perspective and also has a beneficial effect on muscle. Furthermore, through this powdered matcha product, a matcha food or beverage that is produced/provided using the powdered matcha product can be made into a matcha food or beverage that both has health promoting effects from a physical perspective and a mental perspective and also has a beneficial effect on muscle.

### [Article 12]

The matcha richness enhancer that enhances the richness of matcha in a matcha food or beverage according to any one of Articles 1 to 7, wherein
the matcha food or beverage is a matcha beverage.

This matcha richness enhancer enhances the richness of matcha in a matcha beverage. Moreover, this matcha richness enhancer can prevent deterioration over time of the richness and flavor of matcha in a matcha beverage that contains the matcha richness enhancer. Furthermore, through this matcha richness enhancer, a matcha beverage that has health promoting effects from a physical perspective and a mental perspective can be further made into a matcha beverage that also has a beneficial effect on muscle.

### [Article 13]

The matcha richness enhancer that enhances the richness of matcha in a matcha food or beverage according to Article 12, wherein
the matcha richness enhancer is for blending such that parts by mass of powdered matcha: parts by mass of the matcha richness enhancer in the matcha beverage is a blending ratio within a range of 1,000:33 to 334.

This matcha richness enhancer enhances the richness of matcha in a matcha beverage. Moreover, this matcha richness enhancer can prevent deterioration over time of the richness and flavor of matcha in a matcha beverage that contains the matcha richness enhancer. Furthermore, through this matcha richness enhancer, a matcha beverage that has health promoting effects from a physical perspective and a mental perspective can be further made into a matcha beverage that also has a beneficial effect on muscle.

### [Article 14]

A matcha beverage containing the matcha richness enhancer that enhances the richness of matcha in a matcha food or beverage according to any one of Articles 1 to 7.

The richness of matcha in this matcha beverage is enhanced. Moreover, deterioration over time of the richness and flavor of matcha in this matcha beverage is prevented. Furthermore, this matcha beverage both has health promoting effects from a physical perspective and a mental perspective and also has a beneficial effect on muscle.

### [Article 15]

The matcha beverage according to Article 14, wherein
the matcha beverage contains powdered matcha and the matcha richness enhancer that enhances the richness of matcha in a matcha food or beverage such that parts by mass of the powdered matcha: parts by mass of the matcha richness enhancer is a blending ratio within a range of 1,000:33 to 334.

The richness of matcha in this matcha beverage is enhanced. Moreover, deterioration over time of the richness and flavor of matcha in this matcha beverage is prevented. Furthermore, this matcha beverage both has health promoting effects from a physical perspective and a mental perspective and also has a beneficial effect on muscle.

### [Item 1]

A matcha richness enhancer that enhances the richness of matcha in a matcha food or beverage, wherein
the matcha food or beverage is selected from the group consisting of a matcha candy, a matcha baked sweet, matcha ice cream, and matcha chocolate, and
the matcha richness enhancer contains leucine.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 2]

The matcha richness enhancer that enhances the richness of matcha in a matcha food or beverage according to Item 1, wherein
the matcha richness enhancer further contains an aspartic acid salt.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 3]

The matcha richness enhancer that enhances the richness of matcha in a matcha food or beverage according to Item 2, wherein
the matcha richness enhancer further contains isoleucine and valine.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 4]

The matcha richness enhancer that enhances the richness of matcha in a matcha food or beverage according to Item 2, wherein
the matcha richness enhancer contains leucine and an aspartic acid salt such that parts by mass of the leucine: parts by mass of the aspartic acid salt is a blending ratio within a range of 76 to 94:6 to 24.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 5]

The matcha richness enhancer that enhances the richness of matcha in a matcha food or beverage according to Item 3, wherein
the matcha richness enhancer contains leucine, isoleucine, valine, and an aspartic acid salt such that total parts by mass of the leucine, the isoleucine, and the valine: parts by mass of the aspartic acid salt is a blending ratio within a range of 76 to 94:6 to 24.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 6]

The matcha richness enhancer that enhances the richness of matcha in a matcha food or beverage according to Item 5, wherein
the matcha richness enhancer contains leucine, isoleucine, and valine such that parts by mass of the leucine: parts by mass of the isoleucine: parts by mass of the valine is a blending ratio within a range of 40 to 64:6 to 24:6 to 24.

This matcha richness enhancer enhances the richness of matcha in a matcha candy, a matcha baked sweet, matcha ice cream, and/or matcha chocolate. Moreover, through this matcha richness enhancer, a matcha candy, a matcha baked sweet, matcha ice cream, and/or matcha chocolate that has health promoting effects from a physical perspective and a mental perspective can be further made into a matcha candy, a matcha baked sweet, matcha ice cream, and/or matcha chocolate that also has a beneficial effect on muscle.

### [Item 7]

The matcha richness enhancer that enhances the richness of matcha in a matcha food or beverage according to any one of Items 1 to 6, wherein
the matcha food or beverage is a matcha candy.

This matcha richness enhancer enhances the richness of matcha in a matcha candy. Moreover, through this matcha richness enhancer, a matcha candy that has health promoting effects from a physical perspective and a mental perspective can be further made into a matcha candy that also has a beneficial effect on muscle.

### [Item 8]

The matcha richness enhancer that enhances the richness of matcha in a matcha food or beverage according to Item 7, wherein
the matcha richness enhancer is for blending such that parts by mass of powdered matcha: parts by mass of the matcha richness enhancer in the matcha candy is a blending ratio within a range of 75 to 46:10 to 39.

This matcha richness enhancer enhances the richness of matcha in a matcha candy. Moreover, through this matcha richness enhancer, a matcha candy that has health promoting effects from a physical perspective and a mental perspective can be further made into a matcha candy that also has a beneficial effect on muscle.

### [Item 9]

A matcha candy containing the matcha richness enhancer that enhances the richness of matcha in a matcha food or beverage according to any one of

### Items 1 to 6.

The richness of matcha in this matcha candy is enhanced. Moreover, this matcha candy both has health promoting effects from a physical perspective and a mental perspective and also has a beneficial effect on muscle.

### [Item 10]

The matcha candy according to Item 9, wherein
the matcha candy contains powdered matcha and the matcha richness enhancer that enhances the richness of matcha in a matcha food or beverage such that parts by mass of the powdered matcha: parts by mass of the matcha richness enhancer is a blending ratio within a range of 75 to 46:10 to 39.

The richness of matcha in this matcha candy is enhanced. Moreover, this matcha candy both has health promoting effects from a physical perspective and a mental perspective and also has a beneficial effect on muscle.

### [Item 11]

The matcha richness enhancer that enhances the richness of matcha in a matcha food or beverage according to any one of Items 1 to 6, wherein
the matcha food or beverage is a matcha baked sweet.

This matcha richness enhancer enhances the richness of matcha in a matcha baked sweet. Moreover, through this matcha richness enhancer, a matcha baked sweet that has health promoting effects from a physical perspective and a mental perspective can be further made into a matcha baked sweet that also has a beneficial effect on muscle.

### [Item 12]

The matcha richness enhancer that enhances the richness of matcha in a matcha food or beverage according to Item 11, wherein
the matcha richness enhancer is for blending such that parts by mass of powdered matcha: parts by mass of the matcha richness enhancer in the matcha baked sweet is a blending ratio within a range of 1.25:0.5 to 3.

This matcha richness enhancer enhances the richness of matcha in a matcha baked sweet. Moreover, through this matcha richness enhancer, a matcha baked sweet that has health promoting effects from a physical perspective and a mental perspective can be further made into a matcha baked sweet that also has a beneficial effect on muscle.

### [Item 13]

A matcha baked sweet containing the matcha richness enhancer that enhances the richness of matcha in a matcha food or beverage according to any one of Items 1 to 6.

The richness of matcha in this matcha baked sweet is enhanced. Moreover, this matcha baked sweet both has health promoting effects from a physical perspective and a mental perspective and also has a beneficial effect on muscle.

### [Item 14]

The matcha baked sweet according to Item 13, wherein
the matcha baked sweet contains powdered matcha and the matcha richness enhancer that enhances the richness of matcha in a matcha food or beverage such that parts by mass of the powdered matcha: parts by mass of the matcha richness enhancer is a blending ratio within a range of 1.25:0.5 to 3.

The richness of matcha in this matcha baked sweet is enhanced. Moreover, this matcha baked sweet both has health promoting effects from a physical perspective and a mental perspective and also has a beneficial effect on muscle.

### [Item 15]

The matcha richness enhancer that enhances the richness of matcha in a matcha food or beverage according to any one of Items 1 to 6, wherein
the matcha food or beverage is matcha ice cream.

This matcha richness enhancer enhances the richness of matcha in matcha ice cream. Moreover, through this matcha richness enhancer, matcha ice cream that has health promoting effects from a physical perspective and a mental perspective can be further made into matcha ice cream that also has a beneficial effect on muscle.

### [Item 16]

The matcha richness enhancer that enhances the richness of matcha in a matcha food or beverage according to Item 15, wherein
the matcha richness enhancer is for blending such that parts by mass of powdered matcha: parts by mass of the matcha richness enhancer in the matcha ice cream is a blending ratio within a range of 12:0.5 to 4.

This matcha richness enhancer enhances the richness of matcha in matcha ice cream. Moreover, through this matcha richness enhancer, matcha ice cream that has health promoting effects from a physical perspective and a mental perspective can be further made into matcha ice cream that also has a beneficial effect on muscle.

### [Item 17]

Matcha ice cream containing the matcha richness enhancer that enhances the richness of matcha in a matcha food or beverage according to any one of Items 1 to 6.

The richness of matcha in this matcha ice cream is enhanced. Moreover, this matcha ice cream both has health promoting effects from a physical perspective and a mental perspective and also has a beneficial effect on muscle.

### [Item 18]

The matcha ice cream according to Item 17, wherein
the matcha ice cream contains powdered matcha and the matcha richness enhancer that enhances the richness of matcha in a matcha food or beverage such that parts by mass of the powdered matcha: parts by mass of the matcha richness enhancer is a blending ratio within a range of 12:0.5 to 4.

The richness of matcha in this matcha ice cream is enhanced. Moreover, this matcha ice cream both has health promoting effects from a physical perspective and a mental perspective and also has a beneficial effect on muscle.

### [Item 19]

The matcha richness enhancer that enhances the richness of matcha in a matcha food or beverage according to any one of Items 1 to 6, wherein
the matcha food or beverage is matcha chocolate.

This matcha richness enhancer enhances the richness of matcha in matcha chocolate. Moreover, through this matcha richness enhancer, matcha chocolate that has health promoting effects from a physical perspective and a mental perspective can be further made into matcha chocolate that also has a beneficial effect on muscle.

### [Item 20]

The matcha richness enhancer that enhances the richness of matcha in a matcha food or beverage according to Item 19, wherein
the matcha richness enhancer is for blending such that parts by mass of powdered matcha: parts by mass of the matcha richness enhancer in the matcha chocolate is a blending ratio within a range of 16:3.7 to 10.

This matcha richness enhancer enhances the richness of matcha in matcha chocolate. Moreover, through this matcha richness enhancer, matcha chocolate that has health promoting effects from a physical perspective and a mental perspective can be further made into matcha chocolate that also has a beneficial effect on muscle.

### [Item 21]

Matcha chocolate containing the matcha richness enhancer that enhances the richness of matcha in a matcha food or beverage according to any one of Items 1 to 6.

The richness of matcha in this matcha chocolate is enhanced. Moreover, this matcha chocolate both has health promoting effects from a physical perspective and a mental perspective and also has a beneficial effect on muscle.

### [Item 22]

The matcha chocolate according to Item 21, wherein
the matcha chocolate contains powdered matcha and the matcha richness enhancer that enhances the richness of matcha in a matcha food or beverage such that parts by mass of the powdered matcha: parts by mass of the matcha richness enhancer is a blending ratio within a range of 16:3.7 to 10.

The richness of matcha in this matcha chocolate is enhanced. Moreover, this matcha chocolate both has health promoting effects from a physical perspective and a mental perspective and also has a beneficial effect on muscle.

1. A matcha richness enhancer comprising leucine and an aspartic acid salt, wherein
parts by mass of the leucine: parts by mass of the aspartic acid salt is a blending ratio within a range of 76 to 94:6 to 24.

2. A matcha richness enhancer comprising leucine, isoleucine, valine, and an aspartic acid salt, wherein
total parts by mass of the leucine, the isoleucine, and the valine: parts by mass of the aspartic acid salt is a blending ratio within a range of 76 to 94:6 to 24.

3. The matcha richness enhancer according to claim 2, wherein
the matcha richness enhancer contains the leucine, the isoleucine, and the valine such that parts by mass of the leucine: parts by mass of the isoleucine: parts by mass of the valine is a blending ratio within a range of 40 to 64:6 to 24:6 to 24.

4. A matcha food or beverage comprising the matcha richness enhancer according to claim 1.

5. A matcha food or beverage comprising the matcha richness enhancer according to claim 2.

6. The matcha food or beverage according to claim 4, wherein
the matcha food or beverage is a powdered matcha product, and parts by mass of powdered matcha: parts by mass of the matcha richness enhancer in the powdered matcha product is a blending ratio within a range of 1,000:33 to 334.

7. The matcha food or beverage according to claim 5, wherein
the matcha food or beverage is a powdered matcha product, and parts by mass of powdered matcha: parts by mass of the matcha richness enhancer in the powdered matcha product is a blending ratio within a range of 1,000:33 to 334.

8. The matcha food or beverage according to claim 4, wherein
the matcha food or beverage is a matcha candy, and parts by mass of powdered matcha: parts by mass of the matcha richness enhancer in the matcha candy is a blending ratio within a range of 75 to 30:10 to 55.

9. The matcha food or beverage according to claim 5, wherein
the matcha food or beverage is a matcha candy, and parts by mass of powdered matcha: parts by mass of the matcha richness enhancer in the matcha candy is a blending ratio within a range of 75 to 46:10 to 39.

10. The matcha food or beverage according to claim 4, wherein
the matcha food or beverage is a matcha baked sweet, and parts by mass of powdered matcha: parts by mass of the matcha richness enhancer in the matcha baked sweet is a blending ratio within a range of 1.25:0.5 to 3.

11. The matcha food or beverage according to claim 5, wherein
the matcha food or beverage is a matcha baked sweet, and parts by mass of powdered matcha: parts by mass of the matcha richness enhancer in the matcha baked sweet is a blending ratio within a range of 1.25:0.5 to 3.

12. The matcha food or beverage according to claim 4, wherein
the matcha food or beverage is matcha ice cream, and parts by mass of powdered matcha: parts by mass of the matcha richness enhancer in the matcha ice cream is a blending ratio within a range of 12:0.5 to 4.

13. The matcha food or beverage according to claim 5, wherein
the matcha food or beverage is matcha ice cream, and parts by mass of powdered matcha: parts by mass of the matcha richness enhancer in the matcha ice cream is a blending ratio within a range of 12:0.5 to 4.

14. The matcha food or beverage according to claim 4, wherein
the matcha food or beverage is matcha chocolate, and parts by mass of powdered matcha: parts by mass of the matcha richness enhancer in the matcha chocolate is a blending ratio within a range of 16:3.7 to 10.

15. The matcha food or beverage according to claim 5, wherein
the matcha food or beverage is matcha chocolate, and parts by mass of powdered matcha: parts by mass of the matcha richness enhancer in the matcha chocolate is a blending ratio within a range of 16:3.7 to 10.

16. The matcha food or beverage according to claim 4, wherein
the matcha food or beverage is a matcha beverage, and parts by mass of powdered matcha: parts by mass of the matcha richness enhancer in the matcha beverage is a blending ratio within a range of 1,000:33 to 334.

17. The matcha food or beverage according to claim 5, wherein
the matcha food or beverage is a matcha beverage, and parts by mass of powdered matcha: parts by mass of the matcha richness enhancer in the matcha beverage is a blending ratio within a range of 1,000:33 to 334.
